(19) United States
(12) Patent Application Publication
(10) Pub. No.: US 2026/0051955 A1
(43) Pub. Date: Feb. 19, 2026

(54) SYSTEMS AND METHODS FOR THZ SIGNAL SOURCE

(71) Applicant: Attotude, Inc., Menlo Park, CA (US)

(72) Inventors: David F. Welch, Atherton, CA (US); Kuang-Tsan Wu, Ottawa (CA); Joy Laskar, Mountain View, CA (US); Richard Chan, Menlo Park, CA (US); Rene Schmogrow, Menlo Park, CA (US); Sudipto Chakraborty, Plano, TX (US); Eric Juntunen, San Diego, CA (US)

(21) Appl. No.: 18/986,358

(22) Filed: Dec. 18, 2024

Related U.S. Application Data
(60) Provisional application No. 63/683,007, filed on Aug. 14, 2024.

(51) Int. Cl. H04B 10/299; G02B 6/43; G02F 1/225; H04B 10/508

(52) U.S. Cl. CPC H04B 10/299; G02B 6/43; G02F 1/225; H04B 10/508

(57) ABSTRACT

Network elements and methods of use, including a transmitter comprising a client-side input, signal and clock conditioning blocks, a modulation block, and antennas. The client-side input receives baseband signals having client data. The signal conditioning block adjusts signal characteristics of the baseband signals to generate intermediate signals. The clock conditioning block receives a first clock signal having a first clock frequency and adjusts signal characteristics of the first clock signal to generate a second clock signal having a harmonic frequency of the first clock frequency. The modulation block modulates the intermediate signals onto the second clock signal to generate antenna feed signals. The antennas generate radiated signals based on the antenna feed signals and couple the radiated signals into hollow waveguides. The radiated signals are radiated electromagnetic waves configured for coherent detection with a transmission frequency in a range between 300 Gigahertz (GHz) and 10 Terahertz (THz).

### CROSS-REFERENCE TO RELATED APPLICATIONS

This application claims priority to the provisional patent application identified by U.S. Ser. No. 63/683,007, filed Aug. 14, 2024, the entire content of which is hereby expressly incorporated herein by reference.

### BACKGROUND ART

Optical networking is a means of communication that uses signals encoded in light to transmit information in various types of telecommunications networks, including limited range local-area networks (LANs) or wide-area networks (WANs). It is a form of optical communication that relies on optical amplifiers, lasers, or LEDs and wavelength-division multiplexing (WDM) to transmit large quantities of data, generally across fiber-optic cables. Because it is capable of achieving extremely high bandwidth, it is an enabling technology for the Internet and telecommunication networks that transmit the vast majority of all human and machine-to-machine information. However, further development and optimization of optical networking systems face certain limiting factors, namely, power dissipation, thermal requirements, and mechanical tolerances.

Optical components generate photons by exciting electrons in a gain medium, and the electrons emit photons as they return to lower energy levels. Despite efforts to improve efficiency, optical components generate some amount of heat during the electron excitation process, and such heat is referred to as power dissipation. Excessive power dissipation may lead to thermal management problems and may affect the performance and longevity of the optical components.

Optical components are sensitive to temperature fluctuations and often require lower operating temperatures than purely electronic components to maintain optimal performance. Elevated temperatures may result in increased signal noise, diminished signal quality, and reduced service life for optical components. Accordingly, optical components often require cooling systems (e.g., heat sinks, fans, or thermoelectric devices) to dissipate excess heat and maintain the optical components within a safe temperature range.

Optical networking systems typically operate in micrometer wavelengths, demanding extreme precision in component fabrication, assembly, and alignment. Even slight deviations from the required mechanical tolerances may lead to signal degradation, loss, or the introduction of optical crosstalk, negatively impacting network performance. Achieving and maintaining the necessary mechanical tolerances necessitates advanced manufacturing techniques and stringent quality control measures.

Terahertz (THz) wireless communications in a frequency range between 300 Gigahertz (GHz) and 10 THz offer the potential for extremely high data rates, but face significant technical challenges. Existing approaches for transmitting and receiving dual-polarized THz signals have relied heavily on optical components, increasing complexity, cost, and power consumption.

Despite advancements in optical networking, existing systems struggle to achieve efficient operation in the THz frequency range. Existing techniques, such as anti-parallel diode-based mixing and varactor-based mixing, suffer from significant limitations. These methods produce inadequate output power levels, severely restricting their applicability in moderate-distance communication scenarios. While transistor models have shown promise in designing at sub-THz frequencies, they fall short of meeting the link margin of true THz wireless communication. Furthermore, the development of separate, accurate diode or varactor models for THz applications has proven to be a complex and resource-intensive process. Consequently, there exists a pressing need for novel approaches that can overcome these limitations and enable efficient, long-range THz wireless communication without relying on the shortcomings of current mixing techniques or the complexities of developing new component models.

### SUMMARY

The problems existing in the field of optical networking are solved by the systems, assemblies, and methods disclosed herein. The present disclosure includes a system for THz wireless communication. The system includes a signal path and a signal generation path, both implementing fully differential signaling using transistors. Transistor-based implementations are generally compact, low-cost, and scalable, can be digitally controlled, and are generally more reliable than optics-based systems. A two-stage mixer enables WDM functionality and incorporates a sliding intermediate frequency (IF) for the first stage (i.e., a first IF for the first stage is flexible, while a second IF for the second stage is a fixed frequency). The two-stage mixer's input impedance provides required impedance matching, while its output network utilizes power combination techniques. Digital signal processing and calibration mechanisms are integrated into the integrated circuit (IC) or chip to ensure robust detection. This architecture overcomes limitations of prior art systems, enabling efficient THz communication over moderate distances without relying on separate diode or varactor models.

In a first aspect, the present disclosure includes a transmitter, comprising: a client-side input configured to receive one or more baseband signals having client data encoded therein; a signal conditioning block configured to receive the one or more baseband signals from the client-side input and adjust one or more signal characteristics of the one or more baseband signals to generate one or more intermediate signals based on the one or more baseband signals; a clock conditioning block configured to receive a first clock signal and adjust one or more signal characteristics of the first clock signal to generate a second clock signal based on the first clock signal, the first clock signal having a first clock frequency, the second clock signal having a second clock frequency that is a harmonic frequency corresponding to the first clock frequency; a modulation block configured to receive the one or more intermediate signals from the signal conditioning block and the second clock signal from the clock conditioning block and modulate the one or more intermediate signals onto the second clock signal to generate one or more antenna feed signals; and one or more antennas configured to receive the one or more antenna feed signals from the modulation block, generate one or more radiated signals based on the one or more antenna feed signals, and couple the one or more radiated signals into one or more hollow waveguides, each of the one or more radiated signals being radiated electromagnetic waves configured for coherent detection and having a transmission frequency in a range between 300 Gigahertz (GHz) and 10 Terahertz (THz).

In a second aspect, the present disclosure includes a receiver, comprising: one or more antennas configured to detect one or more radiated signals received from one or more hollow waveguides and generate one or more antenna output signals based on the one or more radiated signals, each of the one or more radiated signals being radiated electromagnetic waves configured for coherent detection and having client data encoded therein and a transmission frequency in a range between 300 Gigahertz (GHz) and 10 Terahertz (THz); a clock conditioning block configured to receive a first clock signal and adjust one or more signal characteristics of the first clock signal to generate a second clock signal based on the first clock signal, the first clock signal having a first clock frequency, the second clock signal having a second clock frequency that is a harmonic frequency corresponding to the first clock frequency; a demodulation block configured to receive the one or more antenna output signals from the one or more antennas and the second clock signal from the clock conditioning block and modulate the one or more antenna output signals onto the second clock signal to generate one or more intermediate signals; a signal conditioning block configured to receive the one or more intermediate signals from the demodulation block and adjust one or more signal characteristics of the one or more intermediate signals to generate one or more baseband signals based on the one or more intermediate signals; and a client-side output configured to receive the one or more baseband signals from the signal conditioning block and transmit the one or more baseband signals.

In a third aspect, the present disclosure includes a transceiver, comprising: a transmitter, comprising: a client-side input configured to receive one or more outbound baseband signals having outbound client data encoded therein; an outbound signal conditioning block configured to receive the one or more outbound baseband signals from the client-side input and adjust one or more signal characteristics of the one or more outbound baseband signals to generate one or more outbound intermediate signals based on the one or more outbound baseband signals; a clock conditioning block configured to receive a first clock signal and adjust one or more signal characteristics of the first clock signal to generate a second clock signal based on the first clock signal, the first clock signal having a first clock frequency, the second clock signal having a second clock frequency that is a harmonic frequency corresponding to the first clock frequency; a modulation block configured to receive the one or more outbound intermediate signals from the outbound signal conditioning block and the second clock signal from the clock conditioning block and modulate the one or more outbound intermediate signals onto the second clock signal to generate one or more antenna feed signals; and one or more outbound antennas configured to receive the one or more antenna feed signals from the modulation block, generate one or more outbound radiated signals based on the one or more antenna feed signals, and couple the one or more outbound radiated signals into one or more first hollow waveguides, each of the one or more outbound radiated signals being radiated electromagnetic waves configured for coherent detection and having an outbound transmission frequency in a range between 300 Gigahertz (GHz) and 10 Terahertz (THz); and a receiver, comprising: one or more inbound antennas configured to detect one or more inbound radiated signals received from one of the one or more first hollow waveguides and one or more second hollow waveguides and generate one or more antenna output signals based on the one or more inbound radiated signals, each of the one or more radiated signals being radiated electromagnetic waves configured for coherent detection and having inbound client data encoded therein and an inbound transmission frequency in the range between 300 GHz and 10 THz; a demodulation block configured to receive the one or more antenna output signals from the one or more inbound antennas and the second clock signal from the clock conditioning block and modulate the one or more antenna output signals onto the second clock signal to generate one or more inbound intermediate signals; an inbound signal conditioning block configured to receive the one or more inbound intermediate signals from the demodulation block and adjust one or more signal characteristics of the one or more inbound intermediate signals to generate one or more inbound baseband signals based on the one or more inbound intermediate signals; and a client-side output configured to receive the one or more inbound baseband signals from the signal conditioning block and transmit the one or more inbound baseband signals.

In a fourth aspect, the present disclosure includes a method, comprising: providing one or more baseband signals to a transmitter in a transport network, at least one of the one or more baseband signal having client data encoded therein, the transport network comprising one or more hollow waveguides, the transmitter coupled to the one or more hollow waveguides, and a receiver coupled to the one or more hollow waveguides; generating, by the transmitter, one or more radiated signals based on the one or more baseband signals, at least one of the one or more radiated signals being a radiated electromagnetic wave having a transmission frequency in a range between 300 Gigahertz (GHz) and 10 Terahertz (THz); coupling, by the transmitter, the one or more radiated signals into the one or more hollow waveguides; receiving, by the receiver, the one or more radiated signals from the one or more hollow waveguides; measuring, by the receiver, one or more signal quality parameters of the one or more radiated signals, wherein the one or more signal quality parameters include one or more of signal distortion, bit error rate (BER), spurious free dynamic range (SFDR), signal-to-noise ratio (SNR), signal dynamic range, and jitter; generating, by the receiver, one or more actuation controls based on the one or more signal quality parameters, each of the one or more actuation controls being configured to adjust a particular one of one or more transmitter operating parameters of the transmitter, wherein the one or more transmitter operating parameters include one or more of gain, bandwidth, equalization, linearity, and jitter; sending, by the receiver, an actuation control signal, the actuation control signal having the one or more actuation controls encoded therein; receiving, by the transmitter, the actuation control signal; and adjusting, by the transmitter, at least one of the one or more transmitter operating parameters of the transmitter based on the one or more actuation controls.

The foregoing summary provides an overview of certain selected embodiments or embodiments disclosed herein, and is not intended to describe every aspect, embodiment, embodiment, feature, or advantage of the disclosure exhaustively or comprehensively. Therefore, this summary should not be construed in such a way to limit the scope of this disclosure or to limit the scope of the claims. The details of one or more embodiments disclosed herein are set forth in the accompanying drawings and descriptions below. Other aspects, features, embodiments, embodiments, and advantages will become readily apparent in view of the description, the drawings, and the claims set forth herein.

### BRIEF DESCRIPTION OF THE DRAWINGS

The accompanying drawings, which are incorporated in and constitute a part of this specification, illustrate one or more embodiments described herein and, together with the description, explain these embodiments. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a diagrammatic view of an electromagnetic (EM) spectrum;

FIG. 2 is a block diagram of an exemplary embodiment of a transport network constructed in accordance with the present disclosure;

FIG. 3A is a cross-sectional view of an exemplary embodiment of a first hollow waveguide shown in FIG. 2, taken along the line 3-3′ and in the direction of the arrows;

FIG. 3B is a cross-sectional view of another exemplary embodiment of the first hollow waveguide shown in FIG. 2, taken along the line 3-3′ and in the direction of the arrows, wherein the first hollow waveguide lacks an optional dielectric layer;

FIG. 3C is a cross-sectional view of another exemplary embodiment of the first hollow waveguide shown in FIG. 2, taken along the line 3-3′ and in the direction of the arrows, wherein the first hollow waveguide lacks an optional support layer;

FIG. 3D is a cross-sectional view of another exemplary embodiment of the first hollow waveguide shown in FIG. 2, taken along the line 3-3′ and in the direction of the arrows, wherein the first hollow waveguide lacks the optional dielectric layer and the optional support layer;

FIG. 3E is a cross-sectional view of another exemplary embodiment of the first hollow waveguide shown in FIG. 2, taken along the line 3-3′ and in the direction of the arrows, wherein the first hollow waveguide is a photonic-bandgap fiber;

FIG. 3F is a cross-sectional view of another exemplary embodiment of the first hollow waveguide shown in FIG. 2, taken along the line 3-3′ and in the direction of the arrows, wherein the first hollow waveguide has a hollow waveguide core with an elliptical cross-section;

FIG. 3G is a cross-sectional view of another exemplary embodiment of the first hollow waveguide shown in FIG. 2, taken along the line 3-3′ and in the direction of the arrows, wherein the hollow waveguide core of the first hollow waveguide has a rectangular cross-section;

FIG. 3H is a cross-sectional view of another exemplary embodiment of the first hollow waveguide shown in FIG. 2, taken along the line 3-3′ and in the direction of the arrows, wherein the hollow waveguide core of the first hollow waveguide has a square cross-section;

FIG. 3I is a cross-sectional view of another exemplary embodiment of the first hollow waveguide shown in FIG. 2, taken along the line 3-3′ and in the direction of the arrows, wherein the hollow waveguide core of the first hollow waveguide has a cross-shaped cross-section;

FIG. 3J is a cross-sectional view of another exemplary embodiment of the first hollow waveguide shown in FIG. 2, taken along the line 3-3′ and in the direction of the arrows, wherein the first hollow waveguide is a solid rod fiber;

FIG. 3K is a cross-sectional view of another exemplary embodiment of the first hollow waveguide shown in FIG. 2, taken along the line 3-3′ and in the direction of the arrows, wherein the first hollow waveguide is a microstructured optical fiber;

FIG. 3L is a cross-sectional view of another exemplary embodiment of the first hollow waveguide shown in FIG. 2, taken along the line 3-3′ and in the direction of the arrows, wherein the first hollow waveguide is a porous fiber;

FIG. 3M is a cross-sectional view of another exemplary embodiment of the first hollow waveguide shown in FIG. 2, taken along the line 3-3′ and in the direction of the arrows, wherein the first hollow waveguide is a suspended porous-core fiber;

FIG. 3N is a cross-sectional view of another exemplary embodiment of the first hollow waveguide shown in FIG. 2, taken along the line 3-3′ and in the direction of the arrows, wherein the first hollow waveguide is a suspended slotted core fiber;

FIG. 3O is a cross-sectional view of another exemplary embodiment of the first hollow waveguide shown in FIG. 2, taken along the line 3-3′ and in the direction of the arrows, wherein the first hollow waveguide is a hollow-core bandgap fiber;

FIG. 3P is a cross-sectional view of another exemplary embodiment of the first hollow waveguide shown in FIG. 2, taken along the line 3-3′ and in the direction of the arrows, wherein the first hollow waveguide is a hollow-core tube fiber;

FIG. 3Q is a cross-sectional view of another exemplary embodiment of the first hollow waveguide shown in FIG. 2, taken along the line 3-3′ and in the direction of the arrows, wherein the first hollow waveguide is a hollow-core fiber with negative curvature;

FIG. 3R is a cross-sectional view of another exemplary embodiment of the first hollow waveguide shown in FIG. 2, taken along the line 3-3′ and in the direction of the arrows, wherein the first hollow waveguide is a hollow-core fiber based on anti-resonances and inhibited coupling;

FIG. 3S is a cross-sectional view of another exemplary embodiment of the first hollow waveguide shown in FIG. 2, taken along the line 3-3′ and in the direction of the arrows, wherein the first hollow waveguide is a hollow-core nested anti-resonant nodeless fiber;

FIG. 3T is a cross-sectional view of another exemplary embodiment of the first hollow waveguide shown in FIG. 2, taken along the line 3-3′ and in the direction of the arrows, wherein the first hollow waveguide is a 3D-printed hollow-core fiber based on anti-resonances and inhibited coupling;

FIG. 3U is a cross-sectional view of another exemplary embodiment of the first hollow waveguide shown in FIG. 2, taken along the line 3-3′ and in the direction of the arrows, wherein the first hollow waveguide is a Bragg fiber;

FIG. 4A is a block diagram of an exemplary embodiment of a first transmitter shown in FIG. 2;

FIG. 4B is a block diagram of another exemplary embodiment of the first transmitter shown in FIG. 2, wherein the first transmitter comprises a serializer;

FIG. 4C is a block diagram of another exemplary embodiment of the first transmitter shown in FIG. 2, wherein the first transmitter comprises a deserializer;

FIG. 4D is a block diagram of an exemplary embodiment of transmitter circuitry shown in FIG. 4A;

FIG. 4E is a block diagram of another exemplary embodiment of the transmitter circuitry shown in FIG. 4A, wherein the transmitter circuitry comprises a combiner;

FIG. 4F is a block diagram of another exemplary embodiment of the first transmitter shown in FIG. 2;

FIG. 4G is a block diagram of another exemplary embodiment of the first transmitter shown in FIG. 2;

FIG. 5A is a block diagram of an exemplary embodiment of a first receiver shown in FIG. 2;

FIG. 5B is a block diagram of another exemplary embodiment of the first receiver shown in FIG. 2, wherein the first receiver comprises a deserializer;

FIG. 5C is a block diagram of another exemplary embodiment of the first transmitter shown in FIG. 2, wherein the first transmitter comprises a serializer;

FIG. 5D is a block diagram of an exemplary embodiment of receiver circuitry shown in FIG. 5A;

FIG. 5E is a block diagram of another exemplary embodiment of the receiver circuitry shown in FIG. 5A, wherein the receiver circuitry comprises a splitter;

FIG. 5F is a block diagram of another exemplary embodiment of the first receiver shown in FIG. 2;

FIG. 5G is a block diagram of another exemplary embodiment of the first receiver shown in FIG. 2;

FIG. 6A is a block diagram of an exemplary embodiment of a transceiver shown in FIG. 2;

FIG. 6B is a block diagram of another exemplary embodiment of the transceiver shown in FIG. 2;

FIG. 7 is a schematic diagram of a folded modulator constructed in accordance with the present disclosure;

FIG. 8 is a schematic diagram of a rectifying detector constructed in accordance with the present disclosure;

FIG. 9A is a side view of an exemplary embodiment of an antenna constructed in accordance with the present disclosure for generating circularly polarized signals;

FIG. 9B is a side view of another exemplary embodiment of the antenna shown in FIG. 9A;

FIG. 10 is a perspective view of another exemplary embodiment of the antenna shown in FIG. 9A, wherein the antenna is a bifilar helix antenna;

FIG. 11 is a perspective view of another exemplary embodiment of the bifilar helix antenna shown in FIG. 10, wherein the bifilar helix antenna is enclosed within a conductive cone;

FIG. 12 is a partial cross-sectional view of the bifilar helix antenna shown in FIG. 11, taken from the line 12-12′ and in the direction of the arrows;

FIG. 13 is a diagrammatic view of an electric field produced by the bifilar helix antenna enclosed within the conductive cone shown in FIG. 12;

FIG. 14 is a diagrammatic view of a radiation pattern of the bifilar helix antenna enclosed within the conductive cone shown in FIG. 12;

FIG. 15 is a side view of an exemplary embodiment of a non-uniform bifilar helix antenna constructed in accordance with the present disclosure;

FIG. 16 is a side view of another exemplary embodiment of the non-uniform bifilar helix antenna;

FIG. 17 is a graphical view of a polarization discrimination of the non-uniform bifilar helix antenna shown in FIG. 15;

FIG. 18 is a graphical view of a polarization discrimination of the non-uniform bifilar helix antenna shown in FIG. 16;

FIG. 19 is a side view of another exemplary embodiment of the non-uniform bifilar helix antenna;

FIG. 20 is a side view of another exemplary embodiment of the non-uniform bifilar helix antenna;

FIG. 21A is a diagrammatic front view of an exemplary embodiment of a differential waveguide probe antenna constructed in accordance with the present disclosure;

FIG. 21B is a diagrammatic side view of the differential waveguide probe antenna shown in FIG. 21A;

FIG. 22A is a partial cross-sectional view of the differential waveguide probe antenna shown in FIG. 21A, taken from the line 22-22′ and in the direction of the arrows;

FIG. 22B is another partial cross-sectional view of the differential waveguide probe antenna shown in FIG. 22A, taken from the line 23-23′ and in the direction of the arrows;

FIG. 22C is another partial cross-sectional view of the differential waveguide probe antenna shown in FIG. 22B, taken from the line 24-24′ and in the direction of the arrows;

FIG. 22D is a graphical view of a polarization discrimination of the differential waveguide probe antenna shown in FIG. 21A;

FIG. 23 a diagrammatic view of an exemplary embodiment of a differential tapered antenna constructed in accordance with the present disclosure;

FIG. 24A is a partial cross-sectional view of the differential tapered antenna shown in FIG. 23, taken from the line 27-27′ and in the direction of the arrows;

FIG. 24B is another partial cross-sectional view of the differential tapered antenna shown in FIG. 24A, taken from the line 28-28′ and in the direction of the arrows;

FIG. 24C is a graphical view of a polarization discrimination of the differential tapered antenna shown in FIG. 23;

FIG. 25A is a diagrammatic front view of an exemplary embodiment of a microstrip patch antenna array constructed in accordance with the present disclosure;

FIG. 25B is a diagrammatic side view of the microstrip patch antenna array shown in FIG. 25A;

FIG. 26A is a diagrammatic front view of an exemplary embodiment of a single-ended waveguide probe antenna constructed in accordance with the present disclosure;

FIG. 26B is a diagrammatic side view of the single-ended waveguide probe antenna shown in FIG. 26A;

FIG. 27A is a cross-sectional view of the single-ended waveguide probe antenna shown in FIG. 26A, taken along the line 55-55′ and in the direction of the arrows;

FIG. 27B is another cross-sectional view of the single-ended waveguide probe antenna shown in FIG. 26A, taken along the line 56-56′ and in the direction of the arrows;

FIG. 27C is a partial cross-sectional view of the single-ended waveguide probe antenna shown in FIG. 27B, taken along the line 57-57′ and in the direction of the arrows;

FIG. 28A is a diagrammatic front view of an exemplary embodiment of a slot antenna constructed in accordance with the present disclosure;

FIG. 29A is a cross-sectional view of the slot antenna shown in FIG. 28A, taken along the line 59-59′ and in the direction of the arrows;

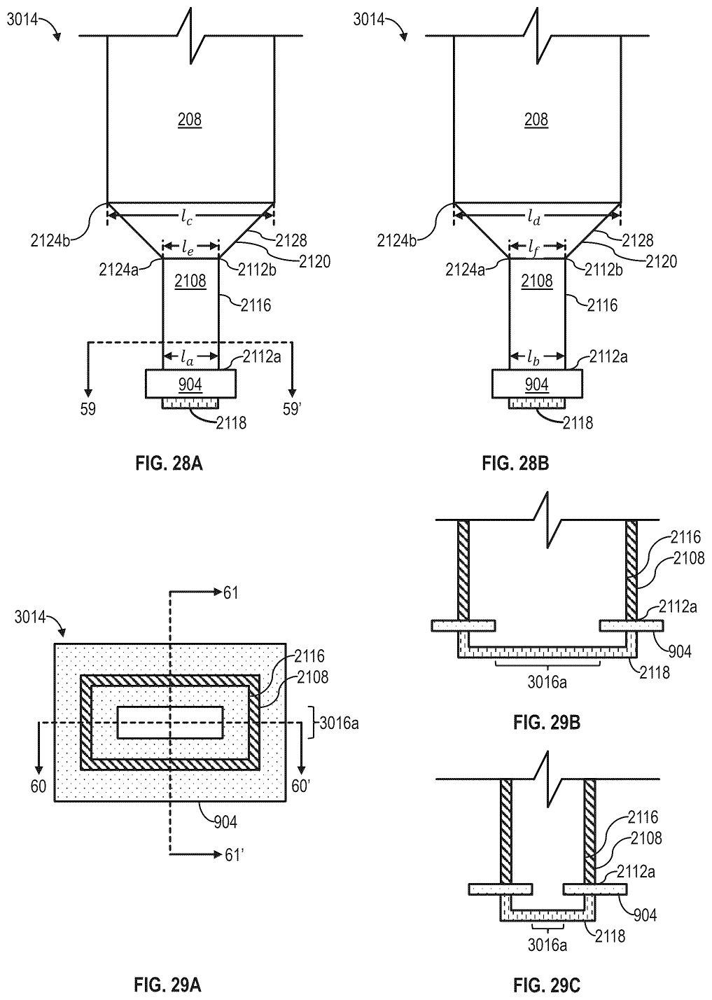

FIG. 28B is a diagrammatic side view of the slot antenna shown in FIG. 28A;

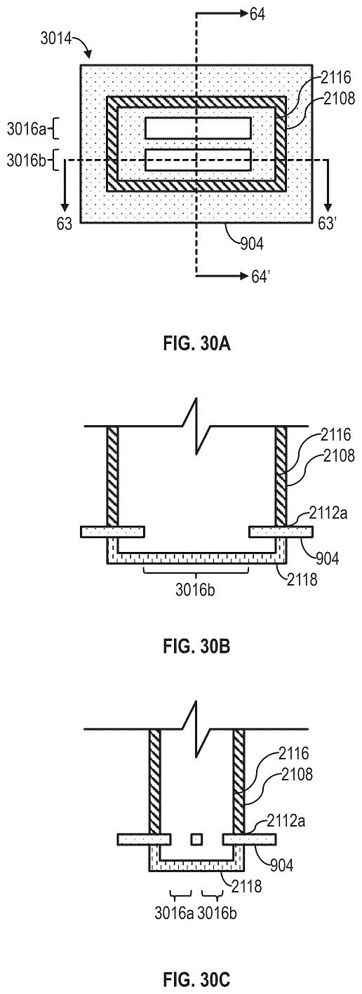

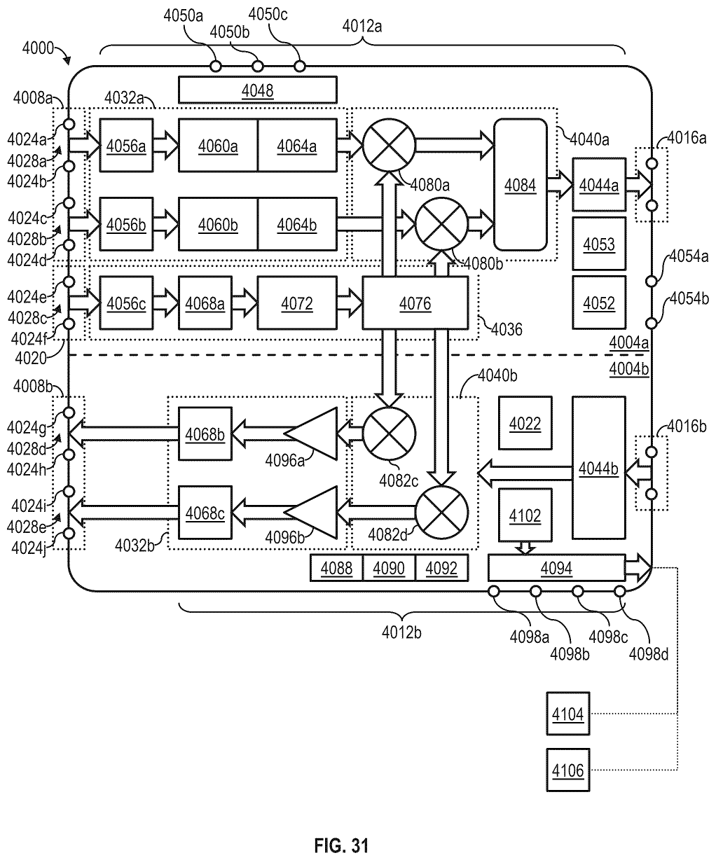

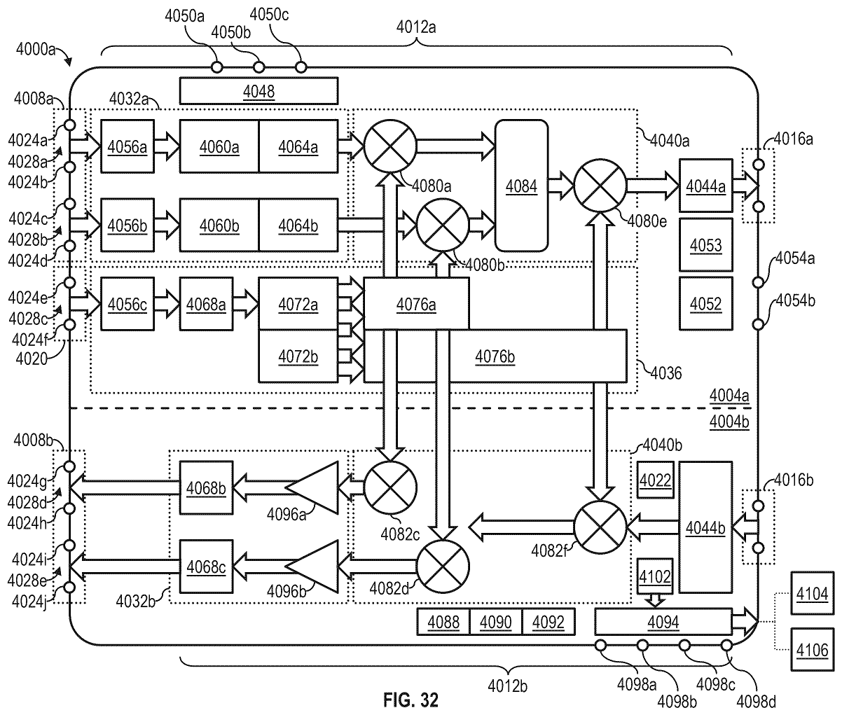

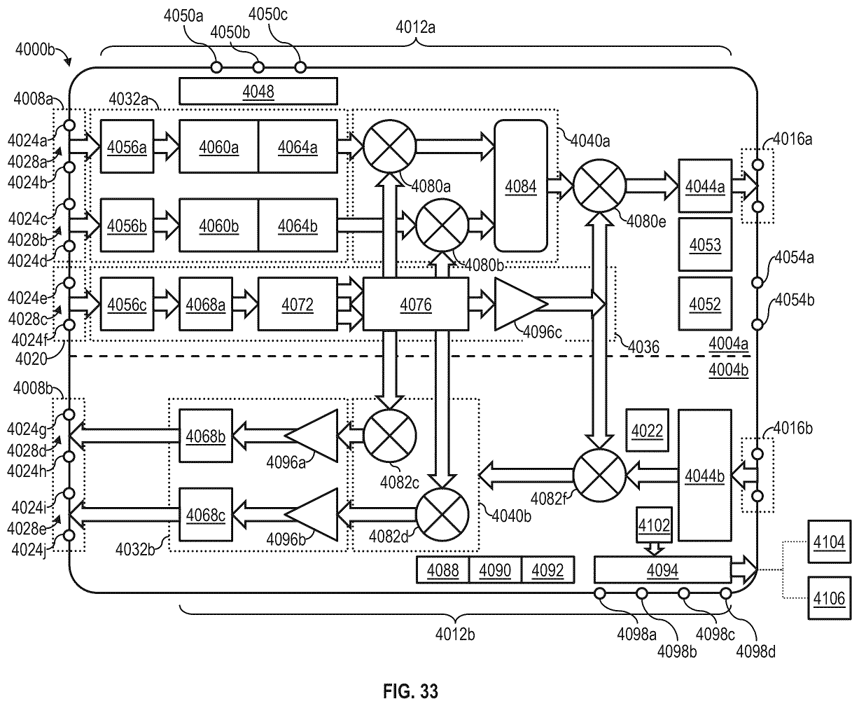

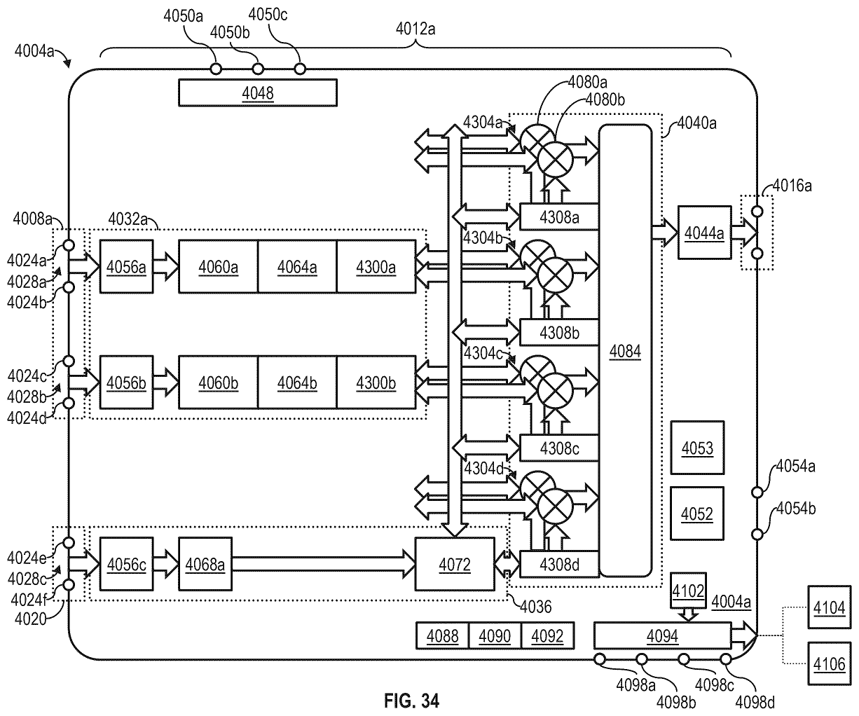

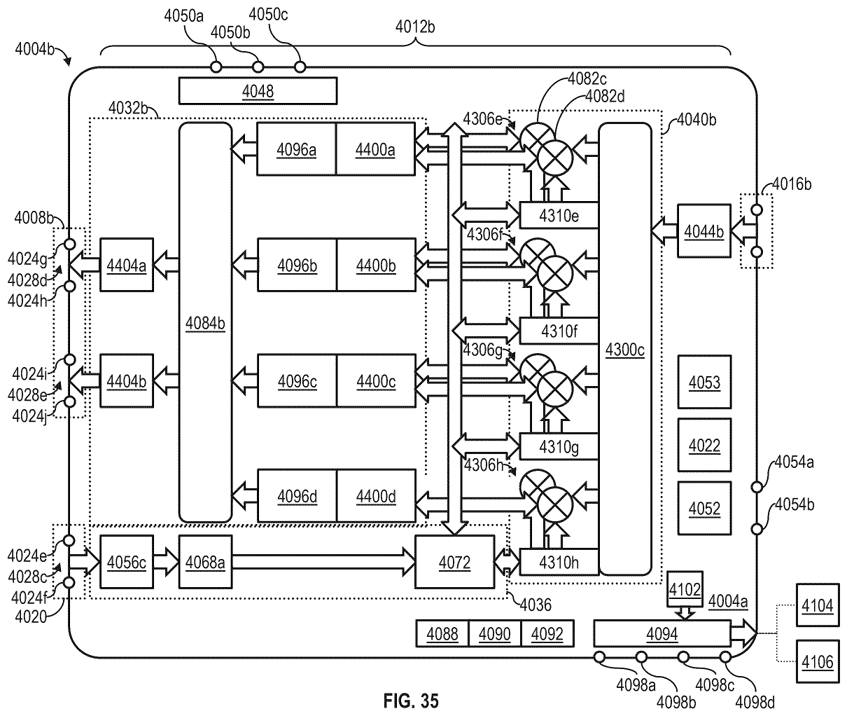

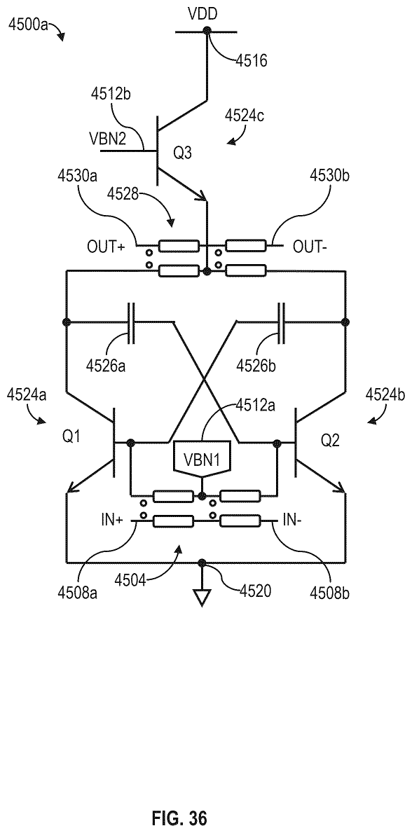

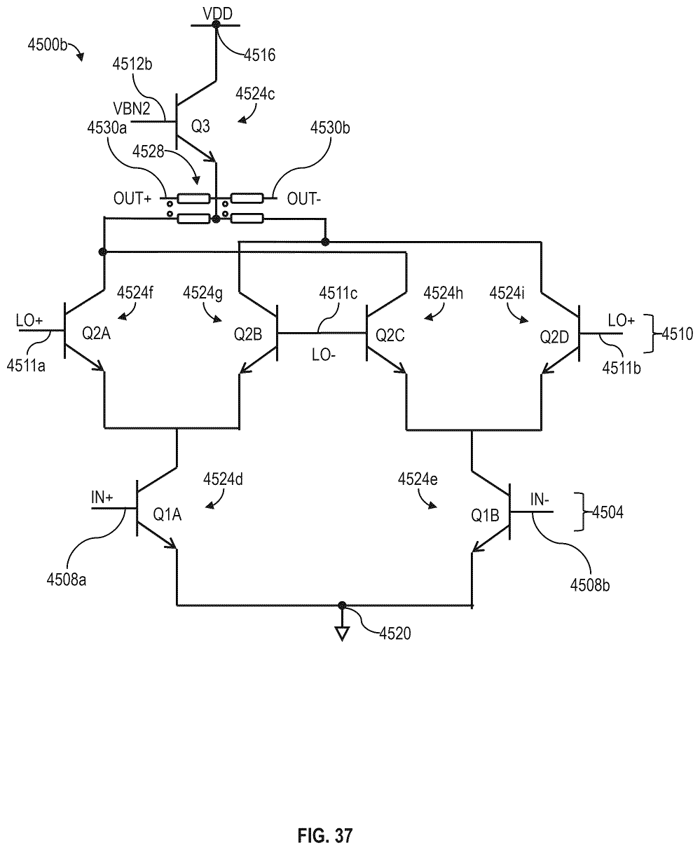

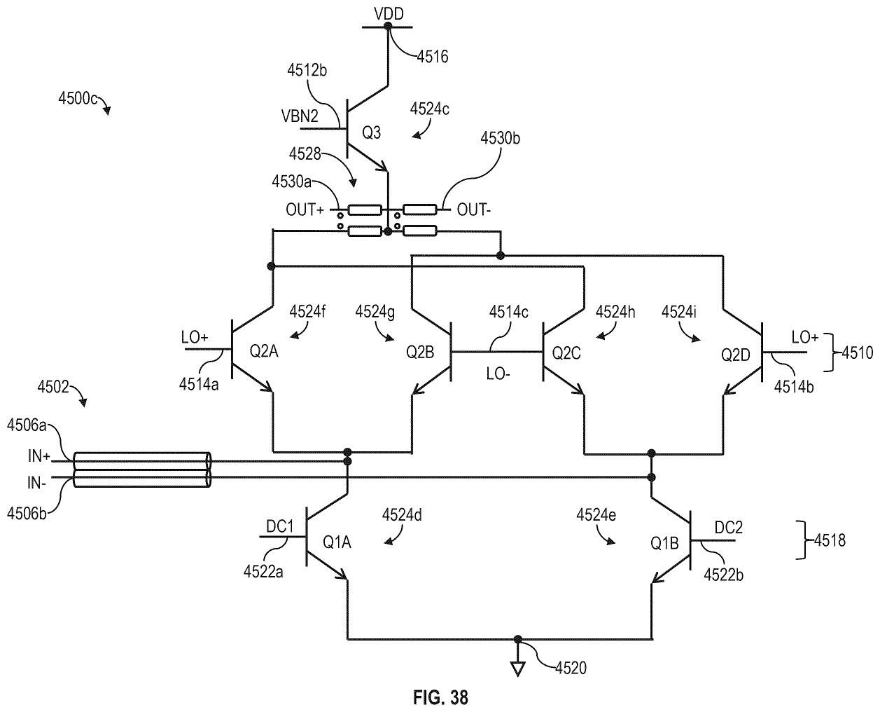

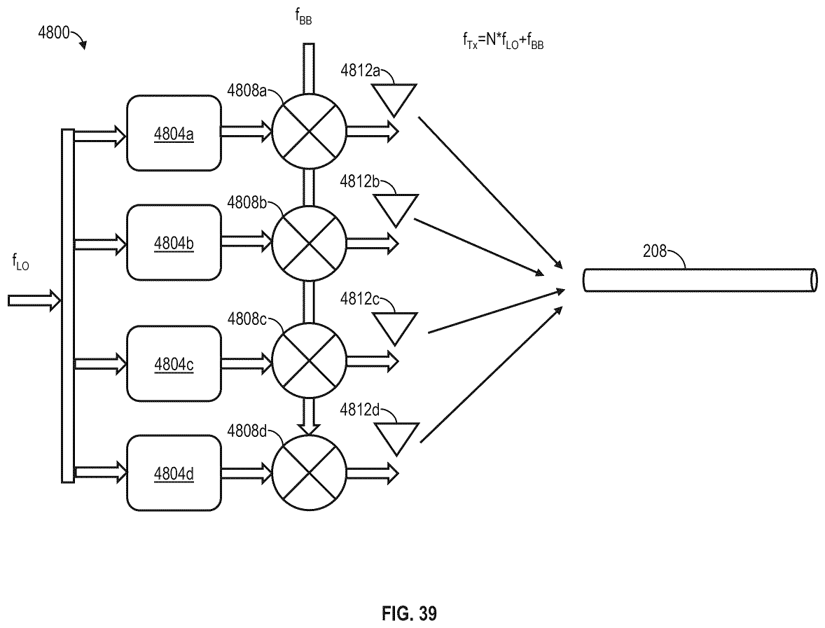

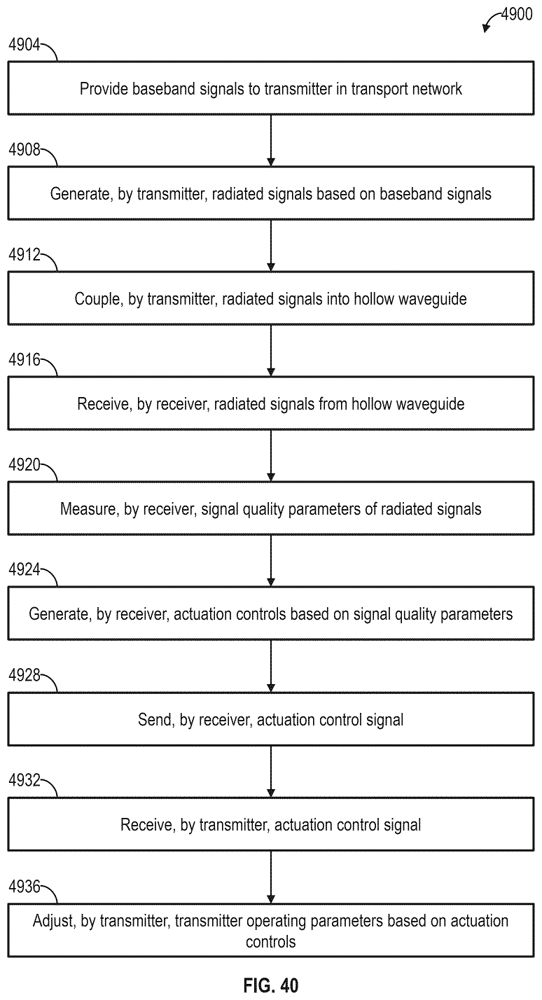

FIG. 29B is a partial cross-sectional view of the slot antenna shown in FIG. 29A, taken along the line 60-60′ and in the direction of the arrows;

FIG. 29C is another partial cross-sectional view of the slot antenna shown in FIG. 29A, taken along the line 61-61′ and in the direction of the arrows;

FIG. 30A is a cross-sectional view of another embodiment of the slot antenna shown in FIG. 28A, taken along the line 59-59′ and in the direction of the arrows, wherein the slot antenna is a double slot antenna;

FIG. 30B is a partial cross-sectional view of the slot antenna shown in FIG. 30A, taken along the line 63-63′ and in the direction of the arrows;

FIG. 30C is another partial cross-sectional view of the slot antenna shown in FIG. 30A, taken along the line 64-64′ and in the direction of the arrows;

FIG. 31 is a diagrammatic view of another exemplary embodiment of a transceiver constructed in accordance with the present disclosure;

FIG. 32 is a diagrammatic view of another exemplary embodiment of a transceiver constructed in accordance with the present disclosure;

FIG. 33 is a diagrammatic view of another exemplary embodiment of a transceiver constructed in accordance with the present disclosure;

FIG. 34 is a diagrammatic view of another exemplary embodiment of a transmitter constructed in accordance with the present disclosure;

FIG. 35 is a diagrammatic view of another exemplary embodiment of a receiver constructed in accordance with the present disclosure;

FIG. 36 is a diagrammatic view of an exemplary embodiment of a first differential circuit constructed in accordance with the present disclosure;

FIG. 37 is a diagrammatic view of another exemplary embodiment of a second differential circuit constructed in accordance with the present disclosure;

FIG. 38 is a diagrammatic view of another exemplary embodiment of a third differential circuit constructed in accordance with the present disclosure;

FIG. 39 is a diagrammatic view of an exemplary embodiment of a signal combiner array constructed in accordance with the present disclosure; and

FIG. 40 is a diagrammatic view of a method of using a transport network in accordance with the present disclosure.

### DETAILED DESCRIPTION

The following detailed description refers to the accompanying drawings. The same reference numbers in different drawings may identify the same or similar elements.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, all numerical values or ranges include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-50 therefore includes 1, 2, 3, 4, 5, 6, 7, 8, 9, 10, 11, 12, 13, 14, 15, 16, 17, 18, 19, 20, etc., up to and including 50, as well as 1.1, 1.2, 1.3, 1.4, 1.5, etc., 2.1, 2.2, 2.3, 2.4, 2.5, etc., and so forth. Reference to a series of ranges includes ranges which combine the values of the boundaries of different ranges within the series. Thus, to illustrate reference to a series of ranges, for example, of 1-10, 10-20, 20-30, 30-40, 40-50, 50-60, 60-75, 75-100, 100-150, 150-200, 200-250, 250-300, 300-400, 400-500, 500-750, 750-1,000, includes ranges of 1-20, 10-50, 50-100, 100-500, and 500-1,000, for example.

As used herein, “circuitry” may refer to analog and/or digital components, or one or more suitably programmed processors (e.g., microprocessors) and associated hardware and software, or hardwired logic. Also, “circuitry” may perform one or more functions. The term “circuitry” may include hardware, such as a processor (e.g., microprocessor), a combination of hardware and software, and/or the like. Software may include one or more processor-executable instructions that when executed by one or more processors cause the one or more processors to perform a specified function. It should be understood that the algorithms described herein may be stored on one or more non-transitory memories. Exemplary non-transitory memory may include random access memory, read only memory, flash memory, and/or the like. Such non-transitory memory may be electrically based, optically based, and/or the like.

As used herein, a “mode” refers to a unique distribution of electric and magnetic fields which repeat along the length of a hollow waveguide by which electromagnetic energy may be transported through the hollow waveguide. “Single-mode” refers to a hollow waveguide designed to carry only one mode of electromagnetic wave. This is achieved by having a narrow core diameter, which allows only one mode of light to propagate at a time. On the other hand, “multi-mode” refers to a hollow waveguide designed to carry multiple modes of electromagnetic waves simultaneously. This is possible due to its larger core diameter, which enables multiple modes to be propagated.

As used herein, “Amplitude Modulation” (AM) refers to a form of signal modulation in which data is encoded in an amplitude of a carrier signal.

As used herein, “Amplitude-Shift Keying” (ASK) refers to a form of AM in which digital data is encoded in an amplitude of a carrier signal, and each symbol (i.e., representing one or more data bits) is sent by transmitting a fixed-amplitude carrier wave at a fixed frequency for a specific time period.

As used herein, “Phase-Shift Keying” (PSK) is a form of signal modulation in which signal data is encoded in a phase of a carrier signal having a constant frequency. “Quadrature PSK” (PSK) Is a form of PSK in which two data bits (i.e., 00, 01, 10, or 11) are modulated at once, selecting one of four possible carrier phase shifts (i.e., 0°, 90°, 180°, or) 270°.

As used herein, “Pulse-Amplitude Modulation” (PAM) refers to a form of AM in which a data signal is encoded in an amplitude of a series of carrier signal pulses. “PAM4” refers to a form of PAM in which a data signal is encoded in an amplitude of a series of carrier signal pulses, in which the amplitude of the carrier signal pulses may be one of four discrete values (i.e., 0, 1, 2, or 3) and each carrier signal pulse represents two data bits (i.e., 00, 01, 10, or 11).

As used herein, “Non-Return-to-Zero” (NRZ) refers to a form of signal modulation in which a binary data signal is encoded in a carrier signal such that ones are represented by a first significant condition (e.g., a positive voltage) and zeroes are represented by a second significant condition (e.g., a negative voltage). “Non-return-to-Zero, Inverted” (NRZI) refers to a form of signal modulation in which the data bits are represented by the presence or absence of a transition at a clock boundary.

As used herein, “Quadrature Amplitude Modulation” (QAM) refers to a form of AM in which two analog message signals or two digital bit streams are encoded in amplitudes of two carrier waves, using either ASK or AM, and the two carrier signals are out of phase with each other by 90°. “QAM16” refers to a form of QAM in which the carrier signals may exist in one of sixteen discrete states (i.e., symbols) having one of sixteen different amplitude and phase levels representing four data bits (i.e., from 0000 to 1111).

As used herein, “Trellis Coded Modulation” (TCM) refers to a form of signal modulation in which a binary data signal is encoded in a phase of a constant amplitude carrier signal. The transmitted signal is created by convolutionally encoding the binary data signal and mapping the result to a signal constellation.

As used herein, “Rayleigh range” refers to the distance along the propagation direction of a beam from the waist to the place where the area of the cross section is doubled.

As used herein, “hollow waveguide” refers to a structure that guides waves by restricting transmission of energy in a particular direction. In the context of the present disclosure, “hollow waveguide” may refer to an optical fiber having a waveguide core operable to propagate RF signals in the THz frequency band or a routed waveguide operable to propagate RF signals in the THz frequency band.

As used herein, “diameter” refers to a straight line passing from side to side through the center of a body or figure. In some embodiments, the body or figure has a circular shape having a single diameter or an elliptical shape having multiple different diameters.

As used herein, “data” refers to quantities, characters, or symbols on which operations are performed by a computer. Data can be recorded on a non-transitory computer readable medium, such as random-access memory and/or read only memory. The random-access memory and/or read only memory may be implemented on semiconductor, magnetic, optical, or mechanical recording media. An example of data is client data, e.g., data provided by a client in connection with a telecommunication service and/or a storage service.

Referring now to the drawings, and in particular to FIG. 1, shown therein is a diagrammatic view of an electromagnetic (EM) spectrum 100 in accordance with the present disclosure. The present disclosure is generally related to network elements that communicate using radiated signals comprising radiated electromagnetic waves coupled into hollow waveguides. The radiated signals described herein generally have a transmission frequency in what is referred to as a Terahertz (THz) frequency band 104 (i.e., frequencies between 0.1 THz and 10 THz corresponding to wavelengths between 3 millimeters (mm) and 30 micrometers (μm)). However, in some embodiments described herein, the transmission frequency of the radiated signals is in a range between 300 Gigahertz (GHz) and 10 THz. The radiated signals described herein are generally configured for coherent detection and generally have a bandwidth in a range between 10% and 40% of the transmission frequency.

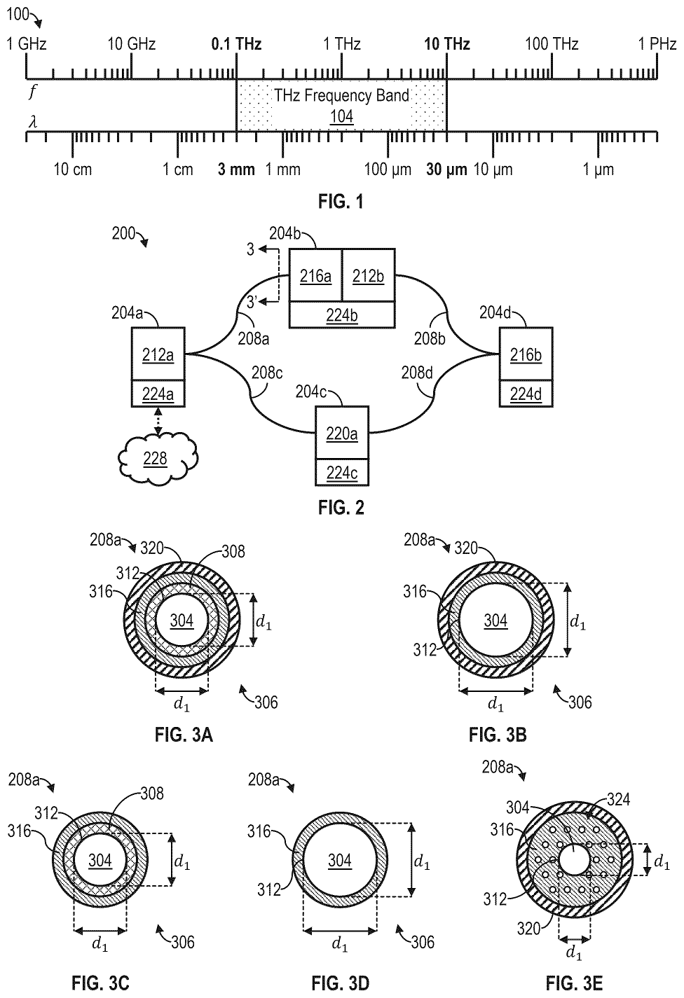

Referring now to FIG. 2, shown therein is a block diagram of an exemplary embodiment of a transport network 200 (hereinafter, the “transport network 200”) constructed in accordance with the present disclosure. The transport network 200 is depicted as comprising a plurality of network elements 204a-n (hereinafter, the “network elements 204”) (e.g., a first network element 204a, a second network element 204b, a third network element 204c, and a fourth network element 204d shown in FIG. 2). While only four of the network elements 204 are shown in FIG. 2 for exemplary purposes, it should be understood that the transport network 200 may comprise a number of the network elements 204 that may be greater or fewer than four.

The transport network 200 may further comprise one or more hollow waveguides 208a-n (hereinafter, the “hollow waveguides 208”) (e.g., a first hollow waveguide 208a, a second hollow waveguide 208b, a third hollow waveguide 208c, and a fourth hollow waveguide 208d shown in FIG. 2). While only four of the hollow waveguides 208 are shown in FIG. 2 for exemplary purposes, it should be understood that the transport network 200 may comprise a number of the hollow waveguides 208 that may be greater or fewer than four.

Radiated signals transmitted within the transport network 200 from the first network element 204a to the fourth network element 204d or vice versa may travel along (1) a first path formed by the first hollow waveguide 208a, the second network element 204b, and the second hollow waveguide 208b or (2) a second path formed by the third hollow waveguide 208c, the third network element 204c, and the fourth hollow waveguide 208d.

In some embodiments, each of the hollow waveguides 208 is configured to support propagation of radiated signals in only a single direction. However, in other embodiments, one or more of the hollow waveguides 208 may be configured to support propagation of radiated signals in a plurality of directions (i.e., two opposing directions). In embodiments where one or more of the hollow waveguides 208 are configured to support propagation of radiated signals in a plurality of directions, a first radiated signal being propagated through the hollow waveguide 208 in a first direction may be differentiated from a second radiated signal being propagated through the hollow waveguide 208 in a second direction opposite the first direction by being provided with a different polarization, frequency, etc. In some such embodiments, one or more circulators may be included to achieve such differentiation.

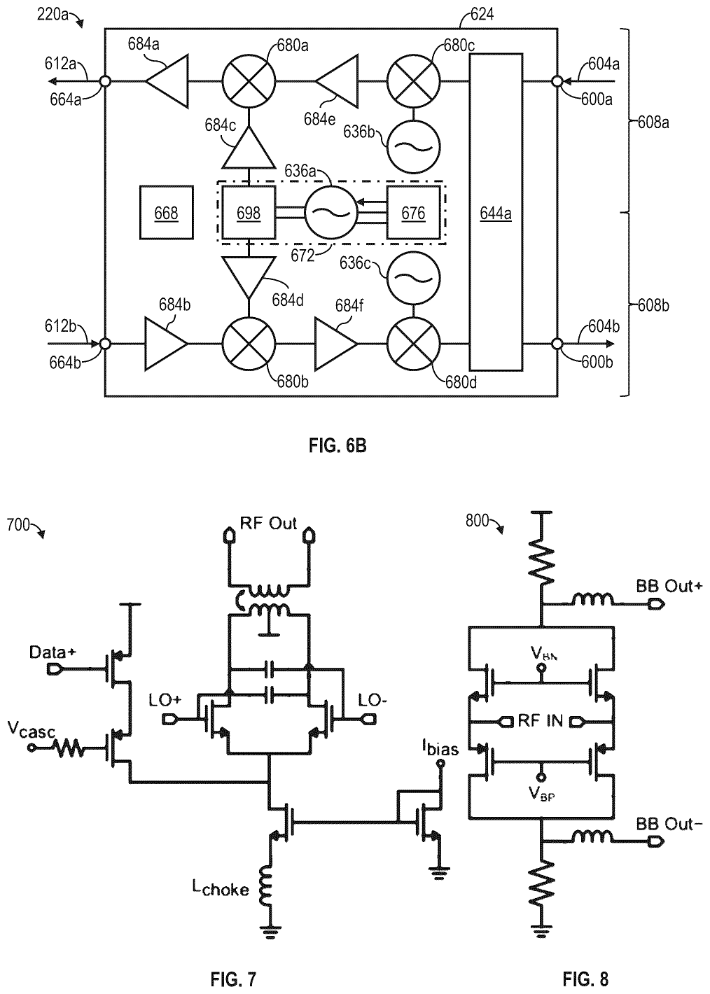

Each of the network elements 204 may comprise one or more of a transmitter 212 (e.g., a first transmitter 212a and a second transmitter 212b shown in FIG. 2) operable to transmit radiated signals comprising radiated electromagnetic waves having client data encoded therein via the hollow waveguides 208, a receiver 216 (e.g., a first receiver 216a and a second receiver 216b shown in FIG. 2) operable to receive radiated signals comprising radiated electromagnetic waves having client data encoded therein via the hollow waveguides 208, and/or a transceiver 220 (e.g., a first transceiver 220a shown in FIG. 2 and a second transceiver 220b shown in FIG. 6B) operable to transmit first radiated signals comprising first radiated electromagnetic waves having first client data encoded therein via particular ones of the hollow waveguides 208 and/or receive second radiated signals comprising second radiated electromagnetic waves having second client data encoded therein via other ones of the hollow waveguides 208.

Each of the network elements 204 may further comprise a control module 224 (e.g., a first control module 224a, a second control module 224b, a third control module 224c, and a fourth control module 224d shown in FIG. 2) (collectively, the “control modules 224”) operable to regulate one or more operating parameters of the network element 204 to which the control module 224 is coupled.

In some embodiments, one or more of the network elements 204 may communicate with each other via a communication network 228. The communication network 228 may permit bidirectional communication of information and/or data between one or more of the network elements 204 of the transport network 200. The communication network 228 may interface with one or more of the network elements 204 in a variety of ways. For example, in some embodiments, the communication network 228 may interface by optical and/or electronic interfaces, and/or may use a plurality of network topographies and/or protocols including, but not limited to, Ethernet, TCP/IP, circuit switched path, combinations thereof, and/or the like. The communication network 228 may utilize a variety of network protocols to permit bidirectional interface and/or communication of data and/or information between one or more of the network elements 204.

The communication network 228 may be almost any type of network. For example, in some embodiments, the communication network 228 may be a version of an Internet network (e.g., exist in a TCP/IP-based network). In one embodiment, the communication network 228 is the Internet. It should be noted, however, that the communication network 228 may be almost any type of network and may be implemented as the World Wide Web (i.e., the Internet), a local area network (LAN), a wide area network (WAN), a metropolitan network, a wireless network, a cellular network, a Bluetooth network, a Global System for Mobile Communications (GSM) network, a code division multiple access (CDMA) network, a 3G network, a 4G network, an LTE network, a 5G network, a satellite network, a radio network, an optical network, a cable network, a public switched telephone network, an Ethernet network, combinations thereof, and/or the like.

If the communication network 228 is the Internet, a primary user interface of the transport network 200 may be delivered through a series of web pages or private internal web pages of a company or corporation, which may be written in hypertext markup language, JavaScript, or the like, and accessible by the user. It should be noted that the primary user interface of the transport network 200 may be another type of interface including, but not limited to, a Windows-based application, a tablet-based application, a mobile web interface, a VR-based application, an application running on a mobile device, and/or the like. In one embodiment, the communication network 228 may be connected to one or more of the network elements 204.

The number of devices and/or networks illustrated in FIG. 2 is provided for exemplary purposes. In practice, there may be additional devices and/or networks, fewer devices and/or networks, different devices and/or networks, or differently arranged devices and/or networks than are shown in FIG. 2. Furthermore, two or more of the devices illustrated in FIG. 2 may be implemented within a single device, or a single device illustrated in FIG. 2 may be implemented as multiple, distributed devices. Additionally, or alternatively, one or more of the devices of the transport network 200 may perform one or more functions described as being performed by another one or more of the devices of the transport network 200.

The network elements 204 may take many different forms. For example, the network elements 204 may be integrated circuits (ICs). In this example, the network elements 204 (e.g., ICs) may communicate via signals comprising radiated electromagnetic waves having client data encoded therein via the hollow waveguides 208 without requiring electrical data busses. In other embodiments, the network elements 204 may be incorporated into components in a data center, such as servers, routers, switches, firewalls, storage systems, application delivery controllers, and/or the like to establish communication between such components in the data center via signals comprising radiated electromagnetic waves having client data encoded therein propagated through the hollow waveguides 208. The hollow waveguides 208 may thus extend from one integrated circuit to another integrated circuit, or from one component to another component, and such may be implemented in a variety of ways, such as IC-to-IC communications, printed circuit board (PCB)-to-PCB communications, component-to-component communications, and/or combinations thereof. In the example of PCB-to-PCB communications, the network elements 204 may each include a PCB.

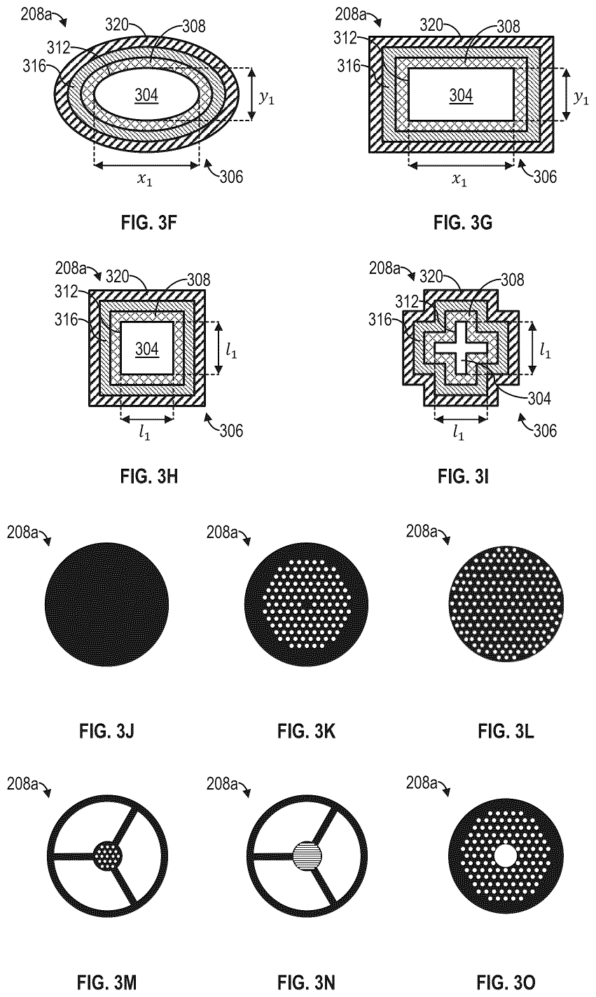

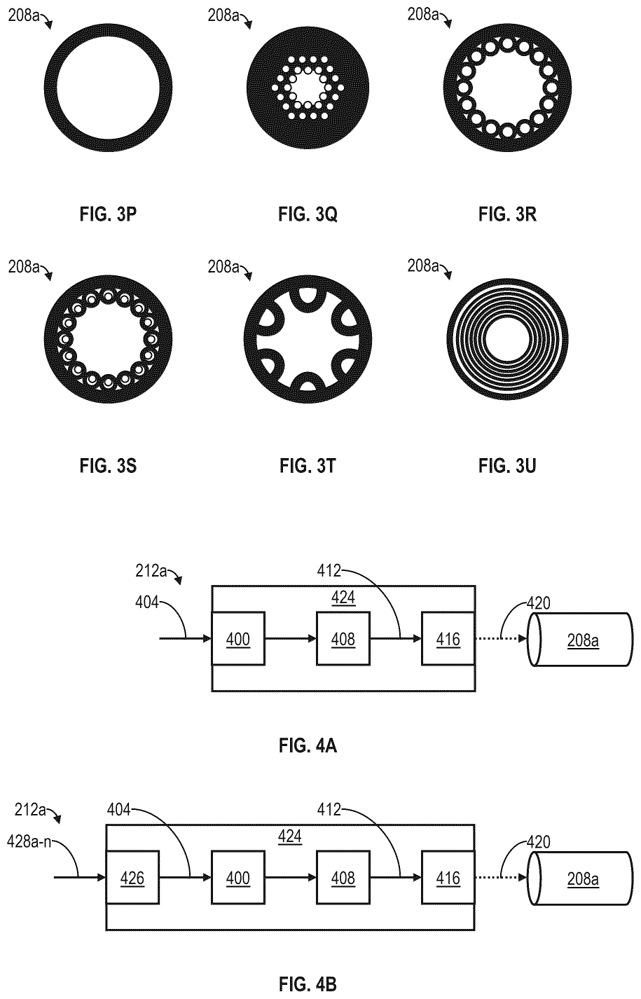

Referring now to FIGS. 3A-3U, shown therein are cross-sectional views of various exemplary embodiments of the first hollow waveguide 208a shown in FIG. 2, taken along the line 3-3′ and in the direction of the arrows. However, it should be understood that the description referring to FIGS. 3A-3U may be applicable to any of the hollow waveguides 208 described herein. In the embodiments shown in FIGS. 3U, the first hollow waveguide 208a is a hollow fiber. However, it should be understood that in other embodiments, the first hollow waveguide 208a may be another form of hollow waveguide, such as a substrate-integrated waveguide, for example.

The first hollow waveguide 208a (and, therefore, each of the hollow waveguides 208) generally comprises a hollow waveguide core 304 and a tubular sidewall 306 having an inner surface 312 in some embodiments defining the hollow waveguide core 304 or in other embodiments simply surrounding the hollow waveguide core 304.

Generally, the hollow waveguide core 304 may be composed of any material capable of propagating radiated electromagnetic waves within the THz frequency band 104 or, in some embodiments, in the range between 300 GHz and 10 THz. More particularly, the hollow waveguide core 304 may be composed of any materials having a low absorption loss (i.e., an absorption loss in a range between 1 dB/km and 10,000 dB/km) within the THz frequency band 104, or in some embodiments, in the range between 300 GHz and 10 THz.

In some embodiments, the hollow waveguide core 304 may be composed of a polymer (e.g., cyclic olefin polymer (COP), cyclic olefin co-polymer (COC), polytetrafluoroethylene (PTFE), high-density polyethylene (HDPE), polymethylpentene (PMP), polypropylene (PP), polystyrene, polycarbonate, poly(methyl methacrylate) (PMMA), Picarin, or ultraviolet (UV) resin) or glass (e.g., silica glass, crown glass, or borosilicate glass).

In other embodiments, the hollow waveguide core 304 may be composed of a gas, a vacuum, or a porous material (i.e., a material having a porosity in a range between 25% and 99%). In such embodiments, the hollow waveguide core 304 may have a refractive index in a range between 1.0 and 1.4, for example. As discussed in more detail below, the hollow waveguide core 304 may have a refractive index n₁.

In some embodiments, the hollow waveguide core 304 may have a cross-section configured to support propagation of radiated signals having only a single polarization at a given time. However, in other embodiments, the hollow waveguide core 304 may have a cross-section configured to support propagation of radiated signals having a plurality of polarizations at a given time. In either case, the hollow waveguide core 304 may have a cross-section configured (e.g., sized and/or shaped) to support propagation of radiated signals having one or more linear polarizations or one or more circular polarizations.

In some embodiments, the hollow waveguide core 304 may have a cross-section configured to support propagation of radiated signals having only a single mode at a given time. However, in other embodiments, the hollow waveguide core 304 may have a cross-section configured to support propagation of radiated signals having a plurality of modes at a given time.

The tubular sidewall 306 of the first hollow waveguide 208a (and, therefore, each of the hollow waveguides 208) may comprise a conductive layer 316 (shown in FIGS. 3A-3I) surrounding the hollow waveguide core 304, a dielectric layer 308 (shown in FIGS. 3A, 3C, and 3F-3I) optionally disposed between the hollow waveguide core 304 and the conductive layer 316, and a support layer 320 (shown in FIGS. 3A, 3B, and 3E-3I) optionally surrounding the conductive layer 316.

In some embodiments, the tubular sidewall 306 of the first hollow waveguide 208a (and, therefore, each of the hollow waveguides 208) may comprise a plurality of the conductive layers 316 interleaved with a plurality of the dielectric layers 308.

In some embodiments, the tubular sidewall 306 of the first hollow waveguide 208a (and, therefore, each of the hollow waveguides 208) may further comprise one or more strength members (not shown) (hereinafter, the “strength members”) surrounding the conductive layer 316 configured to enhance resilience of the first hollow waveguide 208a. In such embodiments, the support layer 320 may surround the strength members.

Generally, the conductive layer 316 may be composed of any material having a refractive index n₃ greater than the refractive index of the hollow waveguide core 304 (i.e., n₁). More particularly, the conductive layer 316 may be composed of a non-oxidizing metallic material (e.g., silver, gold, or indium tin oxide (ITO)). Providing the conductive layer 316 with a refractive index greater than the refractive index of the hollow waveguide core 304 may cause an effective index Δn of the first hollow waveguide 208a to increase, thereby causing more radiated signals to be confined and propagated within the hollow waveguide core 304.

Generally, in embodiments in which the dielectric layer 308 is disposed between the conductive layer 316 and the hollow waveguide core 304, the dielectric layer 308 may be composed of any material having a refractive index n₂ greater than the refractive index of the hollow waveguide core 304 (i.e., n₁). More particularly, the dielectric layer 308 may be composed of a polymer (e.g., cyclic olefin polymer (COP), cyclic olefin co-polymer (COC), polytetrafluoroethylene (PTFE), high-density polyethylene (HDPE), polymethylpentene (PMP), polypropylene (PP), polystyrene, polycarbonate, poly(methyl methacrylate) (PMMA), Picarin, or ultraviolet (UV) resin) or glass (e.g., silica glass, crown glass, or borosilicate glass), but particularly a material having a refractive index n₂ greater than the refractive index of the hollow waveguide core 304 (i.e., n₁) in that embodiment. Providing the dielectric layer 308 with a refractive index greater than the refractive index of the hollow waveguide core 304 may cause an effective index Δn of the first hollow waveguide 208a to increase, thereby causing more radiated signals to be confined and propagated within the hollow waveguide core 304.

The support layer 320 may be configured to shield the inner layers of the first hollow waveguide 208a (and, therefore, any of the hollow waveguides 208) from external environmental factors, provide flexibility to the first hollow waveguide 208a, and/or enhance a tensile strength of the first hollow waveguide 208a. In some embodiments, the support layer 320 may be composed of polymer materials, such as acrylate polymer or polyimide, for example.

In some embodiments, the cross-section of the hollow waveguide core 304 may have a circular shape (i.e., having a diameter d₁ that is equal along both the x-axis and the y-axis) (shown in FIGS. 3A-3D). In some such embodiments, the diameter d₁ of the hollow waveguide core 304 may be between 30 μm and 6 mm. In some such embodiments, the diameter d₁ of the hollow waveguide core 304 may be between 30 μm and 3 mm. In at least one such embodiment, the diameter d₁ of the hollow waveguide core 304 may be 1 mm.

In some embodiments, as shown in FIG. 3E, the first hollow waveguide 208a may be a photonic-bandgap fiber comprising a plurality of air channels 324 (hereinafter the “air channels 324”) periodically spaced throughout the conductive layer 316.

In other embodiments, the cross-section of the hollow waveguide core 304 may have an elliptical shape (i.e., having a first diameter x₁ along the x-axis and a second diameter y₁ along the y-axis, wherein the first diameter is not equal to the second diameter) (shown in FIG. 3F), a rectangular shape (shown in FIG. 3G) (i.e., having a first length x₁ along the x-axis and a second length y₁ along the y-axis, wherein the first length is not equal to the second length), a square shape (i.e., having a length l₁ that is equal along both the x-axis and the y-axis) (shown in FIG. 3H), or a cross shape (i.e., having a length l₁ that is equal along both the x-axis and the y-axis) (shown in FIG. 3I), for example.

In other embodiments, the first hollow waveguide 208a (and, therefore, any of the hollow waveguides 208) may be implemented as a solid rod fiber (shown in FIG. 3J), a microstructured optical fiber (shown in FIG. 3K), a porous fiber (shown in FIG. 3L), a suspended porous-core fiber (shown in FIG. 3M), a suspended slotted core fiber (shown in FIG. 3N), a hollow-core bandgap fiber (shown in FIG. 3O), a hollow-core tube fiber (shown in FIG. 3P), a hollow-core fiber with negative curvature (shown in FIG. 3Q), a hollow-core fiber based on anti-resonances and inhibited coupling (shown in FIG. 3R), a hollow-core nested anti-resonant nodeless fiber (shown in FIG. 3S), a 3D-printed hollow-core fiber based on anti-resonances and inhibited coupling (shown in FIG. 3T), or a Bragg fiber (shown in FIG. 3U), for example.

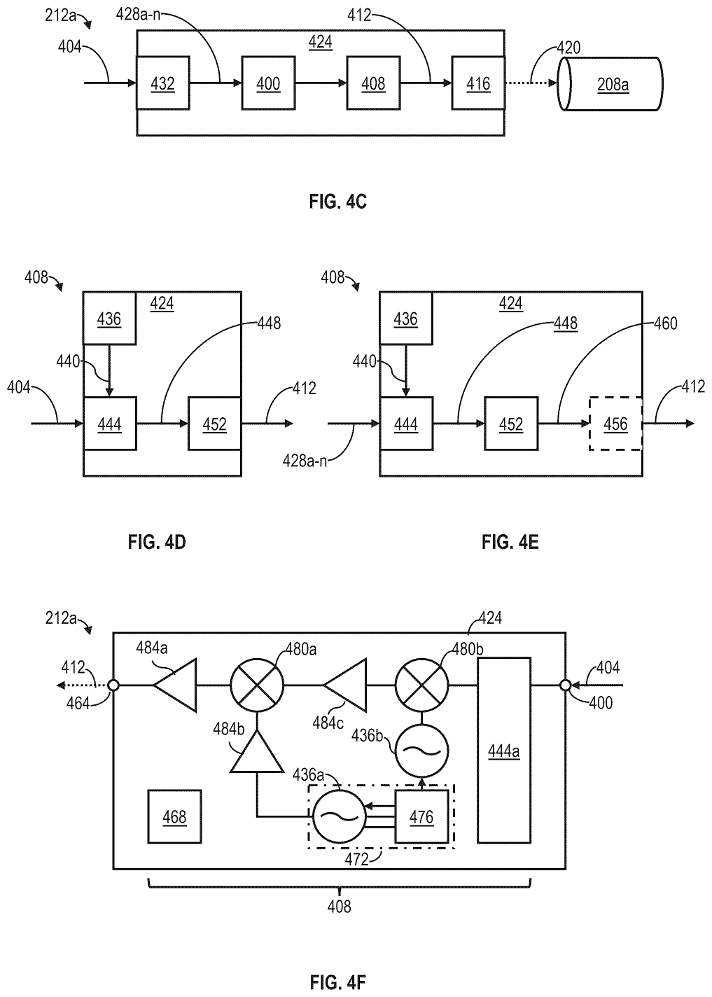

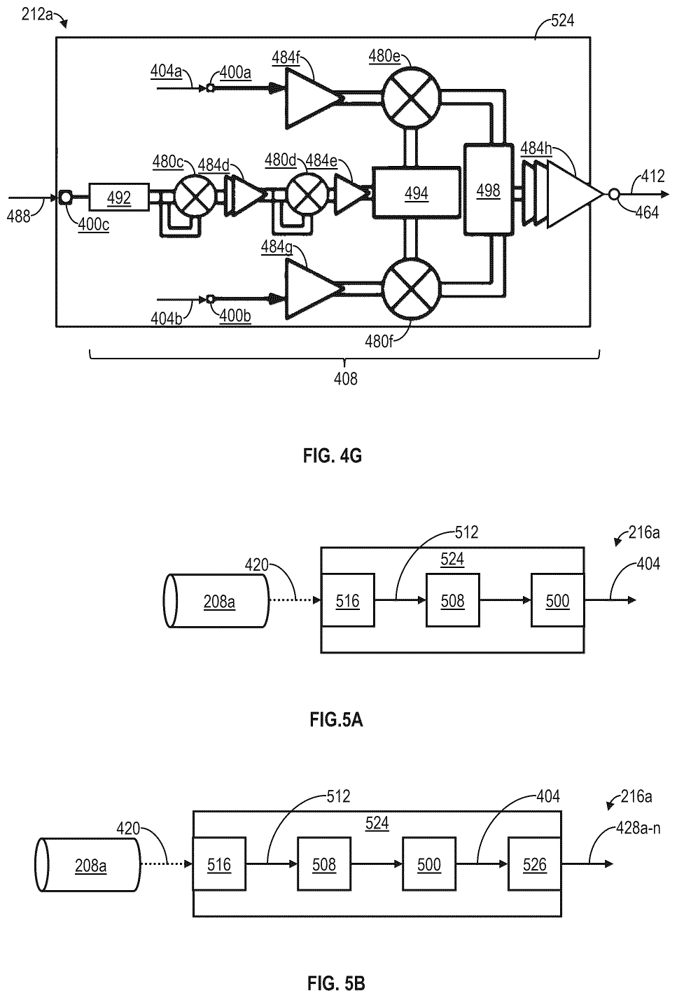

Referring now to FIG. 4A, shown therein is a block diagram of an exemplary embodiment of the first transmitter 212a shown in FIG. 2. However, it should be understood that the description of any particular one of the transmitter 212 may be applicable to any of the transmitters 212 described herein. The first transmitter 212a (and, therefore, each of the transmitters 212) generally comprises a client-side input 400 configured to receive one or more baseband signals 404 (hereinafter, the “baseband signals 404”) having client data encoded therein from one or more external component (e.g., a control module 224), transmitter circuitry 408 configured to receive the baseband signals 404 from the client-side input 400 and generate one or more antenna feed signals 412 (hereinafter, the “antenna feed signals 412”) based on the baseband signals 404, and one or more first antennas 416 (hereinafter, the “first antennas 416”) configured to receive the antenna feed signals 412 from the transmitter circuitry 408, generate one or more radiated signals 420 (hereinafter, the “radiated signals 420”) based on the antenna feed signals 412, and couple the radiated signals 420 into the first hollow waveguide 208a.

In some embodiments, the client-side input 400 is a pair of inputs configured to receive a differential signal. In some such embodiments, the client-side input 400 may be a low voltage differential signaling (LVDS) link configured to receive LVDS signals, and the baseband signals 404 may be LVDS signals indicative of client data.

In some embodiments, the antenna feed signals 412 are provided to the first antennas 416 on one or more transmission lines (not shown) (hereinafter, the “transmission lines”), wherein each of the transmission lines has two or more conductors (not shown) (hereinafter, the “conductors”). In some embodiments, the transmission lines have a first transmission loss and the first hollow waveguide 208a has a second transmission loss that is less than the first transmission loss. In some embodiments, the second transmission loss is in a range between 0.001 and 20.00 decibels (dB) per meter (m) per Terabit (Tb) per second(s).

In some embodiments, as shown in FIG. 4A, each of the client-side input 400, the transmitter circuitry 408, and the first antennas 416 may be disposed on a substrate 424. However, in other embodiments, one or more of the client-side input 400, the transmitter circuitry 408, and the first antennas 416 may be disposed on a first substrate (not shown), and one or more of the client-side input 400, the transmitter circuitry 408, and the first antennas 416 may not be disposed on the first substrate. For example, one or more of the client-side input 400, the transmitter circuitry 408, and the first antennas 416 may be disposed on a second substrate (not shown). In such embodiments, the first substrate and the second substrate may be in a stacked arrangement.

In some embodiments, the substrate 424 may have a plurality of layers (not shown). In such embodiments, one or more of the client-side input 400, the transmitter circuitry 408, and the first antennas 416 may be disposed on a first layer (not shown), and one or more of the client-side input 400, the transmitter circuitry 408, and the first antennas 416 may be disposed on a second layer (not shown).

In some embodiments, one or more of the client-side input 400, the transmitter circuitry 408, and the first antennas 416 may be integrated into a monolithic semiconductor die. In some embodiments, one or more of the client-side input 400, the transmitter circuitry 408, and the first antennas 416 may implemented using one or more of complementary metal-oxide semiconductor (CMOS) technology, silicon-germanium (SiGe) semiconductor technology, and III-V compound semiconductor technology.

In some embodiments, the baseband signals 404 are digital bitstreams. In some embodiments, the client data may be encoded in the baseband signals 404 using a modulation protocol conforming to requirements of one or more of return-to-zero (RZ) code, non-return-to-zero (NRZ) code, pulse-amplitude modulation (PAM), and quadrature-amplitude modulation (QAM). In some embodiments, the client data may be encoded in the radiated signals 420 using a modulation protocol conforming to requirements of one or more of RZ, NRZ, quadrature phase-shift keying (QPSK), QAM, trellis coded modulation (TCM), and Bose-Chaudhuri-Hocquenghem (BCH) code.

In some embodiments, the radiated signals 420 include a first complementary radiated signal having a first polarization and a second complementary radiated signal (not shown) having a second polarization different from the first polarization. In such embodiments, the first antenna 416 may be configured to generate the radiated signals 420 including the first complementary radiated signal and the second complementary radiated signal based on the antenna feed signals 412. The first polarization and the second polarization may be orthogonal to each other.

In some embodiments, each of the first polarization and the second polarization may be a linear polarization. In such embodiments, the first antenna 416 may include one or more of a differential waveguide probe antenna, a differential tapered antenna, and a differential patch antenna. In other embodiments, each of the first polarization and the second polarization may be a circular polarization. In such embodiments, the first antenna 416 may include one or more of a helix antenna and a spiral antenna.

In some embodiments, the radiated signals 420 include a first complementary radiated signal having a first polarization and a second complementary radiated signal having a second polarization different from the first polarization, and the first antennas 416 are further configured to couple the first complementary radiated signal and the second complementary radiated signal into the first hollow waveguide 208a such that the first complementary radiated signal and the second complementary radiated signal interact in the first hollow waveguide 208a to form the combined radiated signal having a third polarization different from the first polarization and the second polarization. In such embodiments, the first antennas 416 may include an antenna array.

Referring now to FIG. 4B, in some embodiments, the first transmitter 212a (and, therefore, any of the transmitters 212) further comprises a first serializer 426 configured to receive a plurality of parallel baseband signals 428a-n (hereinafter, the “parallel baseband signals 428”) and combine the parallel baseband signals 428 into a serial baseband signal (i.e., the baseband signals 404). In such embodiments, the client-side input 400 may be configured to receive the baseband signals 404 from the first serializer 426. In some such embodiments, combining the parallel baseband signals 428 into the baseband signals 404 utilizes at least one of polarization division multiplexing (PDM), time division multiplexing (TDM), and wavelength division multiplexing (WDM).

Referring now to FIG. 4C, in some embodiments, the first transmitter 212a (and, therefore, any of the transmitters 212) further comprises a first deserializer 432 configured to receive a serial baseband signal (i.e., the baseband signals 404) and split the baseband signals 404 into parallel baseband signals 428. In such embodiments, the client-side input 400 may be configured to receive the parallel baseband signals 428 from the first deserializer 432. In some such embodiments, splitting the baseband signals 404 into the parallel baseband signals 428 utilizes at least one of PDM, TDM, and WDM.

Referring now to FIG. 4D, shown therein is an exemplary embodiment of the transmitter circuitry 408 shown in FIGS. 4A-4C. In some embodiments, the transmitter circuitry 408 comprises one or more local oscillators 436a-n (hereinafter, the “LO 436”) configured to generate one or more carrier signals 440 (hereinafter, the “carrier signals 440”) having a baseband frequency less than the transmission frequency, one or more modulation circuits 444 (hereinafter, the “modulator 444”) configured to receive the baseband signals 404 from the client-side input 400 and the carrier signals 440 from the LO 436 and modulate the baseband signals 404 onto the carrier signals 440 to generate one or more modulated signals 448 (hereinafter, the “modulated signals 448”), and one or more up-conversion circuits 452 (hereinafter, the “up-convertor 452”) configured to receive the modulated signals 448 from the modulator 444 and up-convert the modulated signals 448 (i.e., raise a frequency of the modulated signals 448 from the baseband frequency to the transmission frequency) to generate the antenna feed signals 412.

Referring now to FIG. 4E, in embodiments in which the client-side input 400 is configured to receive the parallel baseband signals 428, the transmitter circuitry 408 may be configured to receive the parallel baseband signals 428 from the client-side input 400. In such embodiments, the modulator 444 may be configured to receive the parallel baseband signals 428 from the client-side input 400 and the carrier signals 440 from first LO 436 and modulate the parallel baseband signals 428 onto the carrier signals 440 to generate the modulated signals 448. In such embodiments, the up-converter 452 may be configured to receive the modulated signals 448 from the modulator 444 and up-convert the modulated signals 448 to generate one or more up-converted signals 460 (hereinafter, the “up-converted signals 460”).

In some embodiments, the transmitter circuitry 408 may further comprise a combiner 456 configured to receive the up-converted signals 460 from the up-converter 452 and combine the up-converted signals 460 into the antenna feed signals 412. However, in other embodiments, the first antennas 416 may be configured to receive the antenna feed signals 412 from the up-converter 452, generate the radiated signals 420 based on the antenna feed signals 412, and couple the radiated signals 420 into the first hollow waveguide 208a such that the radiated signals 420 interact in the first hollow waveguide 208a to form a combined radiated signal.

In some embodiments, coupling the radiated signals 420 into the first hollow waveguide 208a such that the radiated signals 420 interact in the first hollow waveguide 208a to form the combined radiated signal utilizes at least one of PDM, TDM, and WDM.

Referring now to FIG. 4F, shown therein is a block diagram of another exemplary embodiment of the first transmitter 212a shown in FIG. 2. However, it should be understood that the description of any particular one of the transmitters 212 may be applicable to any of the transmitters 212 described herein.

In the embodiment shown in FIG. 4F, the first transmitter 212a comprises the client-side input 400 configured to receive the baseband signals 404 from one or more external component (e.g., a control module 224) and send the baseband signals 404 to the transmitter circuitry 408, the transmitter circuitry 408 configured to receive the baseband signals 404 from the client-side input 400, generate the antenna feed signals 412 based on the baseband signals 404, and send the antenna feed signals 412 to an RF interface 464 configured to receive the antenna feed signals 412 from the transmitter circuitry 408 and transmit the antenna feed signals 412, and a digital enhancement and control unit 468 configured to provide digital control and/or processing capabilities for one or more of the components of the first transmitter 212a.

In the embodiment shown in FIG. 4F, the transmitter circuitry 408 comprises one or more modulation block 444a (hereinafter, the “modulation block 444a”), a frequency synthesizer 472 comprising a phase-locked loop (PLL) 476 and a first LO 436a, a second LO 436b, a first frequency mixer 480a, a second frequency mixer 480b, a first amplifier 484a, and a second amplifier 484b.

The modulation block 444a may be configured to receive the baseband signals 404 from the client-side input 400 and encode the baseband signals 404 in a format suitable for modulation onto a carrier signal. In some embodiments, the modulation block 444a may include one or more digital-to-analog converter (DAC), one or more Serializer/Deserializers (SerDes), one or more folded cascode modulators 700 (shown in FIG. 7), and/or circuitry operable to encode the baseband signals 404 in a modulation format, such as AM, ASK, PSK, QAM, QAM16, or variations thereof, for example. In some embodiments, the modulation block 444a may include circuitry operable to perform forward error correction (FEC). The modulation block 444a may be further configured to send the encoded input signals having the data encoded therein to the second frequency mixer 480b.

In some embodiments, the modulation block 444a is configured to simply receive the baseband signals 404 (i.e., the baseband signals 404 having been previously encoded in a modulation format) from the client-side input 400 and send the baseband signals 404 to the second frequency mixer 480b.

The second LO 436b may be configured to generate second carrier signals having a continuous waveform (e.g., a sinusoidal waveform) having a predetermined frequency (i.e., a baseband (BB) frequency). In some embodiments, the predetermined frequency of the second carrier signals (i.e., the BB frequency) is in an RF band (i.e., in a range between 30 Hertz (Hz) and 300 GHz). In some embodiments, the predetermined frequency of the second carrier signals (i.e., the BB frequency) is in a range between 1 Megahertz (MHz) and 300 GHz. In some embodiments, the predetermined frequency of the second carrier signals (i.e., the BB frequency) is in a range between 5 GHz and 30 GHz. The second LO 436b may be further configured to send the second carrier signals to the second frequency mixer 480b.

The second frequency mixer 480b may be configured to receive the encoded baseband signals from the modulation block 444a, receive the second carrier signals from the second LO 436b, up-convert the encoded baseband signals with the second carrier signals to produce first modulated signals having client data encoded therein and having the predetermined frequency of the second carrier signals (i.e., the BB frequency), and send the first modulated signals to the third amplifier 484c.

The third amplifier 484c may be configured to receive the first modulated signals from the second frequency mixer 480b, adjust an amplitude of the first modulated signals such that the amplified first modulated signals can drive the first frequency mixer 480a, and send the amplified first modulated signals to the first frequency mixer 480a.

The frequency synthesizer 472 (i.e., the first LO 436a and the PLL 476) may be configured to generate first carrier signals having a continuous waveform (e.g., a sinusoidal waveform) having a predetermined frequency (e.g., within the THz frequency band 104 or, in some embodiments, in a range between 300 GHz and 10 THz). In some embodiments, the predetermined frequency of the first carrier signals is in a range between 30 GHz and 300 GHz. In some such embodiments, the predetermined frequency of the first carrier signals is 240 GHz. In other embodiments, the predetermined frequency of the first carrier signals is in a range between 300 GHz and 3 THz. The frequency synthesizer 472 may be further configured to send the first carrier signals to the second amplifier 484b.

The second amplifier 484b may be configured to receive the first carrier signals from the first LO 436a, adjust an amplitude of the first carrier signals to generate amplified carrier signals that can drive the first frequency mixer 480a, and send the amplified carrier signals to the first frequency mixer 480a.

In some embodiments, the PLL 476 is configured to generate a PLL reference signal and synchronize one or more of the first LO 436a and the second LO 436b such that one or more of the first carrier signals and the second carrier signals maintains a fixed phase relationship with the PLL reference signal.

The first frequency mixer 480a may be configured to receive the amplified carrier signals from the second amplifier 484b, receive the amplified first modulated signals from the third amplifier 484c, up-convert the amplified first modulated signals with the amplified carrier signals to produce second modulated signals having the client data encoded therein and having the predetermined frequency of the amplified carrier signals (i.e., within the THz frequency band 104 or, in some embodiments, in a range between 300 GHz and 10 THz), and send the second modulated signals to the first amplifier 484a.

The first amplifier 484a may be configured to receive the second modulated signals from the first frequency mixer 480a, adjust an amplitude of the second modulated signals such that the amplified second modulated signals can be transmitted by the RF interface 464, and send the amplified second modulated signals to the RF interface 464. The first amplifier 484a may be configured to generate the amplified second modulated signals to have a power in a range between 0.05 watts (W) and 0.4 W, for example.

The RF interface 464 may be configured to receive the amplified second modulated signals with the client data encoded therein from the first amplifier 484a and send the amplified second modulated signals as the antenna feed signals 412 (i.e., having the client data encoded therein) within a predetermined frequency range (e.g., the THz frequency band 104 or, in some embodiments, in a range between 300 GHz and 10 THz). In some embodiments, the RF interface 464 may be electrically connected to one of the first antennas 416 and configured to send the antenna feed signals 412 to the first antenna 416. In other embodiments, however, the first antennas 416 may be included in place of the RF interface 464.

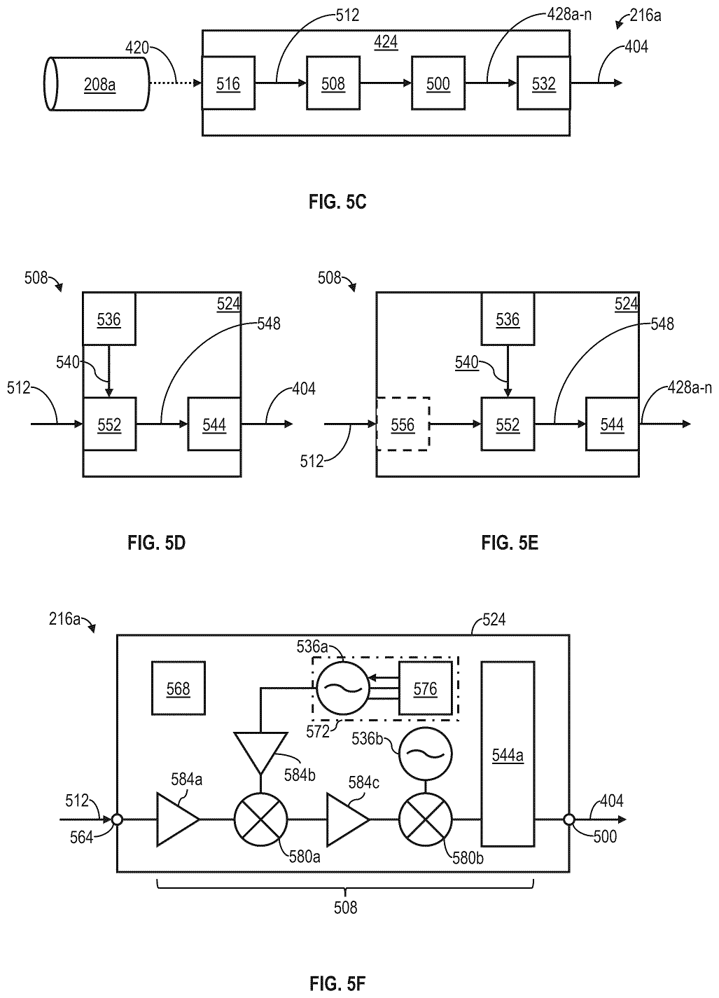

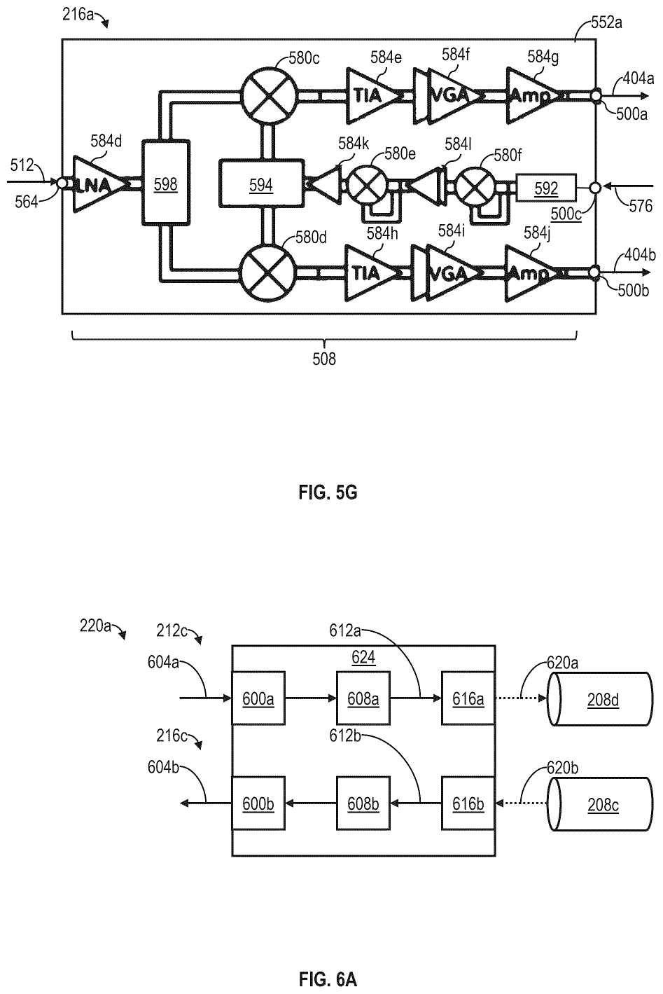

Referring now to FIG. 4G, shown therein is a block diagram of another exemplary embodiment of the first transmitter 212a shown in FIG. 2. In the embodiment shown in FIG. 5B, the first transmitter 212a comprises a plurality of inputs including an in-phase (I)-BB client-side input 400a and a quadrature (Q)-BB client-side input 400b configured to receive I-BB baseband signals 404a and Q-BB baseband signals 404b, respectively, from one or more external component (e.g., a control module 224) and an LO input 400c configured to receive one or more carrier signals 488 (hereinafter, the “carrier signals 488”) from an external LO, the transmitter circuitry 408 configured to generate the antenna feed signals 412 based on the I-BB baseband signals 404a, the Q-BB baseband signals 404b, and the carrier signals 488, and the RF interface 464 configured to transmit the antenna feed signals 412.

In the embodiment shown in FIG. 4G, the transmitter circuitry 408 comprises a balanced to unbalanced converter element (Balun) 492, a third frequency mixer 480c, a fourth frequency mixer 480d, a fifth frequency mixer 480e, and a sixth frequency mixer 480f, a fourth amplifier 484d, a fifth amplifier 484e, a sixth amplifier 484f, a seventh amplifier 484g, and eighth amplifier 484h, a quadrature coupler (e.g., branch-line coupler) 494, and a power combiner (e.g., Wilkinson power combiner) 498.

The I-BB baseband signals 404a and the Q-BB baseband signals 404b may be I and Q components of baseband signals 404 having client data encoded therein. The I-BB client-side input 400a may be configured to send the I-BB baseband signals 404a to the sixth amplifier 484f. The Q-BB client-side input 400b may be configured to send the Q-BB baseband signals 404b to the seventh amplifier 484g.

The LO input 400c may be configured to receive the carrier signals 488 from an external LO, the carrier signals 488 having a continuous waveform (e.g., a sinusoidal waveform) having a predetermined frequency. The LO input 400c may be further configured to send the carrier signals 488 to the Balun 492.

The Balun 492 may be configured to isolate and/or maintain impedance differences between balanced transmission lines and unbalanced transmission lines. The Balun 492 may be further configured to send the carrier signals 488 to the third frequency mixer 480c.

The third frequency mixer 480c may be configured to receive the carrier signals 488 from the Balun 492, multiply the carrier signals 488 (e.g., by a multiple of four), and send the multiplied carrier signals to the fourth amplifier 484d.

The fourth amplifier 484d may be configured to receive the multiplied carrier signals from the third frequency mixer 480c, adjust an amplitude of the multiplied carrier signals such that the amplified carrier signals can drive the fourth frequency mixer 480d, and send the amplified carrier signals to the fourth frequency mixer 480d.

The fourth frequency mixer 480d may be configured to receive the amplified carrier signals from the fourth amplifier 484d, multiply the amplified carrier signals (e.g., by a multiple of two), and send the remultiplied carrier signals to the fifth amplifier 484e.

The fifth amplifier 484e may be configured to receive the remultiplied carrier signals from the fourth frequency mixer 480d, adjust an amplitude of the remultiplied carrier signals such that the reamplified carrier signals can drive the quadrature coupler 494, and send the reamplified carrier signals to the quadrature coupler 494.

The sixth amplifier 484f may be configured to receive the I-BB baseband signals 404a from the I-BB client-side input 400a, adjust an amplitude of the I-BB baseband signals 404a such that the amplified I-BB input signals can drive the fifth frequency mixer 480e, and send the amplified I-BB signals to the fifth frequency mixer 480e.

The seventh amplifier 484g may be configured to receive the Q-BB baseband signals 404b from the Q-BB client-side input 400b, adjust an amplitude of the Q-BB baseband signals 404b such that the amplified Q-BB baseband signals 404b can drive the sixth frequency mixer 480f, and the amplified Q-BB signals to the sixth frequency mixer 480f.

The quadrature coupler 494 may be configured to receive the reamplified carrier signals from the fifth amplifier 484e, split the reamplified carrier signals into first carrier signals and second carrier signals, send the first carrier signals to the fifth frequency mixer 480e, and send the second carrier signals to the sixth frequency mixer 480f, wherein the first carrier signals and the second carrier signals are out of phase by 90°.

The fifth frequency mixer 480e may be configured to receive the amplified I-BB signals from the sixth amplifier 484f, receive the first carrier signals from the quadrature coupler 494, up-convert the amplified I-BB signals with the first carrier signals to produce I antenna feed signals having the I component of the client data encoded therein and having the predetermined frequency of the carrier signals 488, and send the I antenna feed signals to the power combiner 498.

The sixth frequency mixer 480f may be configured to receive the amplified Q-BB signals from the seventh amplifier 484g, receive the second carrier signals from the quadrature coupler 494, up-convert the amplified Q-BB signals with the second carrier signals to produce Q antenna feed signals having the Q component of the client data encoded therein and having the predetermined frequency of the carrier signals 488, and send the Q antenna feed signals to the power combiner 498.

The power combiner 498 may be configured to receive the I antenna feed signals from the fifth frequency mixer 480e, receive the Q antenna feed signals from the sixth frequency mixer 480f, combine the I antenna feed signals and the Q antenna feed signals to produce the antenna feed signals 412, and send the antenna feed signals 412 to the RF interface 464. In some embodiments, the RF interface 464 may be electrically connected to one of the first antennas 416 and configured to send the antenna feed signals 412 to the first antenna 416. In other embodiments, however, one of the first antennas 416 may be included in place of the RF interface 464.

Referring now to FIG. 5A, shown therein is a block diagram of an exemplary embodiment of the first receiver 216a (hereinafter, the “first receiver 216a”) shown in FIG. 2. However, it should be understood that the description of any particular one of the receivers 216 may be applicable to any of the receivers 216 described herein. The first receiver 216a (and, therefore, each of the receiver 216) generally comprises one or more second antennas 516 configured to coherently detect the radiated signals 420 received from the first hollow waveguide 208a and generate one or more antenna output signals 512 (hereinafter, the “antenna output signals 512”) based on the radiated signals 420, receiver circuitry 508 configured to receive the antenna output signals 512 from the second antennas 516 and generate the baseband signals 404 based on the antenna output signals 512, and a client-side output 500 configured to receive the baseband signals 404 from the receiver circuitry 508 and transmit the baseband signals 404 to one or more external component (e.g., a control module 224).

In some embodiments, the antenna output signals 512 are received from the second antennas 516 on one or more transmission lines (not shown) (hereinafter, the “transmission lines”), wherein each of the transmission lines has two or more conductors (not shown) (hereinafter, the “conductors”). In some embodiments, the transmission lines have a first transmission loss and the first hollow waveguide 208a has a second transmission loss that is less than the first transmission loss. In some embodiments, the second transmission loss is in a range between 0.001 and 20.00 dB/m/Tb/s.

In some embodiments, as shown in FIG. 5A, each of the second antennas 516, the receiver circuitry 508, and the client-side output 500 may be disposed on a substrate 524. However, in other embodiments, one or more of the second antennas 516, the receiver circuitry 508, and the client-side output 500 may be disposed on a first substrate (not shown), and one or more of the second antennas 516, the receiver circuitry 508, and the client-side output 500 may not be disposed on the first substrate. For example, the one or more of the second antennas 516, the receiver circuitry 508, and the client-side output 500 may be disposed on a second substrate (not shown). In such embodiments, the first substrate and the second substrate may be in a stacked arrangement.

In some embodiments, the substrate 524 may have a plurality of layers (not shown). In such embodiments, one or more of the second antennas 516, the receiver circuitry 508, and the client-side output 500 may be disposed on a first layer (not shown), and one or more of the second antennas 516, the receiver circuitry 508, and the client-side output 500 may be disposed on a second layer (not shown).

In some embodiments, one or more of the second antennas 516, the receiver circuitry 508, and the client-side output 500 may be integrated into a monolithic semiconductor die. In some embodiments, one or more of the second antennas 516, the receiver circuitry 508, and the client-side output 500 may implemented using one or more of CMOS technology, SiGe semiconductor technology, and III-V compound semiconductor technology.

In some embodiments, the radiated signals 420 include a first complementary radiated signal having a first polarization and a second complementary radiated signal having a second polarization different from the first polarization. In such embodiments, the second antennas 516 may be configured to generate the antenna output signals 512 based on the radiated signals 420 including the first complementary radiated signal and the second complementary radiated signal. The first polarization and the second polarization may be orthogonal to each other.

In some embodiments, the radiated signals 420 may be formed by a first complementary radiated signal having a first polarization and a second complementary radiated signal having a second polarization different from the first polarization interacting in the first hollow waveguide 208a. In such embodiments, the radiated signals 420 may have a third polarization different from the first polarization and the second polarization. In such embodiments, the second antennas 516 may be configured generate the antenna output signals 512 based on the radiated signals 420 formed by the first complementary radiated signal and the second complementary radiated signal.

Referring now to FIG. 5B, in some embodiments, the client-side output 500 is configured to receive a serial baseband signal (i.e., the baseband signals 404) from the receiver circuitry 508. In such embodiments, the first receiver 216a (and, therefore, any of the receivers 216) may further comprise a second deserializer 526 configured to receive the baseband signals 404 from the client-side output 500, split the serial baseband signal into the parallel baseband signals 428, and transmit the parallel baseband signals 428 to one or more external component (e.g., a control module 224). In some such embodiments, splitting the serial baseband signal into the parallel baseband signals 428 utilizes at least one of PDM, TDM, and WDM.

Referring now to FIG. 5C, in some embodiments, the client-side output 500 is configured to receive the parallel baseband signals 428 from the receiver circuitry 508. In such embodiments, the first receiver 216a (and, therefore, any of the receivers 216) may further comprise a second serializer 532 configured to receive the parallel baseband signals 428 from the client-side output 500 and combine the parallel baseband signals 428 into the serial baseband signal (i.e., the baseband signals 404). In some such embodiments, combining the parallel baseband signals 428 into the baseband signals 404 utilizes at least one of PDM, TDM, and WDM.

Referring now to FIG. 5D, shown therein is an exemplary embodiment of the receiver circuitry 508 shown in FIGS. 5A-5C. In some embodiments, the receiver circuitry 508 comprises one or more LOs 536 (hereinafter, the “LO 536”) configured to generate one or more reference signals 540 (hereinafter, the “reference signals 540”) having a baseband frequency less than the transmission frequency, one or more down-conversion circuits 552 (hereinafter, the “down-converter 552”) configured to receive the antenna output signals 512 from the second antennas 516 and the reference signals 540 from the LO 536 and down-convert the antenna output signals 512 (i.e., lower a frequency of the antenna output signals 512 from the transmission frequency to the baseband frequency) using the reference signals 540 to generate one or more modulated signals 548 (hereinafter, the “modulated signals 548”), and one or more demodulation circuits 544 (hereinafter, the “demodulator 544”) configured to receive the modulated signals 548 from the down-converter 552 and demodulate the modulated signals 548 to generate the baseband signals 404.

Referring now to FIG. 5E, in embodiments in which the second antennas 516 are configured to receive the radiated signals 420 formed by a first complementary radiated signal having a first polarization and a second complementary radiated signal having a second polarization different from the first polarization interacting in the first hollow waveguide 208a, the receiver circuitry 508 may be configured to receive the antenna output signals 512 from the second antennas 516. In such embodiments, the demodulator 544 may be configured to receive the modulated signals 548 from the down-converter 552 and demodulate the modulated signals 548 to generate the parallel baseband signals 428.

In some embodiments, the receiver circuitry 508 may further comprise a splitter 556 configured to receive the antenna output signals 512 from the second antennas 516 and split the antenna output signals 512 into a plurality of parallel antenna output signals 560 (hereinafter, the “parallel antenna output signals 560”). However, in other embodiments, the second antennas 516 may be configured to coherently detect the first complementary radiated signal and the second complementary radiated signal based on the radiated signals 420 received from the first hollow waveguide 208a and generate the antenna output signals 512 based on the first complementary radiated signal and the second complementary radiated signal.

In some embodiments, detecting the first complementary radiated signal and the second complementary radiated signal based on the radiated signals 520 received from the first hollow waveguide 208a utilizes at least one of PDM, TDM, and WDM.

Referring now to FIG. 5F, shown therein is a block diagram of another exemplary embodiment of the first receiver 216a shown in FIG. 2. In the embodiment shown in FIG. 5F, the first receiver 216a comprises an RF interface 564 configured to receive the antenna output signals 512, the receiver circuitry 508 configured to generate the baseband signals 404 based on the antenna output signals 512, the client-side output 500 configured to transmit the baseband signals 404 to one or more external component (e.g., a control module 224), and a digital enhancement and control unit 568 configured to provide digital control and/or processing capabilities for one or more of the components of the first receiver 216a.

In the embodiment shown, the receiver circuitry 508 comprises one or more demodulation block 544a (hereinafter, the “demodulation block 544a”), a frequency synthesizer 572 comprising a PLL 576 and a first LO 536a, a second LO 536b, a first frequency mixer 580a, a second frequency mixer 580b, a first amplifier 584a, a second amplifier 584b, and a third amplifier 584c.

The RF interface 564 may be configured to send the antenna output signals 512 to the first amplifier 584a. In some embodiments, the RF interface 564 may be configured to receive the antenna output signals 512 from one of the second antennas 516. In other embodiments, one of the second antennas 516 may be included in place of the RF interface 564.

The first amplifier 584a may be configured to receive the antenna output signals 512 from the RF interface 564, adjust an amplitude of the antenna output signals 512 such that the amplified transmission signals can drive the first frequency mixer 580a, and send the amplified transmission signals to the first frequency mixer 580a.

The frequency synthesizer 572 (i.e., the first LO 536a and the PLL 576) may be configured to generate first carrier signals having a continuous waveform (e.g., a sinusoidal waveform) having a predetermined frequency (e.g., within the THz frequency band 104 or, in some embodiments, in a range between 300 GHz and 10 THz). In some embodiments, the predetermined frequency of the first carrier signals is in a range between 30 GHz and 300 GHz. In some such embodiments, the predetermined frequency of the first carrier signals is 240 GHz. In other embodiments, the predetermined frequency of the first carrier signals is in a range between 300 GHz and 3 THz. The first LO 536a may be further configured to send the first carrier signals to the second amplifier 584b.

The second amplifier 584b may be configured to receive the first carrier signals from the first LO 536a, adjust an amplitude of the first carrier signals to generate amplified carrier signals that can drive the first frequency mixer 580a, and send the amplified carrier signals to the first frequency mixer 580a.

The first frequency mixer 580a may be configured to receive the antenna output signals 512 from the first amplifier 584a, receive the amplified carrier signals from the second amplifier 584b, down-convert the antenna output signals 512 with the amplified carrier signals to produce modulated signals having the client data encoded therein and having the BB frequency, and send the modulated signals to the third amplifier 584c.

The third amplifier 584c may be configured to receive the modulated signals from the first frequency mixer 580a, adjust an amplitude of the modulated signals such that the amplified modulated signals can drive the second frequency mixer 580b, and send the amplified modulated signals to the second frequency mixer 580b.

The second LO 536b may be configured to generate second carrier signals having a continuous waveform (e.g., a sinusoidal waveform) having a predetermined frequency (i.e., the BB frequency). In some embodiments, the predetermined frequency of the second carrier signals (i.e., the BB frequency) is in a range between 8 GHz and 10 GHz. The second LO 536b may be further configured to send the second carrier signals to the second frequency mixer 580b.

The second frequency mixer 580b may be configured to receive the amplified modulated signals from the third amplifier 584c, receive the second carrier signals from the second LO 536b, down-convert the amplified modulated signals with the second carrier signals to produce encoded signals having the client data encoded therein and having the predetermined frequency of the second carrier signals (i.e., the BB frequency), and send the encoded signals to the demodulation block 544a.

The demodulation block 544a may be configured to receive the encoded signals from the second frequency mixer 580b and decode the encoded signals in a format suitable for transmission to one or more external component (e.g., a control module 224) to generate the baseband signals 404.

In some embodiments, the demodulation block 544a may include one or more analog-to-digital converter (ADC), one or more Serializer/Deserializer (SerDes), one or more rectifying detector 800 (shown in FIG. 8), and/or circuitry operable to decode the encoded output signals from a modulation format, such as AM, ASK, PSK, QAM, or QAM16, or variations thereof, for example, to produce the baseband signals 404 with the client data encoded therein. In some embodiments, the demodulation block 544a may include circuitry operable to perform forward error correction (FEC). The demodulation block 544a may be further configured to send the baseband signals 404 to the client-side output 500. In some embodiments, the demodulation block 544a is configured to simply receive the encoded signals from the second frequency mixer 580b and send the encoded signals as the baseband signals 404 to the client-side output 500.

In some embodiments, the client-side output 500 is a pair of output interfaces. In some such embodiments, the client-side output 500 is an LVDS link configured to transmit LVDS signals, and the baseband signals 404 are LVDS signals with the client data encoded therein.

Referring now to FIG. 5G, shown therein is a block diagram of another exemplary embodiment of the first receiver 216a shown in FIG. 2. In the embodiment shown in FIG. 5G, the first receiver 216a comprises the RF interface 564 configured to receive the antenna output signals 512, an LO input 500c configured to receive carrier signals 588 from an external LO, the receiver circuitry 508 configured to generate Q-BB baseband signals 404b and I-BB baseband signals 404a based on the antenna output signals 512 and the carrier signals 588, and a Q-BB client-side output 500a and an I-BB client-side output 500b configured to transmit the Q-BB baseband signals 404b and the I-BB baseband signals 404a, respectively.

In the embodiment shown, the receiver circuitry 508a comprises a third frequency mixer 580c, a fourth frequency mixer 580d, a fifth frequency mixer 580e, a sixth frequency mixer 580f, a fourth amplifier 584d, a fifth amplifier 584e, a sixth amplifier 584f, a seventh amplifier 584g, an eighth amplifier 584h, a ninth amplifier 584i, a tenth amplifier 584j, an eleventh amplifier 584k, a twelfth amplifier 584l, a Balun 592, a quadrature coupler (e.g., branchline coupler) 594, and a power divider (e.g., Wilkinson power divider) 598.

The fourth amplifier 584d may be configured to receive the antenna output signals 512 from the RF interface 564, adjust an amplitude of the antenna output signals 512 such that the amplified transmission signals can drive the power divider 598, and send the amplified transmission signals to the power divider 598. In some embodiments, the fourth amplifier 584d is a low-noise amplifier (LNA).

The power divider 598 may be configured to receive the amplified transmission signals from the fourth amplifier 584d, split the amplified transmission signals into I antenna output signals having the I component of the client data encoded therein and Q antenna output signals having the Q component of the client data encoded therein, send the Q antenna output signals to the third frequency mixer 580c, and send the I antenna output signals to the fourth frequency mixer 580d.

The LO input 500c may be configured to receive carrier signals 588 from an external LO, the carrier signals 588 having a continuous waveform (e.g., a sinusoidal waveform) having a predetermined frequency. The LO input 500c may be further configured to send the carrier signals 588 to the Balun 592.

The Balun 592 may be configured to isolate and/or maintain impedance differences between balanced transmission lines and unbalanced transmission lines. The Balun 492 may be further configured to send the carrier signals 588 to the sixth frequency mixer 580f.

The sixth frequency mixer 580f may be configured to receive the carrier signals 588 from the Balun 592, multiply the carrier signals 588 (e.g., by a multiple of four), and send the multiplied carrier signals to the twelfth amplifier 584l.

The twelfth amplifier 584| may be configured to receive the multiplied carrier signals from the sixth frequency mixer 580f, adjust an amplitude of the multiplied carrier signals to generate amplified carrier signals that can drive the fifth frequency mixer 580e, and send the amplified carrier signals to the fifth frequency mixer 580e.

The fifth frequency mixer 580e may be configured to receive the amplified carrier signals from the twelfth amplifier 584l, multiply the amplified carrier signals (e.g., by a multiple of two), and send the remultiplied carrier signals to the eleventh amplifier 584k.

The eleventh amplifier 584k may be configured to receive the remultiplied carrier signals from the fifth frequency mixer 580e, adjust an amplitude of the remultiplied carrier signals to generate reamplified carrier signals that can drive the quadrature coupler 594, and send the reamplified carrier signals to the quadrature coupler 594.

The quadrature coupler 594 may be configured to receive the reamplified carrier signals from the eleventh amplifier 584k, split the reamplified carrier signals into first carrier signals and second carrier signals, send the first carrier signals to the third frequency mixer 580c, and send the second carrier signals to the fourth frequency mixer 580d, wherein the first carrier signals and the second carrier signals are out of phase by 90°.

The third frequency mixer 580c may be configured to receive the Q antenna output signals from the power divider 598, receive the first carrier signals from the quadrature coupler (e.g., branchline coupler) 566, down-convert the Q antenna output signals with the first carrier signals to generate Q-BB intermediate signals having the Q component of the client data encoded therein and having the BB frequency, and send the Q-BB intermediate signals to the fifth amplifier 584e.

The fifth amplifier 584e, the sixth amplifier 584f, and the seventh amplifier 584g may be configured to receive the Q-BB intermediate signals from the third frequency mixer 580c, down-convert the Q-BB intermediate signals to generate the Q-BB baseband signals 404b, and send the Q-BB baseband signals 404b to the Q-BB client-side output 500a. In some embodiments, the fifth amplifier 584e is a transimpedance amplifier (TIA), and the sixth amplifier 584f is a variable-gain amplifier (VGA).

The fourth frequency mixer 580d may be configured to receive the I antenna output signals from the power divider 598, receive the second carrier signals from the quadrature coupler 594, down-convert the I antenna output signals with the second carrier signals to produce I-BB intermediate signals having the I component of the client data encoded therein and having the BB frequency, and send the I-BB intermediate signals to the eighth amplifier 584h.

The eighth amplifier 584h, the ninth amplifier 584i, and the tenth amplifier 584j may be configured to receive the I-BB intermediate signals from the fourth frequency mixer 580d, down-convert the I-BB intermediate signals to generate the I-BB baseband signals 404a, and send the I-BB baseband signals 404a to the I-BB client-side output 500b. In some embodiments, the eighth amplifier 584h is a TIA, and the ninth amplifier 584i is VGA.

Referring now to FIG. 6A, shown therein is a block diagram of an exemplary embodiment of the first transceiver 220a (hereinafter, the “first transceiver 220a”) shown in FIG. 2. However, it should be understood that the description of any particular one of the transceivers 220 may be applicable to any of the transceivers 220 described herein. The first transceiver 220a (and, therefore, each of the transceivers 220) generally comprises a third transmitter 212c and a third receiver 216c.

The third transmitter 212c generally comprises a client-side input 600a configured to receive one or more first baseband signals 604a (hereinafter, the “first baseband signals 604a”) having first client data encoded therein from one or more external component (e.g., a control module 224), transmitter circuitry 608a configured to receive the first baseband signals 604a from the client-side input 600a and generate one or more antenna feed signals 612a (hereinafter, the “antenna feed signals 612”) based on the first baseband signals 604a, and one or more first antennas 616a (hereinafter, the “first antennas 616”) configured to receive the antenna feed signals 612a from the transmitter circuitry 608a, generate one or more first radiated signals 420a (hereinafter, the “first radiated signals 420a”) based on the antenna feed signals 612a, and couple the first radiated signals 420a into the fourth hollow waveguide 208d.

The third receiver 216c generally comprises one or more second antennas 616b (hereinafter, the “antennas 616b”) configured to coherently detect one or more second radiated signals 620b (hereinafter, the “second radiated signals 620b”) received from the third hollow waveguide 208c and generate one or more antenna output signals 612b (hereinafter, the “antenna output signals 612b”) based on the second radiated signals 620b, receiver circuitry 608b configured to receive the antenna output signals 612b from the second antennas 616b and generate the second baseband signals 604b based on the antenna output signals 612b, and a client-side output 600b configured to receive the second baseband signals 604b from the receiver circuitry 608b and transmit the second baseband signals 604b to one or more external component (e.g., a control module 224).

Each of the components of the first transceiver 220a (and, therefore, each of the transceivers 220) may be the same or similar to one or more of the components of the first transmitter 212a and the first receiver 216a as described herein.

Referring now to FIG. 6B, shown therein is a block diagram of another exemplary embodiment of the first transceiver 220a shown in FIG. 2. In the embodiment shown in FIG. 6B, the first transceiver 220a comprises the client-side input 600a configured to receive the first baseband signals 604a from one or more external component (e.g., a control module 224), the transmitter circuitry 608a configured to generate the antenna feed signals 612a based on the input signals 640a, a first RF interface 664a configured to transmit the antenna feed signals 612a, a second RF interface 664b configured to receive the antenna output signals 612b, the receiver circuitry 608b configured to generate the second baseband signals 604b based on the antenna output signals 612b, the client-side output 600b configured to transmit the second baseband signals 604b to one or more external component, and a digital enhancement and control unit 668 configured to provide digital control and/or processing capabilities for one or more of the components of the first transceiver 220a.

In some embodiments, the first transceiver 220a comprises the first RF interface 664a, but lacks the second RF interface 664b. In such embodiments, the first RF interface 664a may be configured to transmit antenna feed signals 612a and receive antenna output signals 612b. In some embodiments, the first transceiver 220a may have a number of RF interfaces that is greater than two.

In the embodiment shown, the transmitter circuitry 608a comprises a frequency synthesizer 672 comprising a PLL 676, a first LO 636a, and a signal distribution block (e.g., splitter) 698, one or more modulation block 644a (hereinafter, the “modulation block 644a”), a second LO 636b, a first frequency mixer 680a, a third frequency mixer 680c, a first amplifier 684a, a third amplifier 684c, and a fifth amplifier 684e.

In the embodiment shown, the receiver circuitry 608b comprises the frequency synthesizer 672 comprising the PLL 676, the first LO 636a, and the signal distribution 698, the modulation block 644a, a third LO 636c, a second frequency mixer 680b, a fourth frequency mixer 680d, a second amplifier 684b, a fourth amplifier 684d, and a sixth amplifier 684f.

In some embodiment shown in FIG. 6B, each of the components of the first transceiver 220a are disposed on a single substrate 624, which may be a portion of a semiconductor wafer.

The modulation block 644a may be configured to: (1) receive the first baseband signals 604a from the client-side input 600a, encode the first baseband signals 604a in a format suitable for modulation onto a carrier signal, and send the encoded input signals the third frequency mixer 680c; and (2) receive the encoded output signals from the fourth frequency mixer 680d, decode the encoded output signals in a format suitable for transmission to one or more external component (e.g., a control module 224), and send the second baseband signals 604b to the client-side output 600b.

In some embodiments, the modulation block 644a may include one or more DAC, one or more ADC, one or more Serializer/Deserializer (SerDes), one or more folded modulator 700 (shown in FIG. 7), one or more rectifying detector 800 (shown in FIG. 8) and/or circuitry operable to encode the first baseband signals 604a in a modulation format, such as AM, ASK, PSK, QAM, or QAM16, or variations thereof, for example, and decode encoded output signals from the modulation format to produce second baseband signals 604b having the client data encoded therein. In some embodiments, the modulation block 644a may include circuitry operable to perform forward error correction (FEC).

The frequency synthesizer 672 may be configured to generate first carrier signals having a continuous waveform (e.g., a sinusoidal waveform) having a predetermined frequency (e.g., within the THz frequency band 104 or in some embodiments, a range between 300 GHz and 10 THz). In some embodiments, the predetermined frequency of the first carrier signals is in a range between 30 GHz and 300 GHz. In some such embodiments, the predetermined frequency of the first carrier signals is 240 GHz. In other embodiments, the predetermined frequency of the first carrier signals is in a range between 300 GHz and 3 THz. The frequency synthesizer 672 may be further configured to send the first carrier signals to the signal distribution block 698.

The signal distribution block 698 may be configured to receive the first carrier signals from the first LO 636a and distribute the first carrier signals to the third amplifier 684c and the fourth amplifier 684d.

Referring now to the transmitter circuitry 608a, in some embodiments, the client-side input 600a is a pair of input interfaces. In some such embodiments, the client-side input 600a is an LVDS link configured to receive LVDS signals, and the first baseband signals 604a are LVDS signals having the client data encoded therein. The client-side input 600a may be further configured to send the first baseband signals 604a to the modulation block 644a.

The second LO 636b may be configured to generate second carrier signals having a continuous waveform (e.g., a sinusoidal waveform) having a predetermined frequency (i.e., the BB frequency). In some embodiments, the predetermined frequency of the second carrier signals (i.e., the BB frequency) is in a range between 8 GHz and 10 GHz. The second LO 636b may be further configured to send the second carrier signals to the third frequency mixer 680c.

The third frequency mixer 680c may be configured to receive the encoded input signals from the modulation block 644a, receive the second carrier signals from the second LO 636b, up-convert the encoded input signals with the second carrier signals to produce first modulated signals having the client data encoded therein and having the predetermined frequency of the second carrier signals (i.e., the BB frequency), and send the first modulated signals to the fifth amplifier 684e.

The fifth amplifier 684e may be configured to receive the first modulated signals from the third frequency mixer 680c, adjust an amplitude of the first modulated signals such that the amplified first modulated signals can drive the first frequency mixer 680a, and send the amplified first modulated signals to the first frequency mixer 680a.

The third amplifier 684c may be configured to receive the first carrier signals from the signal distribution block 698, adjust an amplitude of the first carrier signals to generate amplified carrier signals that can drive the first frequency mixer 680a, and send the amplified carrier signals to the first frequency mixer 680a.

The first frequency mixer 680a may be configured to receive the amplified carrier signals from the third amplifier 684c, receive the amplified first modulated signals from the fifth amplifier 684e, up-convert the amplified first modulated signals with the amplified carrier signals to produce second modulated signals having the data encoded therein and having the predetermined frequency of the amplified carrier signals (i.e., within the THz frequency band 104 or, in some embodiments, in a range between 300 GHz and 10 THz), and send the second modulated signals to the first amplifier 684a.

The first amplifier 684a may be configured to receive the second modulated signals from the first frequency mixer 680a, adjust an amplitude of the second modulated signals such that the amplified second modulated signals can be transmitted by the first RF interface 664a, and send the amplified second modulated signals to the first RF interface 664a.

The first RF interface 664a may be configured to receive the amplified second modulated signals from the first amplifier 684a and send the amplified second modulated signals as antenna feed signals 612a (i.e., having the data encoded therein) having a frequency within a predetermined frequency range (e.g., the THz frequency band 104 or, in some embodiments, in a range between 300 GHz and 10 THz). In some embodiments, the first RF interface 664a may be connected to one of the antennas 616 and configured to send the antenna feed signals 612a to the antenna 616. In other embodiments, however, one of the antennas 616 may be included in place of the first RF interface 664a.

Referring now to the receiver circuitry 608b, the second RF interface 664b may be configured to receive the antenna output signals 612b (i.e., having client data encoded therein) within a predetermined frequency range (e.g., the THz frequency band 104 or, in some embodiments, in a range between 300 GHz and 10 THz) and send the antenna output signals 612b to the second amplifier 684b. As described in further detail below, the second RF interface 664b may be configured to receive the antenna output signals 612b from one of the antennas 616. In other embodiments, however, one of the antennas 616 may be included in place of the second RF interface 664b.

The second amplifier 684b may be configured to receive the antenna output signals 612b from the second RF interface 664b, adjust an amplitude of the antenna output signals 612b to generate amplified second transmission signals that can drive the second frequency mixer 680b, and send the amplified second transmission signals to the second frequency mixer 680b.

The fourth amplifier 684d may be configured to receive the first carrier signals from the signal distribution block 698, adjust an amplitude of the first carrier signals to generate amplified carrier signals that can drive the second frequency mixer 680b, and send the amplified carrier signals to the second frequency mixer 680b.

The second frequency mixer 680b may be configured to receive the amplified second transmission signals from the second amplifier 684b, receive the amplified carrier signals from the fourth amplifier 684d, down-convert the amplified second transmission signals with the amplified carrier signals to produce third modulated signals having the data encoded therein and having the IF or the BB frequency, and send the third modulated signals to the sixth amplifier 684f.

The sixth amplifier 684f may be configured to receive the third modulated signals from the second frequency mixer 680b, adjust an amplitude of the third modulated signals such that the amplified third modulated signals can drive the fourth frequency mixer 680d, and send the amplified third modulated signals to the fourth frequency mixer 680d.

The third LO 636c may be configured to generate reference signals having a continuous waveform (e.g., a sinusoidal waveform) having a predetermined frequency (i.e., a BB frequency). In some embodiments, the predetermined frequency of the reference signals (i.e., the BB frequency) is in a range between 8 GHZ and 10 GHz. The third LO 636c may be further configured to send the reference signals to the fourth frequency mixer 680d.

The fourth frequency mixer 680d may be configured to receive the amplified third modulated signals from the sixth amplifier 684f, receive the reference signals from the third LO 636c, down-convert the amplified third modulated signals with the reference signals to produce encoded output signals having the client data encoded therein and having the predetermined frequency of the reference signals (i.e., the BB frequency), and send the encoded output signals to the modulation block 644a.

The client-side output 600b may be configured to transmit the second baseband signals 604b having the client data encoded therein to one or more external component (e.g., a control module 224). In some embodiments, the client-side output 600b is a pair of output interfaces. In some such embodiments, the client-side output 600b is an LVDS link configured to transmit LVDS signals, and the second baseband signals 604b are LVDS signals having the client data encoded therein.

Referring now to FIG. 7, shown therein is a schematic diagram of an exemplary embodiment of a folded cascode modulator 700 constructed in accordance with the present disclosure. The folded cascode modulator 700 may be configured to perform broadband direct modulation to generate the encoded signals and to minimize distortion while doing so. The folded cascode modulator 700 may employ a cascade architecture (e.g., a cascaded circuit drive that is “stacked” or “folded”) in order to produce a linear or near-linear modulated output (i.e., the encoded signals).

Referring now to FIG. 8, shown therein is a schematic diagram of an exemplary embodiment of a rectifying detector 800 constructed in accordance with the present disclosure. The rectifying detector 800 may be configured to perform direct detection of incoming signals (i.e., the encoded signals). The rectifying detector 800 may be further configured to detect an envelope of the encoded signals or one or more amplitude transition of the encoded signals to generate the output signals.

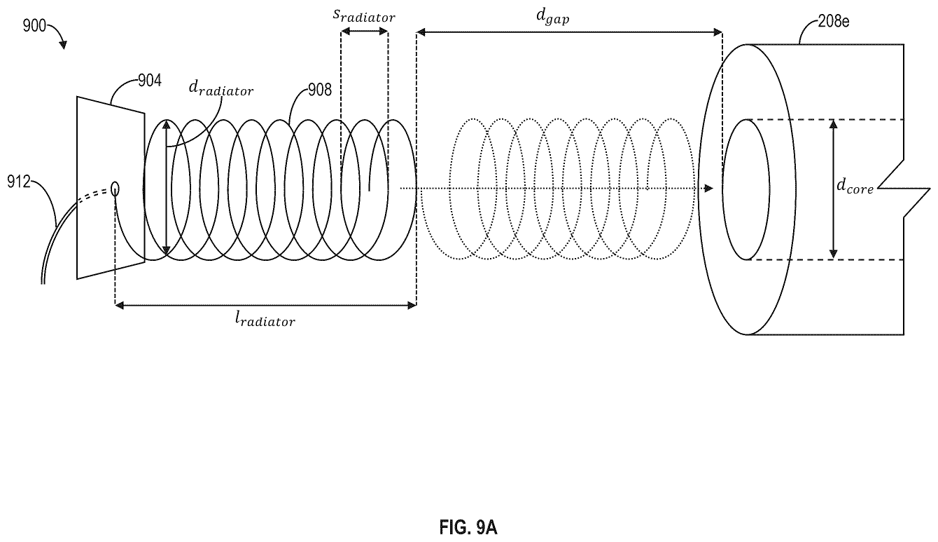

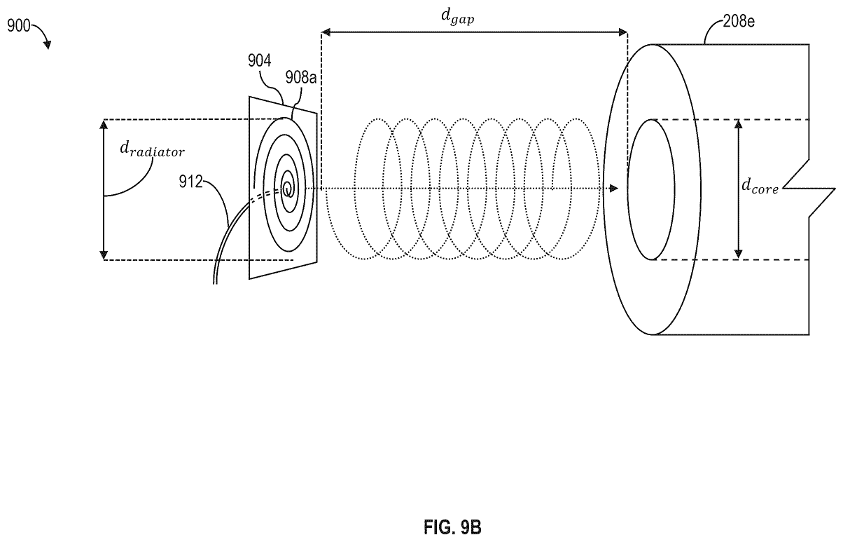

Referring now to FIG. 9A, shown therein is a side view of an exemplary embodiment of an antenna 900 coupled with a fifth hollow waveguide 208e constructed in accordance with the present disclosure. However, it should be understood that the description referring to any particular one of the antennas 416, 516, 616, 900 may refer to any of the antennas 416, 516, 616, 900 described herein. As shown in FIG. 8A, the antenna 900 generally comprises a ground plane 904, a radiator 908 mounted on the ground plane 904, and a coaxial feedline 912 electrically connected to the radiator 908. In some embodiments, the antenna 900 may lack the ground plane 904. In some embodiments, the antenna 900 further comprises a casing (not shown) enclosing the radiator 908. The antenna 900 may be a vertical antenna (i.e., an antenna extending orthogonally from a substrate) or a horizontal antenna (i.e., an antenna extending laterally from a substrate).

The radiator 908 may be configured to transmit and detect radiated signals configured for coherent detection. In the embodiment shown, the radiator 908 is a helical radiator configured to transmit and detect radiated signals having a circular polarization. In this embodiment, the radiator 908 has a length l_{radiator}, a diameter d_{radiator}, and a spacing s_{radiator} between adjacent turns of the radiator 908. The radiator 908 is preferably disposed at a distance d_{gap} from the fifth hollow waveguide 208e.

The radiator 908 may be wound in a predetermined direction, such as clockwise (i.e., a left-hand wind) or counter-clockwise (i.e., a right-hand wind). While the radiator 908 of the antenna 900 is depicted in FIG. 9A as having a right-hand wind or a counter-clockwise rotational direction, it should be understood that the radiator 908 of the antenna 900 may be provided with a left-hand wind or a clockwise rotational direction.

In some embodiments, signals for transmission may be sent to the antenna 900 via the coaxial feedline 912. In other embodiments, received RF signals may be sent from the antenna 900 via the coaxial feedline 912.

In some embodiments, the length l_{radiator} of the radiator 908 may be proportional to the wavelength of the signals being transmitted and/or received. In some embodiments, the length l_{radiator} of the radiator 908 is in a range between 10 microns and 10 mm. In some embodiments, the diameter d_{radiator} of the radiator 908 may be proportional to the wavelength of the signals being transmitted and/or received. In some embodiments, the diameter d_{radiator} of the radiator 908 is in a range between 10 microns and 10 mm. In some embodiments, the spacing s_{radiator} between adjacent turns of the radiator 908 may be in a range between 1 micron and 1 mm.

The predetermined distance d_{gap} at which the antenna 900 is spaced from the hollow waveguide 208 may vary depending upon the carrier frequency of the RF signal being transmitted by the antenna 900. In some embodiments, the predetermined distance d_{gap} at which the antenna 900 is spaced from the hollow waveguide 208 is in a range between 3 μm and 3 mm. In one embodiment, the predetermined distance d_{gap} at which the antenna 900 is spaced from the hollow waveguide 208 is 1 mm. In some embodiments, the antenna 900 may be directly connected to the fifth hollow waveguide 208e.

Referring now to FIG. 9B, shown therein is a top plan view of another exemplary embodiment of the antenna 900 coupled with the fifth hollow waveguide 208e constructed in accordance with the present disclosure. The antenna 900 is similar in construction and function as the antenna 900, with the exception that the antenna 900 includes a first radiator 908a formed of a conductive material having a plurality of coplanar windings. In one embodiment, the first radiator 908a is in the form of a spiral. The first radiator 908a may be wound in a predetermined direction, such as clockwise (i.e., a left-hand wind) or counter-clockwise (i.e., a right-hand wind). While the first radiator 908a of the antenna 900 is depicted in FIG. 9B as having a right-hand wind or a counter-clockwise rotational direction, it should be understood that the first radiator 908a of the antenna 900 may be provided with a left-hand wind or a clockwise rotational direction.

Other embodiments of the antenna 900 include embodiment as a gain horn antenna, a Cassegrain antenna, an omnidirectional antenna, a horn lens antenna, a spot focus antenna, a waveguide probe antenna, a scalar feed horn antenna, a wide-angle scalar feed horn antenna, a trihedral antenna, and a conical horn antenna.

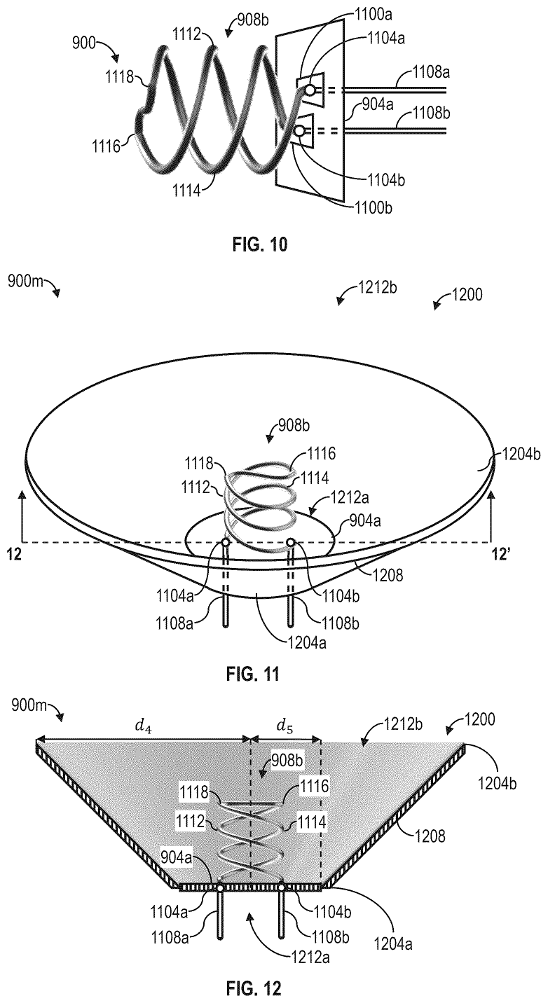

Referring now to FIG. 10, shown therein is another exemplary embodiment of the antenna 900. As shown in FIG. 10, the antenna 900 may be implemented as a bifilar helix antenna. The bifilar helix antenna 900 generally comprises a ground plane 904a having a first differential pad 1100a and a second differential pad 1100b and a second radiator 908b mounted on the ground plane 904a. In some embodiments, the bifilar helix antenna 900 may lack the ground plane 904a. The second radiator 908b is generally in the shape of a double helix and may have a first feed point 1104a electrically connected to the first differential pad 1100a and a second feed point 1104b electrically connected to the second differential pad 1100b. A first coaxial feedline 1108a and a second coaxial feedline 1108b may be electrically connected to the first differential pad 1100a and the second differential pad 1100b, respectively.

In some embodiments, the second radiator 908b may be configured to transmit and detect differential radiated signals. That is, in the transmit direction, the second radiator 908b may receive a first complementary antenna feed signal from the first feed point 1104a and a second complementary antenna feed signal from the second feed point 1104b and transmit the radiated signals based on the first complementary antenna feed signal and the second complementary antenna feed signal. Further, in the receive direction, the second radiator 908b may receive the radiated signals and provide the first complementary antenna output signal to the first feed point 1104a and the second complementary antenna output signal to the second feed point 1104b. In such embodiments, the first complementary antenna output signal and the second complementary antenna output signal may be equal in magnitude but opposite in phase (i.e., out of phase by) 180°.

The second radiator 908b may be wound in a predetermined direction, such as clockwise or counter-clockwise. While the second radiator 908b of the bifilar helix antenna 900 is depicted in FIG. 9 as having a left-hand wind or a clockwise rotational direction, it should be understood that the second radiator 908b of the bifilar helix antenna 900 may be provided with a right-hand wind or a counter-clockwise rotational direction.

The second radiator 908b may comprise a first radiator portion 1112 and a second radiator portion 1114. The first radiator portion 1112 has a first end formed by the first feed point 1104a and a second end 1116 spaced a distance from the first feed point 1104a. The first radiator portion 1112 is in the form of a spiral (i.e., a helix shape). The second radiator portion 1114 has a third end formed by the second feed point 1104b and a fourth end 1118 spaced a distance from the second feed point 1104b. The second radiator portion 1114 is in the form of a spiral (i.e., a helix shape). The second end 1116 of the first radiator portion 1112 is connected to the fourth end 1118 of the second radiator portion 1114.

Referring now to FIGS. 11 and 12, shown therein is another exemplary embodiment of the bifilar helix antenna 900 shown in FIG. 10. As shown in FIGS. 11 and 12, in some embodiments, a conductive cone 1200 may be provided surrounding the bifilar helix antenna 900 (i.e., such that the bifilar helix antenna 900 is enclosed within the conductive cone 1200). The second radiator 908b may be wound in a predetermined direction, such as clockwise or counter-clockwise. While the second radiator 908b of the bifilar helix antenna 900 enclosed within the conductive cone 1200 is depicted in FIGS. 11 and 12 as having a left-hand wind or a clockwise rotational direction, it should be understood that the second radiator 908b of the bifilar helix antenna 900 enclosed within the conductive cone 1200 may be provided with a right-hand wind or a counter-clockwise rotational direction.

The conductive cone 1200 may have a first end 1204a, a second end 1204b opposite the first end 1204a, and a sidewall 1208 extending between the first end 1204a and the second end 1204b. The sidewall 1208 may define a first opening 1212a at the first end 1204a and a second opening 1212b at the second end 1204b. As shown in FIGS. 11 and 12, the first end 1204a of the conductive cone 1200 is generally provided with a diameter d₄ shorter than a diameter d₅ of the second end 1204b of the conductive cone 1200.

The bifilar helix antenna 900 enclosed within the conductive cone 1200 may be configured to transmit circularly polarized signals with a relatively high gain (e.g., more than 6 decibels relative to isotropic (dBi), such as 10 dBi, 12 dBi, 14 dBi, 15 dBi, 16 dBi, 18 dBi, or 20 dBi, for example). In the embodiment shown in FIGS. 11 and 12, the bifilar helix antenna 900 enclosed within the conductive cone 1200 may function as an efficient, wide-bandwidth polarizer. That is, the bifilar helix antenna 900 enclosed within the conductive cone 1200 may be configured to transmit circularly polarized RF signals with a high radiation efficiency (e.g., greater than 50%, such as 60%, 70%, 75%, 80%, 85%, 90%, or 95%, for example). Losses in radiation efficiency are generally due to losses in conductors or substrates. Further, the bifilar helix antenna 900 enclosed within the conductive cone 1200 may be configured to transmit circularly polarized signals with a wide bandwidth (e.g., greater than 10% of center frequency, such as 12%, 14%, 15%, 16%, 18%, 20%, 22%, 24%, or 25%, for example).

The diameter of the bifilar helix antenna 900 may be less than the wavelength of the signals transmitted by the bifilar helix antenna 900. In some embodiments, the conductive cone 1200 may be constructed of a conductive material, such as aluminum, copper, silver, gold, other conductive metals, combinations thereof, and/or the like.

It will be understood by persons having ordinary skill in the art that circularly polarized signals transmitted by a radiator 908 of a first particular one of the antennas 900 may be received only by a radiator 908 of a second particular one of the antennas 900 having the same rotational direction. That is, for example, the radiator 908 shown in FIG. 8A and the first radiator 908a shown in FIG. 8B are depicted as having a right-hand wind or a counter-clockwise rotational direction. As a result, circularly polarized RF signals transmitted by the radiator 908 shown in FIG. 9A or the first radiator 908a shown in FIG. 9B would have a right-hand circular polarization (RHCP). On the other hand, the second radiator 908b shown in FIGS. 10-12 is depicted as having a left-hand wind or a clockwise rotational direction. As a result, circularly polarized RF signals transmitted by the second radiator 908b shown in FIGS. 10-12 would have a left-hand circular polarization (LHCP).

Because circularly polarized signals transmitted by a radiator 908 of a first particular one of the antennas 900 may be received only by a radiator 908 of a second particular one of the antennas 900 having the same rotational direction, circularly polarized RF signals transmitted by the radiator 908 as depicted in FIG. 9A or the first radiator 908a as depicted in FIG. 9B (i.e., RHCP RF signals) could not be received by the second radiator 908b as depicted in FIGS. 10-12. Similarly, circularly polarized signals transmitted by the second radiator 908b as depicted in FIGS. 10-12 (i.e., LHCP RF signals) could not be received by the radiator 908 as depicted in FIG. 9A or the first radiator 908a as depicted in FIG. 9B. However, circularly polarized signals transmitted by the radiator 908 as depicted in FIG. 8A (i.e., RHCP RF signals) could be received by the first radiator 908a as depicted in FIG. 9B, and circularly polarized signals transmitted by the second radiator 908b as depicted in FIG. 10 (i.e., LHCP RF signals) could be received by the second radiator 908b as depicted in FIGS. 11 and 12.

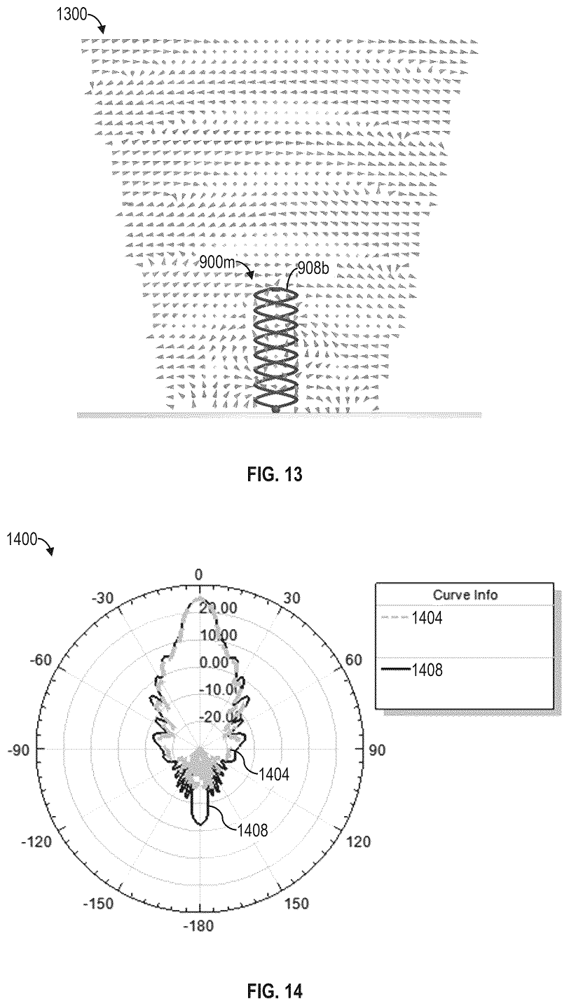

Referring now to FIG. 13, shown therein is a diagrammatic view of an electric field 1300 produced by the bifilar helix antenna 900 enclosed within the conductive cone 1200 shown in FIGS. 11 and 12. As illustrated in FIG. 13, the bifilar helix antenna 900 enclosed within the conductive cone 1200 may be operable to produce the electric field 1300 such that a near-field region of the electric field 1300 and a far-field region of the electric field 1300 are established with a greater directivity than would be provided by conventional antennas. Further, the bifilar helix antenna 900 enclosed within the conductive cone 1200 may be operable to produce the electric field 1300 in a manner that does not interfere with the circular polarization of the circularly polarized radiated signals transmitted by the second radiator 908b.

Referring now to FIG. 14, shown therein is a diagrammatic view of a radiation pattern 1400 of the bifilar helix antenna 900 enclosed within the conductive cone 1200 shown in FIGS. 11 and 12. The radiation pattern 1400 may correspond to a transmission signal having a frequency of 2,000 GHz and a phase of 0°. As shown in FIG. 14, a first curve 1404 demonstrates an LHCP gain of the bifilar helix antenna 900 enclosed within the conductive cone 1200, while a second curve 1408 demonstrates a total directivity of the bifilar helix antenna 900 enclosed within the conductive cone 1200. A difference between the first curve 1404 and the second curve 1408 may indicate metal and polarization losses. As illustrated in FIG. 14 and as described above in relation to FIG. 13, the bifilar helix antenna 900 enclosed within the conductive cone 1200 may be operable to produce the electric field 1300 such that a near-field region 1304 of the electric field 1300 and a far-field region 1308 of the electric field 1300 are established with a greater directivity than would be provided by conventional antennas.

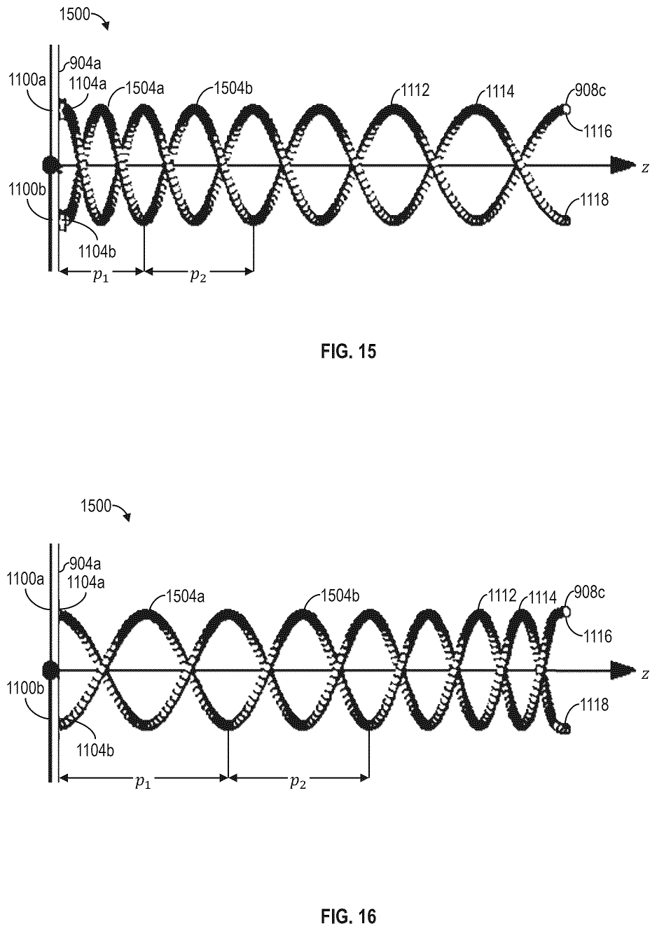

Referring now to FIGS. 15 and 16, shown therein are side views of exemplary embodiments of a non-uniform bifilar helix antenna 1500 (hereinafter, the “non-uniform antenna 1500”) constructed in accordance with the present disclosure. Providing the antenna with a non-uniform design is effective because the size of the helix determines the frequency of operation. By varying characteristic dimensions of the helix, a wider band of frequencies may be effectively radiated.

Similar to the bifilar helix antenna 900 described above, the non-uniform antenna 1500 may comprise the ground plane 904a having the first differential pad 1100a and the second differential pad 1100b and a non-uniform third radiator 908c mounted on the ground plane 904a. The third radiator 908c may have a plurality of turns 1504a-n including at least a first turn 1504a and a second turn 1504b. For purposes of clarity, only the first turn 1504a and the second turn 1504b are labeled with a reference character. The first turn 1504a may have a first characteristic dimension, while the second turn 1504b may have a second characteristic dimension different from the first characteristic dimension. The first turn 1504a may be adjacent to the second turn 1504b or non-adjacent to (i.e., spaced from) the second turn 1504b.

In the embodiment shown in FIG. 15, the first turn 1504a has a first pitch p₁, the second turn 1504b has a second pitch p₂, and the first pitch p₁ is less than the second pitch p₂. the embodiment shown in FIG. 15, the first turn 1504a has the first pitch p₁, the second turn 1504b has the second pitch p₂, and the first pitch p₁ is greater than the second pitch p₂.

In some embodiments, the non-uniform antenna 1500 may lack the ground plane 904a. The third radiator 908c is generally in the shape of a double helix and may have the first feed point 1104a electrically connected to the first differential pad 1100a and the second feed point 1104b electrically connected to the second differential pad 1100b. The first coaxial feedline 1108a and the second coaxial feedline 1108b may be electrically connected to the first differential pad 1100a and the second differential pad 1100b, respectively.

In some embodiments, the third radiator 908c may be configured to emit and receive differential signals. That is, in the transmit direction, the third radiator 908c may receive a first complementary signal from the first feed point 1104a and a second complementary signal from the second feed point 1104b and transmit the transmission signal. Further, in the receive direction, the third radiator 908c may receive the transmission signal and provide the first complementary signal to the first feed point 1104a and the second complementary signal to the second feed point 1104b. In such embodiments, the first complementary signal and the second complementary signal may be equal in magnitude but opposite in phase (i.e., out of phase by) 180°.

The third radiator 908c may be wound in a predetermined direction, such as clockwise or counter-clockwise. While the third radiator 908c of the non-uniform antenna 1500 is depicted in FIGS. 15 and 16 as having a right-hand wind or a counter-clockwise rotational direction, it should be understood that the third radiator 908c of the non-uniform antenna 1500 may be provided with a left-hand wind or a clockwise rotational direction.

The third radiator 908c may comprise the first radiator portion 1112 and the second radiator portion 1114. The first radiator portion 1112 has the first end formed by the first feed point 1104a and the second end 1116 spaced a distance from the first feed point 1104a. The first radiator portion 1112 is in the form of a spiral (i.e., a helix shape). The second radiator portion 1114 has the third end formed by the second feed point 1104b and the fourth end 1118 spaced a distance from the second feed point 1104b. The second radiator portion 1114 is in the form of a spiral (i.e., a helix shape). While the second end 1116 and the fourth end 1118 are shown as being disconnected from each other, it should be understood that, in some embodiments, the second end 1116 of the first radiator portion 1112 is connected to the fourth end 1118 of the second radiator portion 1114.

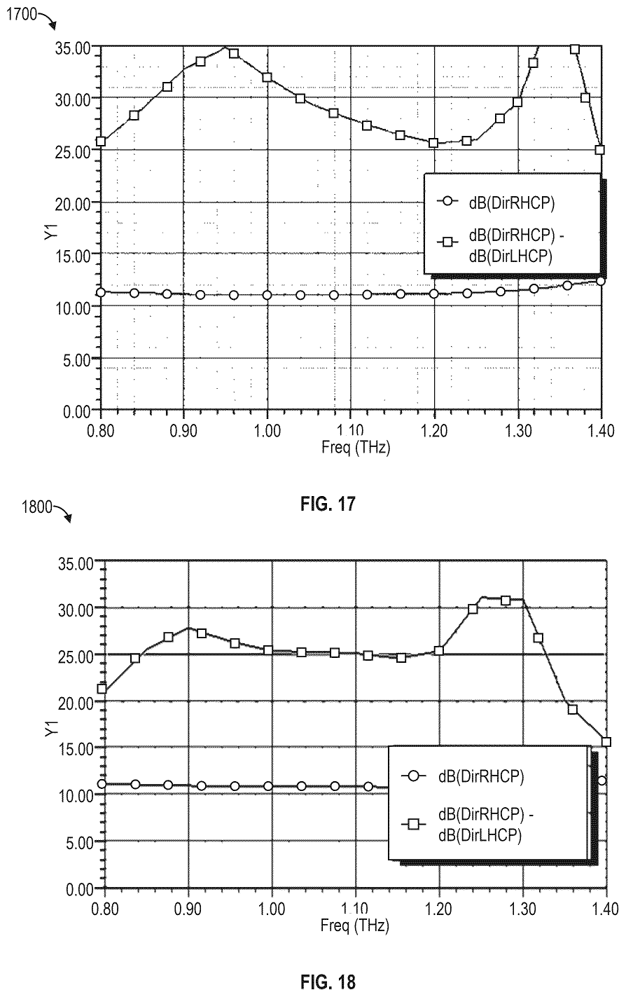

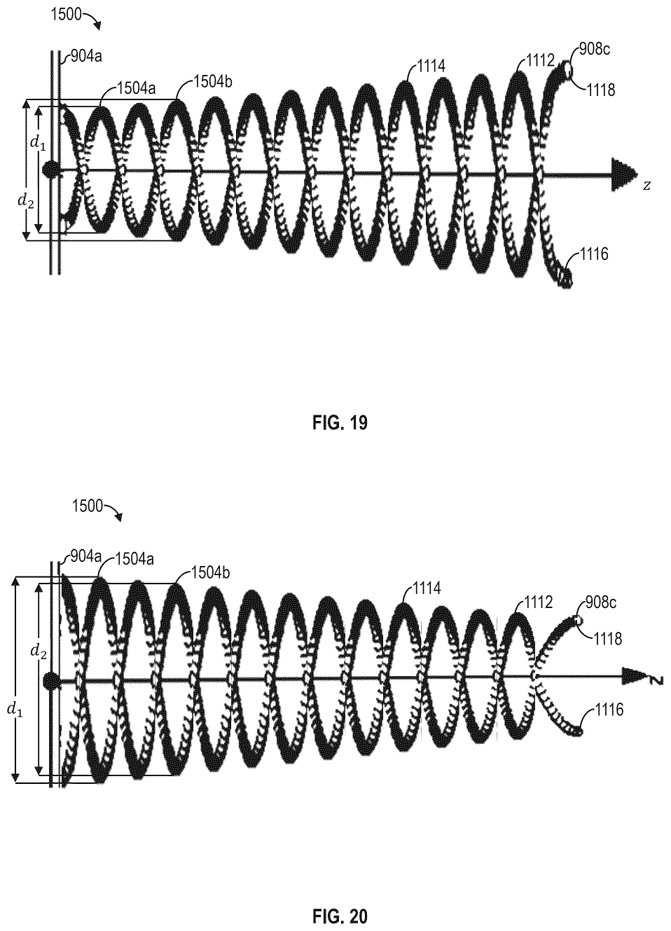

The non-uniform antenna 1500 provides a wider frequency response in comparison to uniform antennas existing in the prior art and the uniform bifilar helix antennas discussed herein. A mathematical equation for the helical shape of the non-uniform radiator 908c of the non-uniform antenna 1500 in three-dimensional space is shown in Table 1 below and in a graph 1700 shown in FIG. 17, while the polarization discrimination of a uniform antenna across the frequency range between 0.80 THz and 1.40 THz is shown in a graph 1800 shown in FIG. 18. As shown in FIGS. 17 and 18, the polarization discrimination may be determined by subtracting the left-hand circular polarization directivity (i.e., DirLHCP) from the right-hand circular polarization directivity (i.e., DirRHCP). As shown in Table 1 and FIG. 16, the right-hand circular polarization directivity (i.e., DirRHCP) of the non-uniform antenna 1500 may be relatively constant (i.e., 11.5 dBi±1 dBi) in the frequency range between 0.80 THz and 1.40 THz. Furthermore, as shown in FIG. 17, the polarization discrimination (i.e., DirRHCP-DirLHCP) of the non-uniform antenna 1500 remains above 25 dB across the frequency range between 0.80 THz and 1.40 THz. Conversely, as shown in FIG. 18, the polarization discrimination (i.e., DirRHCP-DirLHCP) of a uniform antenna dips below 25 dB at the band edges and slightly below 25 dB in the midband range.

TABLE 1
Mathematical Equation for a Helical Shape of
the Non-Uniform Radiator 908c of the Non-Uniform
Antenna 1500 in Three-Dimensional Space

| X(t) | 41 * cos(t) [μm] |
|---|---|
| Y(t) | 41 * sin(t) [μm] |
| Z(t) | 0.293 * t * (t + 25)[μm] |
| start(t) | 0 |
| end(t) | 25.13 |

Referring now to FIGS. 18 and 20, shown therein are side views of more exemplary embodiments of the non-uniform antenna 1500 shown in FIGS. 15 and 16. For purposes of clarity, the differential pads 1100 and the feed points 1104 are not labeled with a reference character in FIGS. 18 and 19. In the embodiments shown in FIGS. 19 and 20, the first characteristic dimension and the second characteristic dimension are not pitches, but diameters. In the embodiment shown in FIG. 19, the first turn 1504a has a first diameter d₁, the second turn 1504b has a second diameter d₂, and the first diameter d₁ is less than the second diameter d₂. In the embodiment shown in FIG. 20, the first turn 1504a has the first diameter d₁, the second turn 1504b has the second diameter d₂, and the first diameter d is greater than the second diameter d₂.

Varying the diameters d₁₋ₙ of the turns 1504 of the third radiator 908c rather than the pitches p₁₋ₙ of the turns 1504 of the third radiator 908c may be advantageous in different bands or with different ground plane dimensions, wire dimensions, etc.

It should be understood that the third radiator 908c and/or the non-uniform antenna 1500 may be included in place of any of the respective radiators 908 and/or antennas 900 described herein. Further, it should be understood that, while the second turn 1504b is shown as being directly adjacent to the first turn 1504a, there may be one or more turns in between the first turn 1504a and the second turn 1504b. Finally, it should be understood that, while the first turn 1504a is shown as being directly adjacent to the ground plane 904a, there may be one or more turns in between the ground plane 904a and the first turn 1504a.

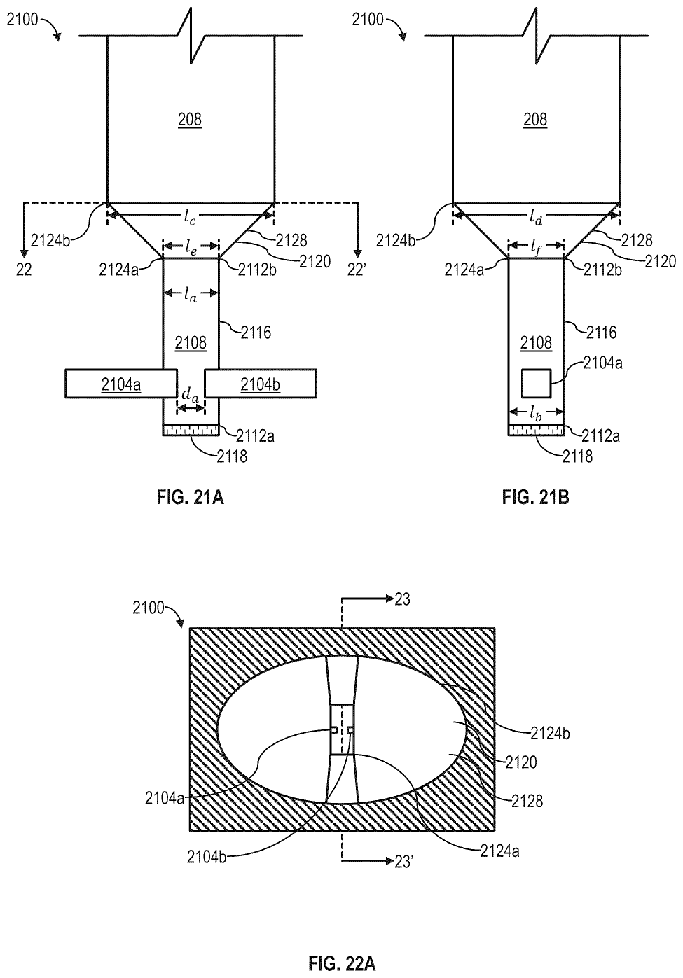

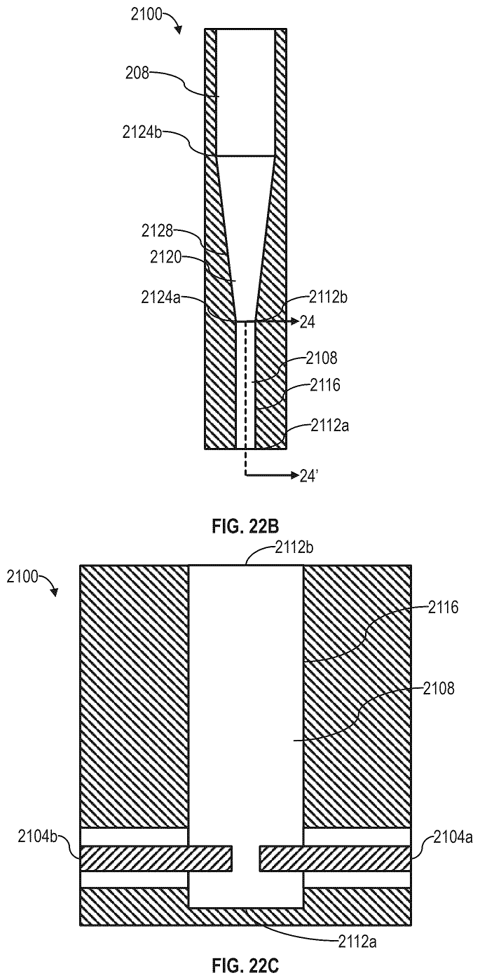

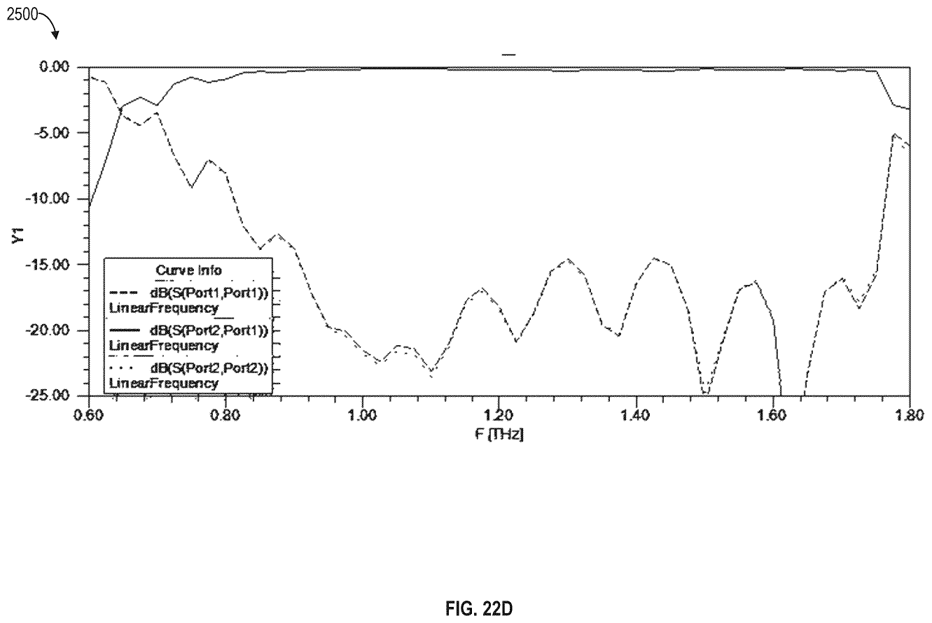

Referring now to FIGS. 21A, 21B, and 22A-22C, shown therein is a differential waveguide probe antenna 2100 constructed in accordance with the present disclosure. The differential waveguide probe antenna 2100 is configured to generate and transmit the transmission signal. Conversely, the differential waveguide probe antenna 2100 is further configured to receive the transmission signal. The differential waveguide probe antenna 2100 comprises a pair of waveguide probes 2104 including a first waveguide probe 2104a and a second waveguide probe 2104b.

In some embodiments, the differential waveguide probe antenna 2100 may further comprise an intermediary waveguide 2108 configured to propagate the transmission signal. In such embodiments, the differential waveguide probe antenna 2100 may be further configured to generate and transmit the transmission signal into the intermediary waveguide 2108. Conversely, in such embodiments, the differential waveguide probe antenna 2100 may be further configured to receive the transmission signal from the intermediary waveguide 2108.

The intermediary waveguide 2108 may have a first end 2112a, a second end 2112b (the first end 2112a and the second end 2112b, collectively, the “ends 2112”) opposite the first end 2112a, and a surface 2116 extending between the ends 2112. In some embodiments, a back reflector 2118 may abut the first end 2112a. The surface 2116 may be constructed of a metal. The intermediary waveguide 2108 may be constructed as such in order to ensure that one or more intended waveguide modes are established. That is, were the intermediary waveguide 2108 to be constructed at a smaller size, the one or more intended waveguide modes may not be able to propagate, and were the intermediary waveguide 2108 to be constructed at a larger size, one or more unintended waveguide modes may be excited. In some embodiments, the one or more intended waveguide modes of the intermediary waveguide 2108 sufficiently matches the one or more intended waveguide modes of the hollow waveguide 208 such that a coupling loss between the intermediary waveguide 2108 and the hollow waveguide 208 is minimized (e.g., the coupling loss is in a range between 0.1 dB and 5.0 dB).

As shown in FIG. 21A, in a first direction, the intermediary waveguide 2108 may have a first cross-sectional length lₐ greater than zero and less than two wavelengths of the transmission signal at 10 THz (or a maximum frequency in the frequency band occupied by the transport network 200) (i.e., 60 μm). Further, as shown in FIG. 21B, in a second direction perpendicular to the first direction, the intermediary waveguide 2108 may have a second cross-sectional length l_{y} less than two wavelengths of the transmission signal at 10 THz (or a maximum frequency in the frequency band occupied by the transport network 200) (i.e., 60 μm) and greater than one-half wavelength at 300 GHz (or a minimum frequency in the frequency band occupied by the transport network 200) (i.e., 0.5 mm).

The waveguide probes 2104 may be positioned on opposite sides of the surface 2116 of the intermediary waveguide 2108 and may extend into the intermediary waveguide 2108 toward each other, but may be spaced a first distance da from each other. The waveguide probes 2104 may thus establish a strong electrical field in line with the one or more intended waveguide modes. Each of the waveguide probes 2104 may be excited with the transmission signal. In some embodiments, each of the waveguide probes 2104 may be excited with the transmission signal at an equal strength and/or an opposite phase. That is, the waveguide probes 2104 may be configured to receive the transmission signal as a differential signal having a first complementary signal and a second complementary signal and generate and transmit the transmission signal in the electromagnetic wave form. Conversely, the waveguide probes 2104 may be further configured to receive the transmission signal and provide the transmission signal as a differential signal having a first complementary signal and a second complementary signal.

In some embodiments, the intermediary waveguide 2108 may have a flared end at the second end 2112b configured to facilitate a mode transition between the intermediary waveguide 2108 and the hollow waveguide 208. In such embodiments, as shown in FIG. 21A, in the first direction, the intermediary waveguide 2108 at the flared end may have a third cross-sectional length l_{c} greater than the first cross-sectional length lₐ. Further, as shown in FIG. 21B, in the second direction perpendicular to the first direction, the intermediary waveguide 2108 at the flared end may have a fourth cross-sectional length lₐ greater than the second cross-sectional length l_{b}. In some such embodiments, the flared end may be formed integrally with the intermediary waveguide 2108. However, in other such embodiments, the flared end may be constructed as a horn 2120 separate from but coupled to the intermediary waveguide 2108. The horn 2120 may have a first end 2124a abutting the second end 2112b of the intermediary waveguide 2108, a second end 2124b (the first end 2124a and the second end 2124b, collectively, the “ends 2124”) opposite the first end 2124a, and a curved surface 2128 extending between the ends 2124.

As shown in FIG. 21A, in the first direction, the horn 2120 at the first end 2124a may have a fifth cross-sectional length lₑ equal to the first cross-sectional length lₐ. Further, as shown in FIG. 21B, in the second direction perpendicular to the first direction, the horn 2120 at the first end 2124a may have a sixth cross-sectional length l_{f} equal to the second cross-sectional length l_{b}.

The differential waveguide probe antenna 2100 may be configured to transmit the transmission signal with a wide (i.e., greater than 50%) bandwidth into the hollow waveguide 208 at least in part because an energy contribution from each of the waveguide probes 2104 effectively cancels out the higher-order, unintended waveguide modes of the other waveguide probe 2104. A polarization discrimination of the differential waveguide probe antenna 2100 across a frequency range between 0.60 THz and 1.80 THz is shown in a graph 2500 shown in FIG. 22D.

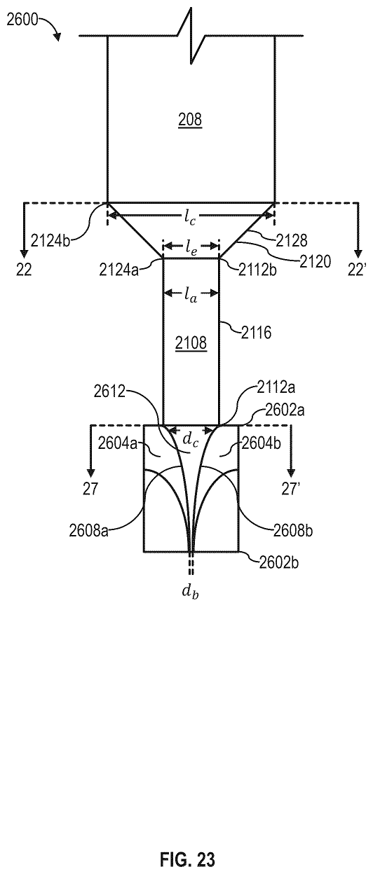

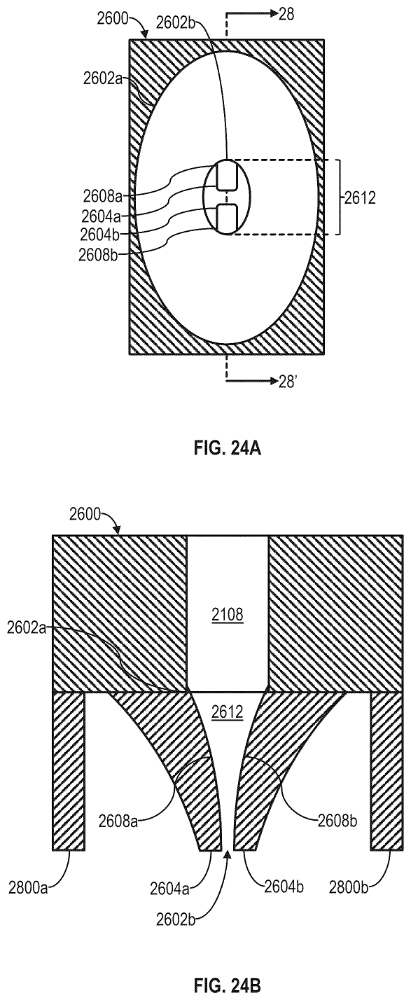

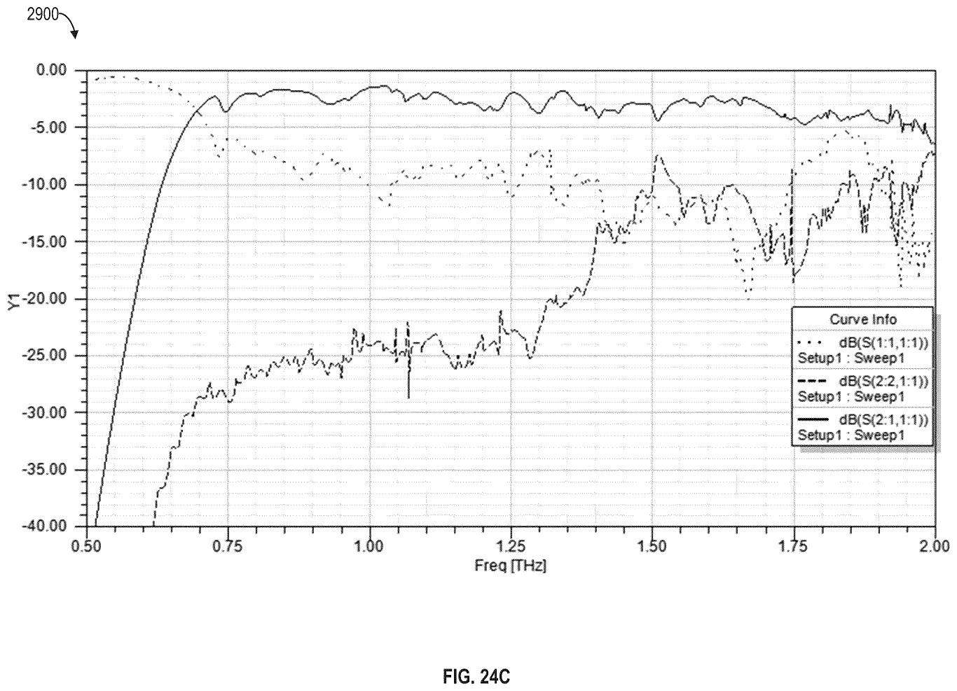

Referring now to FIGS. 23, 24A, and 24B, shown therein is an exemplary embodiment of a differential tapered antenna 2600 constructed in accordance with the present disclosure. The differential tapered antenna 2600 is configured to generate and transmit the transmission signal in the electromagnetic wave form—and, conversely, receive the transmission signal in the electromagnetic wave form. The differential tapered antenna 2600 may have a first end 2602a and a second end 2602b (the first end 2602a and the second end 2602b, collectively, the “ends 2602”) opposite the first end 2602a and may comprise a pair of conductors including a first conductor 2604a and a second conductor 2604b (collectively, the “conductors 2604”) spaced a second distance d_{b} from the first conductor 2604a at the second end 2602b and a third distance d_{c} at the first end 2602a.

The differential tapered antenna 2600 may be similar in some respects to a tapered slot antenna and in some respects to a ridged horn antenna. However, the differential tapered antenna 2600 differs from such antennas due to the differential tapered antenna 2600 having a differential launch and being coupled into the intermediary waveguide 2018 which is sized and dimensioned such that the intermediary waveguide 2018 may propagate multiple waveguide modes simultaneously. However, it should be understood that, in some embodiments, the differential tapered antenna 2600 may be configured to excite only a single waveguide mode at a given time.

The differential tapered antenna 2600 may be configured to generate and transmit the transmission signal into the intermediary waveguide 2108 and receive the transmission signal from the intermediary waveguide 2108. In some embodiments, the differential tapered antenna 2600 may be configured to couple the transmission signal directly into—and receive the transmission signal directly from—the hollow waveguide 208, rather than the intermediary waveguide 2108.

In the embodiment shown in FIGS. 23, 24A, and 24B, the differential tapered antenna 2600 has a first planar, yet longitudinally directed curved surface 2608a and a second planar, yet longitudinally directed curved surface 2608b (collectively, the “curved surfaces 2608”) bordering a space 2612. In some embodiments, the second distance d_{b} between the first conductor 2604a and the second conductor 2604b at the second end 2602b is greater than zero and less than two wavelengths of the transmission signal at 10 THz (or the maximum frequency in the frequency band occupied by the transport network 200). The second distance d_{b} may be selected to establish a single waveguide mode for the frequency of the transmission signal. In some embodiments, a third distance d_{c} between the conductors 2604 at the first end 2602a is greater than the second distance d_{b}. This tapered shape may establish a continuously scaled geometry which enables an ultra-wide (i.e., greater than 50%) bandwidth. As energy launches down the conductors 2604, the one or more intended waveguide modes are established between the conductors 2604 and subsequently launched into the intermediary waveguide 2108.

In some embodiments, each of the conductors 2604 may be fed with the transmission signal at an equal strength and/or an opposite phase. That is, the conductors 2604 may be configured to receive the transmission signal as a differential signal having a first complementary signal and a second complementary signal and generate and transmit the transmission signal in the electromagnetic wave form. Conversely, the conductors 2604 may be further configured to receive the transmission signal and provide the transmission signal as a differential signal having a first complementary signal and a second complementary signal.

A thickness and a width of the transmission lines at the feed point may be selected to establish a characteristic impedance matched to the receiver and/or driver. Persons having ordinary skill in the art will understand how to perform such calculations. As shown in FIG. 24B, the differential tapered antenna 2600 may further comprise one or more ground connections, such as a first ground connection 2800a and a second ground connection 2800b. A polarization discrimination of the differential tapered antenna 2600 across a frequency range between 0.50 THz and 2.00 THz is shown in a graph 2900 shown in FIG. 24C.

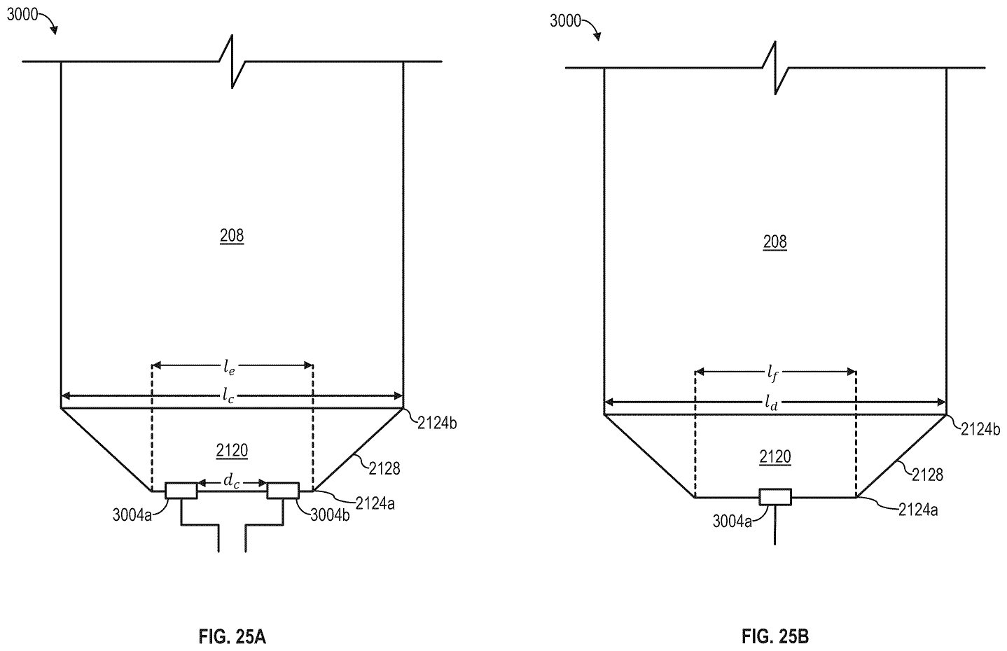

Referring now to FIGS. 25A and 25B, shown therein is an exemplary embodiment of a microstrip patch antenna array 3000 constructed in accordance with the present disclosure. The microstrip patch antenna array 3000 is configured to generate and transmit the transmission signal in the electromagnetic wave form and, conversely, receive the transmission signal in the electromagnetic wave form.

In some embodiments, the microstrip patch antenna array 3000 comprises a pair of microstrip patch antennas 3004 including a first microstrip patch antenna 3004a and a second microstrip patch antenna 3004b (collectively, the “microstrip patch antennas 3004”) spaced a third distance d_{c} from the first microstrip patch antenna 3004a. However, in other embodiments, the microstrip patch antenna array 3000 may comprise more than two of the microstrip patch antennas 3004.

In some embodiments, the microstrip patch antenna array 3000 may further comprise the horn 2120 having the first end 2124a proximal to the microstrip patch antennas 3004, the second end 2124b distal to the microstrip patch antennas 3004, and the curved surface 2128 extending between the ends 2124. As shown in FIG. 25A, in a first direction, the horn 2120 at the first end 2124a may have the fifth cross-sectional length lₑ, and the horn 2120 at the second end 2124b may have the third cross-sectional length l_{c} greater than the fifth cross-sectional length lₑ. Further, as shown in FIG. 25B, in a second direction perpendicular to the first direction, the horn 2120 at the first end 2124a may have the sixth cross-sectional length l_{f}, and the horn 2120 at the second end 2124b may have the fourth cross-sectional length lₐ greater than the sixth cross-sectional length l_{f}.

In some embodiments, each of the microstrip patch antennas 3004 may be fed with the transmission signal at an equal strength and/or an opposite phase. However, in other embodiments, each of the microstrip patch antennas 3004 may be fed with the transmission signal at an equal strength and/or an equal phase. That is, the microstrip patch antennas 3004 may be configured to receive the transmission signal as a differential signal having a first complementary signal and a second complementary signal and generate and transmit the transmission signal in the electromagnetic wave form. Conversely, the microstrip patch antennas 3004 may be further configured to receive the transmission signal and provide the transmission signal as a differential signal having a first complementary signal and a second complementary signal.

The differential waveguide probe antenna 2100, the differential tapered antenna 2600, and the microstrip patch antenna array 3000 are configured to generate the transmission signal in a linearly polarized form.

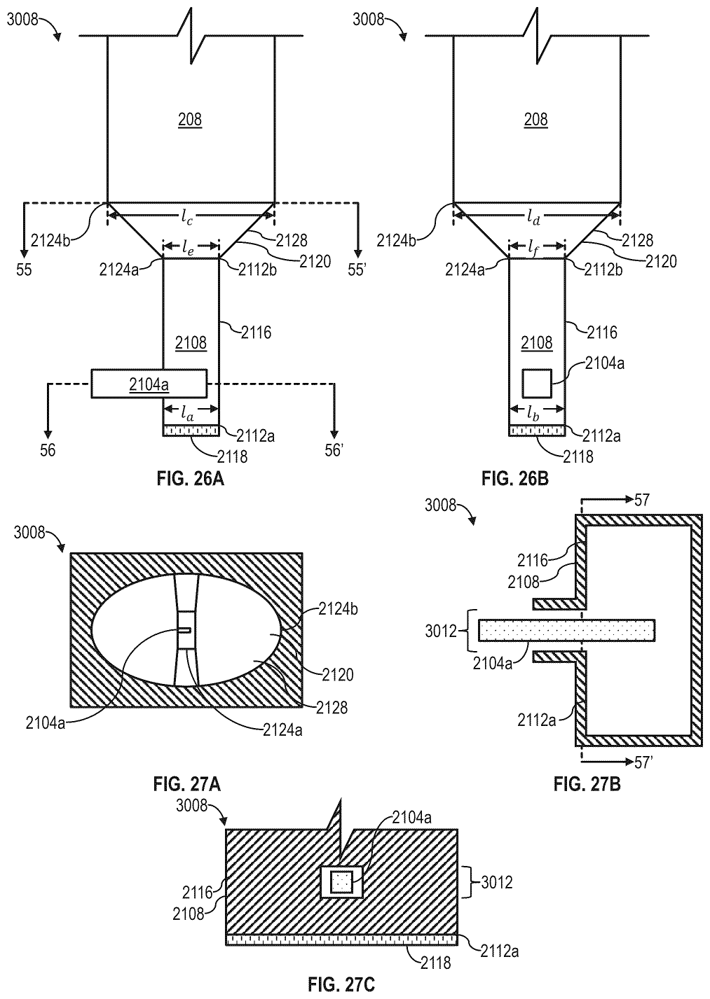

Referring now to FIGS. 26A, 26B, and 27A-27C, shown therein is a diagrammatic view of an exemplary embodiment of a single-ended waveguide probe antenna 3008 constructed in accordance with the present disclosure. In some embodiments, the single-ended waveguide probe antenna 3008 may lack the second waveguide probe 2104b, thereby only comprising the first waveguide probe 2104a. Further, in some embodiments, the surface 2116 of the intermediary waveguide 2108 may define an opening 3012 through which the first waveguide probe 2104a extends. As referenced above, in some embodiments, the first end 2112a of the intermediary waveguide 2108 may serve as a back reflector.

Referring now to FIGS. 28A, 28B, 29A-29C, and 30A-30C, shown therein are diagrammatic views of exemplary embodiments of a slot antenna 3014 constructed in accordance with the present disclosure. As shown in FIGS. 28A, 28B, 29A-29C, and 30A-30C, the slot antenna 3014 may include the ground plane 904 disposed between the intermediary waveguide 2108 and the back reflectors 2118. In some embodiments, the ground plane 904 may define one or more slots 3016 (e.g., a first slot 3016a shown in FIGS. 29A-C, 30A, and 30C and a second slot 3016b shown in FIGS. 30A-30C) (hereinafter, the “slots 3016”).

Any of the antennas disclosed herein can be used in combination with network elements described above that communicate using radio frequency communications transmitted and received by antennas. The radio frequency (RF) communications have a carrier frequency in what is referred to as a Terahertz (THz) frequency band 104 (i.e., frequencies between 0.1 THz and 10 THz and wavelengths between 3 millimeters (mm) and 30 micrometers (μm)). Where certain aspects of the present disclosure are described as relating to “THz”, it should be understood that such aspects of the present disclosure relate to the THz frequency band 104.

Referring now to FIG. 31, shown therein is another exemplary embodiment of a transceiver 4000 constructed in accordance with the present disclosure. As shown in FIG. 31, in some embodiments, the transceiver 4000 may comprise a transmitter 4004a and a receiver 4004b. The transmitter 4004a may comprise a client-side input 4008a, transmitter circuitry 4012a, and one or more outbound antennas 4016a (hereinafter, the “outbound antennas 4016a”). The transmitter 4004a may further comprise a clock source which may be one of a local clock source (not shown) configured to generate one or more clock signals (hereinafter, the “clock signals”) and a clock input 4020 configured to receive the clock signals from a remote clock source (not shown). The receiver 4004b may comprise one or more inbound antennas 4016b (hereinafter, the “inbound antennas 4016b”), receiver circuitry 4012b, and a client-side output 4008b. The receiver 4004b may further comprise a reference source which may be one of a local reference source (e.g., the clock conditioning block 4036) configured to generate one or more reference signals (hereinafter, the “reference signals”), a reference input (e.g., the clock input 4020) configured to receive the reference signals from a remote reference source (not shown), and a clock data recovery (CDR) circuit 4022 configured to recover the reference signals from the inbound radiated signals received by the inbound antennas 4016b.

The client-side input 4008a may be configured to receive one or more outbound baseband signals (hereinafter, the “outbound baseband signals”). The outbound baseband signals may have client data encoded therein. In some embodiments, the client-side input 4008a may be configured to receive the outbound baseband signals as differential signals. In such embodiments, the client-side input 4008a may comprise a first pair of electrical conductors including a first electrical conductor 4024a and a second electrical conductor 4024b. In some such embodiments, one of the first electrical conductor 4024a and the second electrical conductor 4024b may be electrically coupled to a common ground, while the other of the first electrical conductor 4024a and the second electrical conductor 4024b may receive the outbound baseband signals as single-ended signals referenced against the common ground.

In some embodiments, the client-side input 4008a may be configured to receive the outbound baseband signals as complex signals, wherein each of the complex signals includes an in-phase (I) component and a quadrature (Q) component. In such embodiments, the client-side input 4008a may comprise a pair of input terminals including a first input terminal 4028a configured to receive the I component of the outbound baseband signals and a second input terminal 4028b configured to receive the Q component of the outbound baseband signals. In some such embodiments, the first input terminal 4028a may comprise the first pair of electrical conductors including the first electrical conductor 4024a and the second electrical conductor 4024b, while the second input terminal 4028b may comprise a second pair of electrical conductors including a third electrical conductor 4024c and a fourth electrical conductor 4024d. The second pair of electrical conductors including the third electrical conductor 4024c and the fourth electrical conductor 4024d may be similar to the first pair of electrical conductors described above.

The clock input 4020 may comprise a third input terminal 4028c configured to receive the clock signals from the remote clock source. The clock signals may be periodic signals having a predetermined clock frequency. In some embodiments, the clock input 4020 may be configured to receive—or, in other embodiments, the local clock source may be configured to generate—the clock signals as differential signals. In some such embodiments, the clock input 4020 may comprise a third pair of electrical conductors 4024 including a fifth electrical conductor 4024e and a sixth electrical conductor 4024f. In some such embodiments, one of the fifth electrical conductor 4024e and the sixth electrical conductor 4024f may be electrically coupled to a common ground, while the other of the fifth electrical conductor 4024e and the sixth electrical conductor 4024f may receive the clock signals as single-ended signals referenced against the common ground.

The transmitter circuitry 4012a may be configured to receive the outbound baseband signals from the client-side input 4008a and the clock signals from the clock source (i.e., one of the local clock source and the clock input 4020) and generate one or more antenna feed signals (hereinafter, the “antenna feed signals”) based on the outbound baseband signals and the clock signals. The transmitter circuitry 4012a may comprise an outbound signal conditioning block 4032a, a clock conditioning block 4036, an outbound modulation block 4040a, and an outbound matching network 4044a.

In some embodiments, the transceiver 4000 may further comprise a power management unit (PMU) 4048 and/or an automatic test/self-test module (ATST) 4052.

In embodiments which include the PMU 4048, the transceiver 4000 may further comprise one or more PMU electrical conductors 4050a-n (hereinafter, the “PMU electrical conductors 4050”) including a first PMU electrical conductor 4050a, a second PMU electrical conductor 4050b, and a third PMU electrical conductor 4050c shown in FIG. 31, for example. The PMU 4048 may comprise analog circuitry and may be operable to manage and/or control a power supply (i.e., voltage and/or current) to the transceiver 4000 via one or more PMU regulators (hereinafter, the “PMU regulators”) and/or one or more PMU converters (hereinafter, the “PMU converters”). The PMU 4048 may be further operable to receive one or more PMU input signals (hereinafter, the “PMU input signals”) and/or transmit one or more PMU output signals (hereinafter, the “PMU output signals”) via the PMU electrical conductors 4050.

The PMU input signals may include a regulated power supply signal received from the external power supply, for example, and a power control signal from a processor 4053, for example. The PMU output signals may include one or more power measurement signals indicative of one or more of a measured voltage, a measured current, and a measured dynamic signal (i.e., a time-varying signal). Embodiments of the transceiver 4000 which include the PMU 4048 may be provided with improved noise immunity when compared with embodiments of the transceiver 4000 which do not include the PMU 4048.

Exemplary embodiments of the processor 4053 may include, but are not limited to, a digital signal processor (DSP), a central processing unit (CPU), a field programmable gate array (FPGA), a microprocessor, a multi-core processor, an application specific integrated circuit (ASIC), combinations, thereof, and/or the like, for example. The processor 4053 may be capable of communicating with the transmitter 4004a and/or the receiver 4004b. For example, the processor 4053 may be capable of communicating by exchanging signals (e.g., analog, digital, optical, and/or the like) via one or more ports (e.g., physical or virtual ports) using a network protocol to provide updated information to the transmitter 4004a and/or the receiver 4004b and/or receive updated information from the transmitter 4004a and/or the receiver 4004b.

The ATST may provide ATST output signals to an external test device (e.g., voltage or current measurement equipment, a spectrum analyzer, or an oscilloscope). High-impedance (e.g., 1,000 ohms-10 Megaohms) test equipment may be used to measure the voltage, low-impedance (i.e., 1-10 ohms) test equipment may be used to measure the current, and a 50-ohm impedance system may be used to measure the dynamic signal, for example.

In embodiments which include the ATST 4052, the transceiver 4000 may further comprise one or more ATST electrical conductors 4054a-n (hereinafter, the “ATST electrical conductors 4054”), including a first ATST electrical conductor 4054a and a second ATST electrical conductor 4054b shown in FIG. 31, for example. The ATST 4052 may be operable to perform one or more self-tests on the transceiver 4000 without using—or while minimizing use of—external test equipment, which may include performing a diagnostic test on the transceiver 4000, verifying operation of the circuitry of the transceiver 4000 described herein, detecting faults and/or malfunctions in the transceiver 4000, reporting results of such tests, and/or initiating corrective action if needed. The ATST 4052 may be further operable to receive one or more ATST input signals (hereinafter, the “ATST input signals”) and/or transmit one or more ATST output signals (hereinafter, the “ATST output signals”) via the ATST electrical conductors 4054. The ATST 4052 may be implemented using transistor-based switches configured to provide an on-chip voltage or current to at least one of the ATST electrical conductors 4054. The ATST input signals may include a test control signal received from the processor 4053, for example.

As described herein, the transceiver 4000 generally comprises a plurality of signal processing circuit blocks, wherein each of the signal processing circuit blocks includes digital configuration parameters that enable modification of operational parameters. The ATST 4052 may interface with the signal processing circuit blocks to facilitate internal and external testing operations. Further, the ATST 4052 may provide observation variables to designated test points (e.g., external equipment or internal testing blocks such as an on-chip high-resolution analog-to-digital converter (ADC)). Based on the outputs of such tests, actuation controls for the designated test points (e.g., external equipment or internal testing blocks such as an on-chip high-resolution analog-to-digital converter (ADC)) may be changed to operate the transceiver 4000 at a desired specification.

The transmitter circuitry 4012a may comprise one or more outbound signal paths (hereinafter, the “outbound signal paths”). That is, in some embodiments, the transmitter circuitry 4012a may comprise a single outbound signal path. However, as shown in FIG. 31, in embodiments in which the client-side input 4008a is configured to receive the outbound baseband signals as complex signals including the I component and the Q component, the transmitter circuitry 4012a may comprise a plurality of outbound signal paths, wherein each of the outbound signal paths corresponds to a particular one of the I component and the Q component of the outbound baseband signals.

The outbound signal conditioning block 4032a may comprise one or more electrical termination circuits (TRMs) 4056 (hereinafter, the “TRMs 4056”) (e.g., a first TRM 4056a and a second TRM 4056b shown in FIG. 31) configured to receive the outbound baseband signals from the client-side input 4008a and match an impedance of a transmission medium from which the outbound baseband signals were received, one or more re-timer/bypass circuits (RET/BYPs) 4060 (hereinafter, the “RET/BYPs 4060”) (e.g., a first RET/BYP 4060a and a second RET/BYP 4060b shown in FIG. 31) configured to receive the outbound baseband signals from the TRMs 4056 and selectively re-time the outbound baseband signals, and one or more pulse-shaping circuits (shapers) 4064 (hereinafter, the “shapers 4064”) (e.g., a first shaper 4064a and a second shaper 4064b shown in FIG. 31) configured to receive the outbound baseband signals from the RET/BYPs and reshape the outbound baseband signals. The shapers 4064 may include signal processing circuitry including active and/or passive circuits configured to modify the outbound baseband signals through various techniques including filtering, performing pre-emphasis, and implementing inverse transfer functions.

The clock conditioning block 4036 may comprise a third TRM 4056c configured to receive the clock signals from the clock source and provide a matched impedance load for the clock signals, an outbound buffer (BUF) 4068a configured to receive the clock signals from the third TRM 4056c and buffer the clock signals, a frequency divider 4072 configured to receive the clock signals from the outbound BUF 4068a and divide the clock frequency by a predetermined value (e.g., integer value), and a frequency multiplier 4076 configured to receive the clock signals from the frequency divider 4072 and multiply the clock frequency by a predetermined value (e.g., predetermined integer value).

The outbound modulation block 4040a may comprise one or more outbound frequency mixers 4080 (hereinafter, the “outbound frequency mixers 4080”) (e.g., a first outbound frequency mixer 4080a and a second outbound frequency mixer 4080b shown in FIG. 31) configured to receive the outbound baseband signals from the outbound signal conditioning block 4032a and the clock signals from the clock conditioning block 4036 and modulate the outbound baseband signals onto the clock signals to generate one or more outbound intermediate signals (hereinafter, the “outbound intermediate signals”).

In embodiments in which the client-side input 4008a is configured to receive the outbound baseband signals as complex signals including the I component and the Q component, the outbound modulation block 4040a may further comprise an outbound combiner 4084a configured to receive one or more first ones (hereinafter, the “first outbound intermediate signals”) of the outbound intermediate signals from the first outbound frequency mixer 4080a and one or more second ones (hereinafter, the “second outbound intermediate signals”) of the outbound intermediate signals from the second outbound frequency mixer 4080b and combine the first outbound intermediate signals and the second outbound intermediate signals to generate one or more combined outbound intermediate signals (hereinafter, the “combined outbound intermediate signals”).

The outbound matching network 4044a may be configured to receive the combined outbound intermediate signals from the outbound modulation block 4040a and match a characteristic impedance of a transmission medium into which the intermediate signals are to be coupled (i.e., the hollow waveguides 208) to generate one or more antenna feed signals (hereinafter, the “antenna feed signals”).

The outbound antennas 4016a may be configured to receive the antenna feed signals from the transmitter circuitry 4012a, generate one or more outbound radiated signals (hereinafter, the “outbound radiated signals”) based on the antenna feed signals, and couple the outbound radiated signals into the hollow waveguides 208. The outbound radiated signals may be radiated electromagnetic waves configured for coherent detection and having a transmission frequency in a range between 300 GHz and 10 THz.

The inbound antennas 4016b may be configured to coherently detect one or more inbound radiated signals (hereinafter, the “inbound radiated signals”) coupled into the hollow waveguides 208 and generate one or more antenna output signals (hereinafter, the “antenna output signals”) based on the inbound radiated signals. The inbound radiated signals may be radiated electromagnetic waves configured for coherent detection and having a transmission frequency in a range between 300 GHz and 10 THz. The inbound radiated signals may be different from the outbound radiated signals.

In some embodiments, the inbound antennas 4016b may be configured to detect the inbound radiated signals as complex signals, wherein each of the complex signals includes an I component and a Q component. In such embodiments, the client-side output 4008b may comprise a pair of output terminals including a first output terminal 4028d configured to receive the I component of the inbound baseband signals and a second output terminal 4028e configured to receive the Q component of the inbound baseband signals.

The receiver circuitry 4012b may be configured to receive the antenna output signals from the inbound antennas 4016b and generate one or more inbound baseband signals (hereinafter, the “inbound baseband signals”) based on the antenna output signals. The inbound baseband signals may have client data encoded therein. The receiver circuitry 4012b may comprise an inbound matching network 4044b, an inbound modulation block 4040b, and an inbound signal conditioning block 4032b. In some embodiments, the receiver circuitry 4012b may further comprise a temperature sensor (TSENS) 4088 configured to monitor a temperature of the transceiver 4000, a peak detector (PkDET) 4090 configured to sample a peak amplitude of the inbound radiated signals, an analog-to-digital converter (ADC) 4092 configured to convert analog signals into a digital representation, and/or a serial peripheral interface (SPI) 4094 configured to facilitate communication between the transceiver 4000 and other network elements 204.

In some embodiments, the transceiver 4000 further comprises a temperature control circuit (not shown) operable to control a temperature of the transceiver 4000. In such embodiments, the temperature data obtained by the TSENS 4088 may be used by the transceiver 4000 as a biasing input to the temperature control circuit, thereby allowing temperature sensing and bias adjustment of the transceiver 4000 based on the temperature data obtained by the TSENS 4088.

In some embodiments, the peak amplitude data obtained by the PkDET 4090 may be used by the transceiver 4000 to determine whether to adjust an operating point bias to be applied to one or more of the circuits of the receiver circuitry 4012b to maintain a sensitivity of the receiver circuitry 4012b.

In embodiments which include the SPI 4094, the transceiver 4000 may further comprise one or more SPI electrical conductors 4098a-n (hereinafter, the “SPI electrical conductors 4098”), such as a first SPI electrical conductor 4098a, a second SPI electrical conductor 4098b, a third SPI electrical conductor 4098c, and a fourth SPI electrical conductor 4098d shown in FIG. 31, for example, and an SPI controller 4102. The SPI 4094 may be further operable to receive one or more SPI input signals (hereinafter, the “SPI input signals”) and/or transmit one or more SPI output signals (hereinafter, the “SPI output signals”) via the SPI electrical conductors 4098.

The SPI input signals may include a serial clock (SCK) signal, a serial data in (SDI) signal, a serial data out (SDO) signal, and a chip select (CS) signal, for example. The SCK signal may be a clock signal to provide timing synchronization for the SPI 4094 and may be generated by the SPI controller 4102. The SDI signal may be a serial data signal received from a remote SPI-compatible device (not shown). The SDO signal may be a serial data signal transmitted to a remote SPI-compatible device 4104. The CS signal may be activated by the SPI controller 4102 to initiate communication with a remote peripheral 4106.

The receiver circuitry 4012b may comprise one or more inbound signal paths (hereinafter, the “inbound signal paths”). That is, in some embodiments, the receiver circuitry 4012b may comprise a single inbound signal path. However, as shown in FIG. 31, in embodiments in which the inbound antennas 4016b are configured to detect the inbound radiated signals as complex signals including the I component and the Q component, the receiver circuitry 4012b may comprise a plurality of inbound signal paths, wherein each of the inbound signal paths corresponds to a particular one of the I component and the Q component of the inbound radiated signals.

The inbound matching network 4044b may be configured to receive the antenna output signals from the inbound antennas 4016b and match a characteristic impedance of the transmission medium from which the antenna output signals were received (i.e., the hollow waveguides 208) to generate one or more inbound intermediate signals (hereinafter, the “inbound intermediate signals”). The inbound matching network 4044b may include active and/or passive circuitry operable to match impedances between the transmission medium (i.e., the hollow waveguides 208) and the receiver circuitry 4012b in order to minimize signal reflections and maximize an amount of power received from the inbound antennas 4016b. In some embodiments, the inbound matching network 4044b may be configured to implement impedance transformation in a lossless manner to achieve complex conjugate matching between the receiver circuitry 4012b and the inbound antennas 4016b. For example, if the inbound antennas 4016b “see” an impedance Zₐ=R+jX (where R represents the real component and jX represents the complex component), the receiver circuitry 4012b may “see” a corresponding impedance Zᵣ=R−jX. In such embodiments, such a complex conjugate matching arrangement may facilitate maximum power transfer between the inbound antennas 4016b and the receiver circuitry 4012b.

The inbound modulation block 4040b may comprise one or more inbound frequency mixers 4082 (hereinafter, the “inbound frequency mixers 4082”) (e.g., a first inbound frequency mixer 4082c and a second inbound frequency mixer 4082d shown in FIG. 31) configured to receive the inbound intermediate signals from the inbound matching network 4044b and the reference signals from the reference source (e.g., the clock conditioning block 4036) and modulate the inbound intermediate signals onto the reference signals to generate the inbound baseband signals.

The inbound signal conditioning block 4032b may comprise one or more amplifiers 4096 (e.g., a first amplifier 4096a and a second amplifier 4096b shown in FIG. 31) configured to receive the inbound baseband signals from the inbound modulation block 4040b and amplify the inbound baseband signals and one or more inbound BUFs 4068 (e.g., a first inbound BUF 4068b and a second inbound BUF 4068c shown in FIG. 31) configured to receive the inbound baseband signals from the amplifiers 4096 and buffer the inbound baseband signals. In some embodiments, one or more of the amplifiers 4096 may be a transimpedance amplifier (TIA).

The client-side output 4008b may be configured to receive the inbound baseband signals from the inbound BUFs 4068 and transmit the inbound baseband signals from the transceiver 4000. In some embodiments, the client-side output 4008b may be configured to transmit the inbound baseband signals as differential signals. In such embodiments, the client-side output 4008b may comprise a fourth pair of electrical conductors including a seventh electrical conductor 4024g and an eighth electrical conductor 4024h. In some such embodiments, one of the seventh electrical conductor 4024g and the eighth electrical conductor 4024h may be electrically coupled to a common ground, while the other of the seventh electrical conductor 4024g and the eighth electrical conductor 4024h may transmit the outbound baseband signals as single-ended signals referenced against the common ground.

In some embodiments, the client-side output 4008b may be configured to transmit the inbound baseband signals as complex signals, wherein each of the complex signals includes an I component and a Q component. In such embodiments, the client-side output 4008b may comprise the pair of output terminals including the first output terminal 4028d configured to transmit the I component of the inbound baseband signals and the second output terminal 4028e configured to transmit the Q component of the inbound baseband signals. In some such embodiments, the first output terminal 4028d may comprise the fourth pair of electrical conductors including the seventh electrical conductor 4024g and the eighth electrical conductor 4024h, while the second output terminal 4028e may comprise a fifth pair of electrical conductors including a ninth electrical conductor 4024i and a tenth electrical conductor 4024j. The fifth pair of electrical conductors including the ninth electrical conductor 4024i and the tenth electrical conductor 4024j may be similar to the fourth pair of electrical conductors described above.

Referring now to FIG. 32, shown therein is another exemplary embodiment of a transceiver 4000a constructed in accordance with the present disclosure. As shown in FIG. 32, in some embodiments, the clock conditioning block 4036 may comprise a first frequency divider 4072a and a second frequency divider 4072b instead of the frequency divider 4072 shown in FIG. 31 and a first frequency multiplier 4076a and a second frequency multiplier 4076b instead of the frequency multiplier 4076 shown in FIG. 31. In such embodiments, the outbound modulation block 4040a may further comprise a third outbound frequency mixer 4080e, and the inbound modulation block 4040b may further comprise a third inbound frequency mixer 4082f. The frequency divider 4072, the first frequency divider 4072a and the second frequency divider can be made using analog or digital frequency dividers. Examples of analog frequency dividers include regenerative frequency dividers, and injection locked frequency dividers. Exemplary digital frequency dividers include binary counters, Johnson counters, mixed signal dividers, fractional-N synthesis dividers, and delta-sigma fractional-n dividers. The frequency multiplier 4076, the first frequency multiplier 4076a, and the second frequency multiplier 4076b can be electronic circuits that generates an output signal having an output frequency that is a harmonic (multiple) of an input frequency received by the electronic circuit. The Frequency multipliers 4076, 4076a and 4076b may include a nonlinear circuit that distorts the input signal and consequently generates harmonics of the input signal, and a subsequent bandpass filter that selects the desired harmonic frequency and removes the unwanted fundamental and other harmonics from the output. The frequency multipliers 4076, 4076a and 4076b may also include an amplifier to amplify the desired harmonic frequency.

In the embodiment shown in FIG. 32, the first frequency divider 4072a may be configured to receive the clock signals from the outbound BUF 4068a and divide the clock frequency by a first predetermined integer value (e.g., two) to generate one or more first clock signals (hereinafter, the “first clock signals”) having a first clock frequency, while the second frequency divider 4072b may be configured to receive the clock signals from the outbound BUF 4068a and divide the clock frequency by a second predetermined integer value (e.g., four) to generate one or more second clock signals (hereinafter, the “second clock signals”) having a second clock frequency.

In the embodiment shown in FIG. 32, the first frequency multiplier 4076a may be configured to receive the first clock signals from the first frequency divider 4072a and multiply the first clock frequency by a third predetermined integer value (e.g., three), while the second frequency multiplier 4076b may be configured to receive the second clock signals from the second frequency divider 4072b and multiply the second clock frequency by a fourth predetermined integer value (e.g., three). In some embodiments, the second frequency multiplier 4076b may be configured to multiply the second clock frequency by the fourth predetermined integer value multiple times (e.g., three times).

In the embodiment shown in FIG. 32, the first outbound frequency mixer 4080a and the second outbound frequency mixer 4080b may be configured to receive the outbound baseband signals from the outbound signal conditioning block 4032a and the first clock signals from the clock conditioning block 4036 and modulate the outbound baseband signals onto the first clock signals to generate the outbound intermediate signals.

In the embodiment shown in FIG. 32, the third outbound frequency mixer 4080e may be configured to receive the outbound intermediate signals from the outbound combiner 4084a and the second clock signals from the clock conditioning block 4036 and modulate the outbound intermediate signals onto the second clock signals.

In the embodiment shown in FIG. 32, the third inbound frequency mixer 4082f may be configured to configured to receive the inbound intermediate signals from the inbound matching network 4044b and the reference signals from the reference source (e.g., the clock conditioning block 4036) and modulate the inbound intermediate signals onto the reference signals, while the first inbound frequency mixer 4082c and the second inbound frequency mixer 4082d may be configured to receive the inbound intermediate signals from the third inbound frequency mixer 4082f and the reference signals from the reference source (e.g., the clock conditioning block 4036) and modulate the inbound intermediate signals onto the reference signals to generate the inbound baseband signals.

Referring now to FIG. 33, shown therein is another exemplary embodiment of a transceiver 4000b constructed in accordance with the present disclosure. As shown in FIG. 32, in some embodiments, the clock conditioning block 4036 may comprise a third amplifier 4096c configured to receive the configured to receive the clock signals from the frequency multiplier 4076 and amplify the clock signals, while the third outbound frequency mixer 4080e may be configured to receive the outbound intermediate signals from the outbound combiner 4084a and the clock signals from the clock conditioning block 4036 and modulate the outbound intermediate signals onto the clock signals.

In the embodiment shown in FIG. 33, the frequency multiplier 4076 may be configured to receive the clock signals from the frequency divider 4072 and multiply the clock frequency by a fifth integer predetermined value (e.g., three). In some embodiments, the frequency multiplier 4076 may be configured to multiply the clock frequency by the fifth predetermined integer value multiple times (e.g., two times).

It should be understood that the first predetermined integer value, the second predetermined integer value, the third predetermined integer value, the fourth predetermined integer value, and the fifth predetermined integer value may be any integer value.

In the embodiment shown in FIG. 33, the third inbound frequency mixer 4082f may be configured to configured to receive the inbound intermediate signals from the inbound matching network 4044b and the reference signals from the reference source (e.g., the clock conditioning block 4036) and modulate the inbound intermediate signals onto the reference signals.

Referring now to FIG. 34, shown therein is another exemplary embodiment of a transmitter 4004a constructed in accordance with the present disclosure. As shown in FIG. 34, in some embodiments, the outbound signal conditioning block 4032a may comprise one or more outbound splitters 4300 (hereinafter, the “outbound splitters 4300”) (e.g., a first outbound splitter 4300a and a second outbound splitter 4300b shown in FIG. 34), while the outbound modulation block 4040a may comprise a plurality of outbound frequency mixer blocks 4304 (e.g., a first outbound frequency mixer block 4304a, a second outbound frequency mixer block 4304b, a third outbound frequency mixer block 4304c, and a fourth outbound frequency mixer block 4304d shown in FIG. 34).

In the embodiment shown in FIG. 34, each of the outbound splitters 4300 may be configured to receive the outbound baseband signals from a particular one of the shapers 4064 (i.e., the first outbound splitter 4300a may be configured to receive the outbound baseband signals from the first shaper 4064a, while the second outbound splitter 4300b may be configured to receive the outbound baseband signals from the second shaper 4064b) and split the outbound baseband signals into a predetermined integer number (e.g., four) of outbound baseband signals. It should be understood that the predetermined integer number may be any integer number. The outbound splitters 4300 may include passive and/or active circuitry operable to distribute power equally between each of the outbound baseband signals. That is, the outbound splitters 4300 may be operable to provide equal impedances to each of the outbound baseband signals having been split by the outbound splitters 4300, thereby distributing power equally between each of the outbound baseband signals having been split by the outbound splitters 4300.

In the embodiment shown in FIG. 34, each of the outbound frequency mixer blocks 4304 may include a pair of outbound frequency mixers 4080 and an outbound I/Q local oscillator (LO) 4308 (e.g., a first outbound I/Q LO 4308a, a second outbound I/Q LO 4308b, a third outbound I/Q LO 4308c, and a fourth outbound I/Q LO 4308d shown in FIG. 34) (collectively, the “outbound I/Q LOs 4308”). For purposes of clarity, only two of the outbound frequency mixers 4080 (i.e., the first outbound frequency mixer 4080a and the second outbound frequency mixer 4080b shown in FIG. 34) are labeled with a reference character.

In the embodiment shown in FIG. 34, each of the outbound I/Q LOs 4308 may be configured to receive the clock signals from the clock conditioning block 4036 and generate one or more phase-shifted clock signals (hereinafter, the “phase-shifted clock signals”) based on the clock signals. The phase-shifted clock signals may have a 90-degree phase-shift relative to the clock signals, for example. In some embodiments, the outbound I/Q LOs 4308 may be configured to provide sufficient drive and phase adjustment to the outbound frequency mixers 4080.

In the embodiment shown in FIG. 34, each of the outbound frequency mixers 4080 may be configured to receive a particular one of the outbound baseband signals from the outbound signal conditioning block 4032a and the phase-shifted clock signals from a particular one of the outbound I/Q LOs 4308 and modulate the outbound baseband signals onto the phase-shifted clock signals to generate the outbound intermediate signals. For example, the first outbound frequency mixer 4080a may be configured to receive a first one of the outbound baseband signals from the first outbound splitter 4300a and the phase-shifted clock signals from the first outbound I/Q LO 4308a and modulate the first one of the outbound baseband signals onto the phase-shifted clock signals to generate a first one of the outbound intermediate signals, while the second outbound frequency mixer 4080b may be configured to receive a second one of the outbound baseband signals from the second outbound splitter 4300b and the phase-shifted clock signals from the second outbound I/Q LO 4308b and modulate the second one of the outbound baseband signals onto the phase-shifted clock signals to generate a second one of the outbound intermediate signals.

Modulating the outbound baseband signals, which may be double-sideband signals, onto the phase-shifted clock signals may have the effect of canceling out or rejecting one sideband (i.e., an upper or lower sideband) of the outbound intermediate signals, thereby converting the double-sideband signals into single-sideband signals.

Referring now to FIG. 35, shown therein is another exemplary embodiment of a receiver 4004b constructed in accordance with the present disclosure. As shown in FIG. 35, in some embodiments, the inbound modulation block 4040b may comprise an inbound splitter 4300c and a plurality of inbound frequency mixer blocks 4306 (e.g., (e.g., a first inbound frequency mixer block 4306e, a second inbound frequency mixer block 4306f, a third inbound frequency mixer block 4306g, and a fourth inbound frequency mixer block 4306h shown in FIG. 35), wherein each of the inbound frequency mixer blocks 4306 may include a pair of inbound frequency mixers 4082 and an inbound I/Q LO 4310 (e.g., a first inbound I/Q LO 4310e, a second inbound I/Q LO 4310f, a third inbound I/Q LO 4310g, and a fourth inbound I/Q LO 4310h shown in FIG. 35) (collectively, the “inbound I/Q LOs 4310”). For purposes of clarity, only two of the inbound frequency mixers 4082 (i.e., the first inbound frequency mixer 4082c and the second inbound frequency mixer 4082d shown in FIG. 35) are labeled with a reference character.

As shown in FIG. 35, in some embodiments, the inbound signal conditioning block 4032b may comprise a plurality of equalizers 4400 (e.g., a first equalizer 4400a, a second equalizer 4400b, a third equalizer 4400c, and a fourth equalizer 4400d shown in FIG. 35), a plurality of amplifiers 4096 (e.g., a first amplifier 4096a, a second amplifier 4096b, a third amplifier 4096c, and a fourth amplifier 4096d shown in FIG. 35), an inbound combiner 4084b, and one or more driver/termination (DRV/TRM) blocks 4404 (e.g., a first DRV/TRM block 4404a and a second DRV/TRM block 4404b shown in FIG. 35).

In the embodiment shown in FIG. 35, the inbound splitter 4300c may be configured to receive the inbound intermediate signals from the inbound matching network 4044b and split the inbound intermediate signal into a predetermined integer number (e.g., four) of inbound intermediate signals. It should be understood that the predetermined integer number may be any integer number.

In the embodiment shown in FIG. 35, each of the inbound I/Q LOs 4310 may be configured to receive the clock signals from the clock conditioning block 4036 and generate the phase-shifted clock signals based on the clock signals. In some embodiments, the inbound I/Q LOs 4310 may be configured to provide sufficient drive and phase adjustment to the inbound frequency mixers 4082.

In the embodiment shown in FIG. 35, each of the inbound frequency mixers 4082 may be configured to receive a particular one of the inbound intermediate signals from the inbound splitter 4300c and the phase-shifted clock signals from a particular one of the inbound I/Q LOs 4310 and modulate the inbound intermediate signals onto the phase-shifted clock signals to generate the inbound baseband signals. For example, the first inbound frequency mixer 4082c may be configured to receive a first one of the inbound intermediate signals from the inbound splitter 4300c and the phase-shifted clock signals from the first inbound I/Q LO 4310e and modulate the first one of the inbound intermediate signals onto the phase-shifted clock signals to generate a first one of the inbound baseband signals, while the second inbound frequency mixer 4082db may be configured to receive a second one of the inbound intermediate signals from the inbound splitter 4300c and the phase-shifted clock signals from the second inbound I/Q LO 4310f and modulate the second one of the inbound intermediate signals onto the phase-shifted clock signals to generate a second one of the inbound baseband signals.

Modulating the inbound intermediate signals, which may be double-sideband signals, onto the phase-shifted clock signals may have the effect of canceling out or rejecting one sideband (i.e., an upper or lower sideband) of the inbound baseband signals, thereby converting the double-sideband signals into single-sideband signals.

In the embodiment shown in FIG. 35, each of the equalizers 4400 may be configured to receive a particular one of the inbound baseband signals from the inbound modulation block 4040b and equalize (i.e., restore signal shape, correct distortion, and/or eliminate interference of) the particular one of the inbound baseband signals. In some embodiments, one or more of the equalizers 4400 may be a continuous-time linear equalizer (CTLE). However, in other embodiments, one or more of the equalizers 4400 may be a linear, non-linear, or adaptive equalizer, for example.

In the embodiment shown in FIG. 35, each of the amplifiers 4096 may be configured to receive a particular one of the inbound baseband signals from a particular one of the equalizers 4400 and amplify the particular one of the inbound baseband signals. In some implementations, one or more of the amplifiers 4096 may be a variable-gain amplifier (VGA).

In the embodiment shown in FIG. 35, the inbound combiner 4084b may be configured to receive the inbound baseband signals from each of the amplifiers 4096 and combine the inbound baseband signals to generate one or more combined inbound baseband signals (hereinafter, the “combined inbound baseband signals”).

In the embodiment shown in FIG. 35, each of the DRV/TRM blocks 4404 may be configured to receive a particular one of the combined inbound baseband signals, drive (i.e., amplify the signal to a sufficient power level for transmission) the particular one of the combined inbound baseband signals, and provide impedance termination for the particular one of the combined inbound baseband signals to prevent signal reflection. The termination impedance may be 50 ohms, for example. The implementation of this impedance matching may be based on the system architecture: in wideband or broadband transceiver systems, for example, the transceiver blocks are directly designed to present input and output impedances of 50 ohms; and in narrowband transceiver applications, for example, the standard 50-ohm impedance may be transformed to a desired impedance value using a lossless matching network.

In the embodiment shown in FIG. 35, each of the output terminals 4028 may be configured to receive a particular one of the combined inbound baseband signals from a particular one of the DRV/TRM blocks 4404 and transmit the combined inbound baseband signals to one or more external component (e.g., a control module 224).

Referring now to FIG. 36, shown therein is an exemplary embodiment of a first differential circuit 4500a constructed in accordance with the present disclosure. In the embodiment shown in FIG. 36, the first differential circuit 4500a is implemented as a neutralized buffer with local regulation. The first differential circuit 4500a generally comprises: a differential input 4504 including a positive input terminal (IN+) 4508a and a negative input terminal (IN−) 4508b, for example; one or more voltage bias nodes (VBNs) 4512a-n (hereinafter, the “VBNs 4512”) including a first VBN (VBN1) 4512a and a second VBN (VBN2) 4512b, for example; a positive power supply node (VDD) 4516; a common ground node 4520; a plurality of transistors 4524a-n (hereinafter, the “transistors 4524”) including a first transistor (Q1) 4524a, a second transistor (Q2) 4524b, and a third transistor (Q3) 4524c, for example; one or more capacitors 4526a-n (hereinafter, the “capacitors 4526”) including a first capacitor 4526a and a second capacitor 4526b, for example; and a differential output 4528 including a positive output terminal (OUT+) 4530a and a negative output terminal (OUT−) 4530b, for example.

The first transistor 4524a and the second transistor 4524b may be operable to function as gain elements for the first differential circuit 4500a, while the third transistor 4524c may be operable to provide local regulation for the first differential circuit 4500a. Local regulation refers to a mechanism by which power regulation elements are used to isolate individual circuit blocks from power supply fluctuations. For example, a single regulator that provides local regulation to a plurality of circuit blocks would still perform the regulation, but the fluctuations from one of the plurality of circuit blocks may be visible to the others of the plurality of circuit blocks. The third transistor 4524c may provide isolation from the power supply node 4516, which may be an unregulated power supply.

The first VBN 4512a may be operable to indicate, determine, and/or set a bias voltage that is applied to base terminals of the first transistor 4524a and the second transistor 4524b, while the second VBN 4512b may be operable to indicate, determine, and/or set a bias voltage that is applied to base terminal of the third transistor 4524c. The first capacitor 4526a and the second capacitor 4526b may be operable to function as coupling capacitances for the first differential circuit 4500.

The first differential circuit 4500a having transformer elements and being provided with the first capacitor 4526a and the second capacitor 4526b functioning as coupling capacitances may be operable to ensure independent DC biasing at the differential input 4504 and the differential output 4528.

Referring now to FIG. 37, shown therein is an exemplary embodiment of a second differential circuit 4500b constructed in accordance with the present disclosure. In the embodiment shown in FIG. 37, the second differential circuit 4500b is implemented as a transformer-coupled four-quadrant multiplier. The second differential circuit 4500b generally comprises: the differential input 4504 including the positive input terminal (IN+) 4508a and the negative input terminal (IN−) 4508b, for example; a differential local oscillator (LO) input 4510 including a first positive LO terminal (LO+) 4514a, a second positive LO terminal (LO+) 4514b, and a common negative LO terminal (LO−) 4514c, for example; the second VBN (VBN2) 4512b; the positive power supply node (VDD) 4516; the common ground node 4520; the transistors 4524 including the third transistor (Q3) 4524c, a first input transistor (Q1A) 4524d, a second input transistor (Q1B) 4524e, a first LO transistor (Q2A) 4524f, a second LO transistor (Q2B) 4524g, a third LO transistor (Q2C) 4524h, and a fourth LO transistor (Q2D) 4524i, for example; and the differential output 4528 including the positive output terminal (OUT+) 4530a and the negative output terminal (OUT−) 4530b, for example.

Referring now to FIG. 38, shown therein is an exemplary embodiment of a third differential circuit 4500c constructed in accordance with the present disclosure. In the embodiment shown in FIG. 38, the third differential circuit 4500c is implemented as a four-quadrant multiplier with current mode inputs and voltage mode outputs. The third differential circuit 4500c generally comprises: a differential current mode input 4502 including a positive current mode input terminal (IN+) 4506a and a negative current mode input terminal (IN−) 4506b, for example; the differential LO input 4510 including the first positive LO terminal (LO+) 4514a, the second positive LO terminal (LO+) 4514b, and the common negative LO terminal (LO−) 4514c, for example; the second VBN (VBN2) 4512b, the positive power supply node (VDD) 4516; a direct current (DC) input 4518 including a first DC input terminal (DC1) 4522a and a second DC input terminal (DC2) 4522b, for example; the common ground node 4520; the transistors 4524 including the third transistor (Q3) 4524c, the first input transistor (Q1A) 4524d, the second input transistor (Q1B) 4524e, the first LO transistor (Q2A) 4524f, the second LO transistor (Q2B) 4524g, the third LO transistor (Q2C) 4524h, and the fourth LO transistor (Q2D) 4524i, for example; and the differential output 4528 including the positive output terminal (OUT+) 4530a and the negative output terminal (OUT−) 4530b, for example.

Referring now to FIG. 39, shown therein is an exemplary embodiment of a signal combiner array 4800 constructed in accordance with the present disclosure. In the embodiment shown in FIG. 39, the signal combiner array 4800 generally comprises: one or more beamforming elements 4804a-n (hereinafter, the “beamforming elements 4804”) including a first beamforming element 4804a, a second beamforming element 4804b, a third beamforming element 4804c, and a fourth beamforming element 4804d, for example; one or more frequency mixers 4808a-n (hereinafter, the “frequency mixers 4808”) including a first frequency mixer 4808a, a second frequency mixer 4808b, a third frequency mixer 4808c, and a fourth frequency mixer 4808d, for example; and one or more antennas 4812a-n (hereinafter, the “antennas 4812”) including a first antenna 4812a, a second antenna 4812b, a third antenna 4812c, and a fourth antenna 4812d, for example.

One or more of the beamforming elements 4804 may be operable to receive an LO signal—from an on-chip clock multiplier (e.g., one of the frequency multipliers 4076) or divider (e.g., one of the frequency dividers 4072) or directly from one of the LOs 4308, for example—having an LO frequency (f_{LO}) and multiply the frequency of the LO signal by a predetermined integer value (N) to generate one or more multiplied LO signals (hereinafter, the “multiplied LO signals”), each of the multiplied LO signals having a multiplied LO frequency (N·f_{LO}).

One or more of the frequency mixers 4808 may be operable to receive the multiplied LO signals from the beamforming elements 4804 and a baseband signal from one of the baseband processing blocks described herein (e.g., one or more of the TRMs 4056, the RET/BYPs 4060, and the shapers 4064 of the outbound signal conditioning block 4032) having a baseband frequency (f_{BB}) and mix the multiplied LO signals with the baseband signal to generate one or more antenna feed signals (hereinafter, the “antenna feed signals”), each of the antenna feed signals having a transmission frequency (f_{Tx}) equal to a sum of the multiplied LO frequency (N·f_{LO}) and the baseband frequency. One or more of the antennas 4812 may be operable to receive the antenna feed signals from the frequency mixers 4808, generate one or more radiated signals (hereinafter, the “radiated signals”) based on the antenna feed signals, and couple the radiated signals into a hollow waveguide 208.

The outbound signal conditioning block 4032a may comprise one or more electrical termination circuits (TRMs) 4056 (hereinafter, the “TRMs 4056”) (e.g., a first TRM 4056a and a second TRM 4056b shown in FIG. 31) configured to receive the outbound baseband signals from the client-side input 4008a and match an impedance of a transmission medium from which the outbound baseband signals were received, one or more re-timer/bypass circuits (RET/BYPs) 4060 (hereinafter, the “RET/BYPs 4060”) (e.g., a first RET/BYP 4060a and a second RET/BYP 4060b shown in FIG. 31) configured to receive the outbound baseband signals from the TRMs 4056 and selectively re-time the outbound baseband signals, and one or more pulse-shaping circuits (shapers) 4064 (hereinafter, the “shapers 4064”) (e.g., a first shaper 4064a and a second shaper 4064b shown in FIG. 31) configured to receive the outbound baseband signals from the RET/BYPs and reshape the outbound baseband signals. The shapers 4064 may include signal processing circuitry including active and/or passive circuits configured to modify the outbound baseband signals through various techniques including filtering, performing pre-emphasis, and implementing inverse transfer functions.

In some embodiments, the signal combiner array 4800 is fully differential. In some embodiments, one or more of the beamforming elements 4804 may be implemented using an up-conversion mixer topology (i.e., the transmission frequency is higher than the LO frequency). That is, the mixer topology may be used to implement a multiplier. It should be understood that a mixer represents a multiplication of two signals (i.e., Y=X₁*X₂). If X₁ and X₂ are harmonically related, then Y may represent a frequency multiplier. There are two types of mixing operations: real and complex. If X₁ and X₂ are real variables, then the mixing is a real mixing. Conversely, if X₁ and X₂ are complex variables, then the mixing is a complex mixing.

Referring now to FIG. 40, shown therein is a diagrammatic view of a method 4900 of using the transport network 200 in accordance with the present disclosure. As shown in FIG. 40, the method 4900 generally comprises the steps of: providing one or more baseband signals to a transmitter 4004a in a transport network 200, at least one of the one or more baseband signal having client data encoded therein, the transport network 200 comprising one or more hollow waveguides 208, the transmitter 4004a coupled to the one or more hollow waveguides 208, and a receiver 4004b coupled to the one or more hollow waveguides 208 (step 4904); generating, by the transmitter 4004a, one or more radiated signals based on the one or more baseband signals, at least one of the one or more radiated signals being a radiated electromagnetic wave having a transmission frequency in a range between 300 Gigahertz (GHz) and 10 Terahertz (THz) (step 4908); coupling, by the transmitter 4004a, the one or more radiated signals into the one or more hollow waveguides 208 (step 4912); receiving, by the receiver 4004b, the one or more radiated signals from the one or more hollow waveguides 208 (step 4916); measuring, by the receiver 4004b, one or more signal quality parameters (e.g., signal distortion, bit error rate, spurious free dynamic range (SFDR), signal-to-noise ratio (SNR), signal dynamic range, jitter, etc.) of the one or more radiated signals (step 4920); generating, by the receiver 4004b, one or more actuation controls based on the one or more signal quality parameters, each of the one or more actuation controls being configured to adjust one or more transmitter operating parameters (e.g., gain, bandwidth, equalization parameters (e.g., power consumption of active signal processing circuit blocks and/or bandwidth-controlling elements, which may affect broadband bandwidth and resonant frequencies), linearity, jitter, etc.) of the transmitter 4004a (step 4924); sending, by the receiver 4004b, an actuation control signal having the one or more actuation controls encoded therein (step 4928); receiving, by the transmitter 4004a, the actuation control signal (step 4932); and adjusting, by the transmitter 4004a, at least one of the one or more transmitter operating parameters based on the one or more actuation controls (step 4936).

The step of adjusting at least one of the transmitter operating parameters based on the one or more actuation controls (step 4936) may be further defined as adjusting, by the processor 4053, at least one of the transmitter operating parameters based on the one or more actuation controls. The step of generating the one or more radiated signals based on the one or more baseband signals (step 4908) may include mixing, by the transmitter 4004a, each of the one or more baseband signals with a particular local oscillator signal of one or more local oscillator signals. Each particular local oscillator signal of the one or more local oscillator signals having a particular local oscillator frequency of a plurality of local oscillator frequencies. At least one of the plurality of local oscillator frequencies may be the transmission frequency.

### Illustrative Clauses

Exemplary, non-limiting illustrative clauses are provided in the clauses below. However, the scope of the present inventive concept(s) is to be understood to not be limited in any manner by the clauses presented below.

Illustrative clause 1. A transmitter, comprising: a client-side input configured to receive one or more baseband signals having client data encoded therein; a signal conditioning block configured to receive the one or more baseband signals from the client-side input and adjust one or more signal characteristics of the one or more baseband signals to generate one or more intermediate signals based on the one or more baseband signals; a clock conditioning block configured to receive a first clock signal and adjust one or more signal characteristics of the first clock signal to generate a second clock signal based on the first clock signal, the first clock signal having a first clock frequency, the second clock signal having a second clock frequency that is a harmonic frequency corresponding to the first clock frequency; a modulation block configured to receive the one or more intermediate signals from the signal conditioning block and the second clock signal from the clock conditioning block and modulate the one or more intermediate signals onto the second clock signal to generate one or more antenna feed signals; and one or more antennas configured to receive the one or more antenna feed signals from the modulation block, generate one or more radiated signals based on the one or more antenna feed signals, and couple the one or more radiated signals into one or more hollow waveguides, each of the one or more radiated signals being radiated electromagnetic waves configured for coherent detection and having a transmission frequency in a range between 300 Gigahertz (GHz) and 10 Terahertz (THz).

Illustrative clause 2. The transmitter of illustrative clause 1, wherein the client-side input is configured to receive the one or more baseband signals having the client data encoded therein using a modulation protocol conforming to a specification of one of intensity modulation (IM)/direct detection (DD) (IM/DD), return-to-zero (RZ) code, non-return-to-zero (NRZ) code, pulse-amplitude modulation (PAM), IM-PAM, quadrature-amplitude modulation (QAM), and single-sideband (SSB) modulation.

Illustrative clause 3. The transmitter of illustrative clause 1, further comprising a clock source configured to generate the first clock signal, the clock conditioning block being configured to receive the first clock signal from the clock source.

Illustrative clause 4. The transmitter of illustrative clause 1, wherein the client-side input includes one or more signal input ports, each of the one or more signal input ports including a first electrical conductor electrically coupled to a common ground and a second electrical conductor configured to be electrically coupled to a particular first transmission medium of one or more first transmission mediums, the client-side input being configured to receive the one or more baseband signals from the one or more first transmission mediums as one or more single-ended signals referenced against the common ground.

Illustrative clause 5. The transmitter of illustrative clause 4, wherein the signal conditioning block includes one or more first electrical termination circuits, each of the one or more first electrical termination circuits being configured to receive a particular baseband signal of the one or more baseband signals from a particular signal input port of the one or more signal input ports and match a characteristic impedance of the particular first transmission medium to which the second electrical conductor of the particular signal input port is configured to be electrically coupled.

Illustrative clause 6. The transmitter of illustrative clause 5, wherein the signal conditioning block further includes one or more re-timer circuits, each of the one or more re-timer circuits being configured to receive a particular baseband signal of the one or more baseband signals from a particular first electrical termination circuit of the one or more first electrical termination circuits and re-time the particular baseband signal.

Illustrative clause 7. The transmitter of illustrative clause 6, wherein each of the one or more re-timer circuits includes a re-timer portion and a bypass portion, the re-timer portion of each of the one or more re-timer circuits being configured to receive a particular baseband signal of the one or more baseband signals from a particular first electrical termination circuit of the one or more first electrical termination circuits and selectively re-time the particular baseband signal, the bypass portion of each of the one or more re-timer circuits being configured to receive a particular baseband signal of the one or more baseband signals from a particular first electrical termination circuit of the one or more first electrical termination circuits and selectively bypass the re-timer portion.

Illustrative clause 8. The transmitter of illustrative clause 6, wherein the signal conditioning block further includes one or more pulse-shaping circuits, each of the one or more pulse-shaping circuits being configured to receive a particular baseband signal of the one or more baseband signals from a particular re-timer circuit of the one or more re-timer circuits and adjust one or more signal characteristics of the one or more baseband signals to generate the one or more intermediate signals based on the one or more baseband signals.

Illustrative clause 9. The transmitter of illustrative clause 8, wherein the signal conditioning block further includes one or more splitters, each of the one or more splitters being configured to receive a particular intermediate signal of the one or more intermediate signals from a particular pulse-shaping circuit of the one or more pulse-shaping circuits and split the particular intermediate signal into a plurality of intermediate signals.

Illustrative clause 10. The transmitter of illustrative clause 9, wherein the plurality of intermediate signals are a plurality of first intermediate signals and the modulation block includes a plurality of frequency mixers and a combiner, each of the plurality of frequency mixers being configured to receive a particular intermediate signal of the plurality of intermediate signals from the signal conditioning block and the second clock signal from the clock conditioning block and modulate the particular intermediate signal onto the second clock signal to generate a plurality of second intermediate signals, the combiner being configured to receive the plurality of second intermediate signals from the one or more frequency mixers and combine the plurality of second intermediate signals to generate the one or more antenna feed signals.

Illustrative clause 11. The transmitter of illustrative clause 1, further comprising a clock input configured to receive the first clock signal, the clock conditioning block being configured to receive the first clock signal from the clock input.

Illustrative clause 12. The transmitter of illustrative clause 11, wherein the clock input includes a clock input port including a third electrical conductor electrically coupled to a common ground and a fourth electrical conductor configured to be electrically coupled to a second transmission medium, the clock input being configured to receive the first clock signal from the second transmission medium as a single-ended signal referenced against the common ground.

Illustrative clause 13. The transmitter of illustrative clause 12, wherein the clock conditioning block includes a second electrical termination circuit configured to receive the first clock signal from the clock input port and match a characteristic impedance of the second transmission medium from which the fourth electrical conductor of the clock input port is configured to receive the first clock signal.

Illustrative clause 14. The transmitter of illustrative clause 13, wherein the clock conditioning block further includes a buffer configured to receive the first clock signal from the second electrical termination circuit and adjust one or more signal characteristics of the first clock signal.

Illustrative clause 15. The transmitter of illustrative clause 14, wherein the clock conditioning block further includes a frequency divider configured to receive the first clock signal from the buffer and divide the first clock frequency of the first clock signal by a first predetermined integer value.

Illustrative clause 16. The transmitter of illustrative clause 15, wherein the clock conditioning block further includes one or more frequency multipliers, each of the one or more frequency multipliers being configured to receive the first clock signal from the frequency divider and multiply the first clock frequency of the first clock signal by a second predetermined integer value to generate the second clock signal.

Illustrative clause 17. The transmitter of illustrative clause 1, wherein the one or more intermediate signals are one or more first intermediate signals and the modulation block includes one or more frequency mixers and a combiner, each of the one or more frequency mixers being configured to receive a particular first intermediate signal of the one or more first intermediate signals from the signal conditioning block and a particular second clock signal of the one or more second clock signals from the clock conditioning block and modulate the particular first intermediate signal onto the particular second clock signal to generate one or more second intermediate signals, the combiner being configured to receive the one or more second intermediate signals from the one or more frequency mixers and combine the one or more second intermediate signals to generate the one or more antenna feed signals.

Illustrative clause 18. The transmitter of illustrative clause 16, wherein at least one of the one or more frequency multipliers is a multi-stage frequency multiplier configured to receive the first clock signal from the frequency divider and multiply the first clock frequency of the first clock signal by the second predetermined integer value at least two times to generate a third clock signal having a third clock frequency.

Illustrative clause 19. The transmitter of illustrative clause 18, wherein the one or more intermediate signals are one or more first intermediate signals and the modulation block includes one or more first frequency mixers, a combiner, and a second frequency mixer, each of the one or more first frequency mixers being configured to receive a particular first intermediate signal of the one or more first intermediate signals from the signal conditioning block and the second clock signal from the clock conditioning block and modulate the particular first intermediate signal onto the second clock signal to generate one or more second intermediate signals, the combiner being configured to receive the one or more second intermediate signals from the one or more first frequency mixers and combine the one or more second intermediate signals to generate one or more third intermediate signals, the second frequency mixer being configured to receive the one or more third intermediate signals from the combiner and the third clock signal from the clock conditioning block and modulate the one or more third intermediate signals onto the third clock signal to generate the one or more antenna feed signals.

Illustrative clause 20. The transmitter of illustrative clause 15, wherein the clock conditioning block further includes a multi-stage frequency multiplier configured to receive the first clock signal from the frequency divider and multiply the first clock frequency of the first clock signal by a second predetermined integer value at least two times to generate the second clock signal.

Illustrative clause 21. The transmitter of illustrative clause 20, wherein the clock conditioning block further includes a clock amplifier configured to receive the second clock signal from the multi-stage frequency multiplier and amplify the second clock signal to generate a third clock signal having a third clock frequency.

Illustrative clause 22. The transmitter of illustrative clause 21, wherein the one or more intermediate signals are one or more first intermediate signals and the modulation block includes one or more first frequency mixers, a combiner, and one or more second frequency mixers, each of the one or more first frequency mixers being configured to receive a particular first intermediate signal of the one or more first intermediate signals from the signal conditioning block and the second clock signal from the clock conditioning block and modulate the particular first intermediate signal onto the second clock signal to generate one or more second intermediate signals, the combiner being configured to receive the one or more second intermediate signals from the one or more first frequency mixers and combine the one or more second intermediate signals to generate one or more third intermediate signals, each of the one or more second frequency mixers being configured to receive a particular third intermediate signal of the one or more third intermediate signals from the combiner and the third clock signal from the clock conditioning block and modulate the particular third intermediate signal onto the third clock signal to generate the one or more antenna feed signals.

Illustrative clause 23. The transmitter of illustrative clause 1, further comprising a matching network configured to receive the one or more antenna feed signals from the modulation block and match a characteristic impedance of the one or more hollow waveguides into which the one or more antennas are configured to couple the one or more radiated signals.

Illustrative clause 24. The transmitter of illustrative clause 1, wherein each of the one or more baseband signals, the one or more intermediate signals, the first clock signal, the second clock signal, and the one or more antenna feed signals are differential signals having an in-phase (I) component and a quadrature (Q) component.

Illustrative clause 25. A receiver, comprising: one or more antennas configured to detect one or more radiated signals received from one or more hollow waveguides and generate one or more antenna output signals based on the one or more radiated signals, each of the one or more radiated signals being radiated electromagnetic waves configured for coherent detection and having client data encoded therein and a transmission frequency in a range between 300 Gigahertz (GHz) and 10 Terahertz (THz); a clock conditioning block configured to receive a first clock signal and adjust one or more signal characteristics of the first clock signal to generate a second clock signal based on the first clock signal, the first clock signal having a first clock frequency, the second clock signal having a second clock frequency that is a harmonic frequency corresponding to the first clock frequency; a demodulation block configured to receive the one or more antenna output signals from the one or more antennas and the second clock signal from the clock conditioning block and modulate the one or more antenna output signals onto the second clock signal to generate one or more intermediate signals; a signal conditioning block configured to receive the one or more intermediate signals from the demodulation block and adjust one or more signal characteristics of the one or more intermediate signals to generate one or more baseband signals based on the one or more intermediate signals; and a client-side output configured to receive the one or more baseband signals from the signal conditioning block and transmit the one or more baseband signals.

Illustrative clause 26. The receiver of illustrative clause 25, wherein the one or more antennas are configured to detect the one or more radiated signals received from one or more hollow waveguides having the client data encoded therein using a modulation protocol conforming to a specification of one of intensity modulation (IM)/direct detection (DD) (IM/DD), return-to-zero (RZ) code, non-return-to-zero (NRZ) code, pulse-amplitude modulation (PAM), IM-PAM, quadrature-amplitude modulation (QAM), and single-sideband (SSB) modulation.

Illustrative clause 27. The receiver of illustrative clause 25, further comprising a clock source configured to generate the first clock signal, the clock conditioning block being configured to receive the first clock signal from the clock source.

Illustrative clause 28. The receiver of illustrative clause 25, wherein the client-side output includes one or more signal output ports, each of the one or more signal output ports including a first electrical conductor electrically coupled to a common ground and a second electrical conductor configured to be electrically coupled to a particular first transmission medium of one or more first transmission mediums, the client-side output being configured to transmit the one or more baseband signals into the one or more first transmission mediums as one or more single-ended signals referenced against the common ground.

Illustrative clause 29. The receiver of illustrative clause 28, wherein the demodulation block includes a splitter and a plurality of frequency mixers, the splitter being configured to receive the one or more antenna output signals from the one or more antennas and split the one or more antenna output signals into a plurality of antenna output signals, each of the plurality of frequency mixers being configured to receive a particular antenna output signal of the plurality of antenna output signals from the splitter and the second clock signal from the clock conditioning block and modulate the particular antenna output signal onto the second clock signal to generate a plurality of intermediate signals.

Illustrative clause 30. The receiver of illustrative clause 29, wherein the signal conditioning block includes a plurality of equalizers, each of the plurality of equalizers being configured to receive a particular intermediate signal of the plurality of intermediate signals from the demodulation block and equalize the particular intermediate signal.

Illustrative clause 31. The receiver of illustrative clause 30, wherein each of the plurality of equalizers is a continuous time linear equalizer.

Illustrative clause 32. The receiver of illustrative clause 31, wherein the plurality of intermediate signals are a plurality of first intermediate signals and the signal conditioning block further includes a plurality of signal amplifiers, each of the plurality of signal amplifiers being configured to receive a particular first intermediate signal of the plurality of first intermediate signals from a particular equalizer of the plurality of equalizers and amplify the particular first intermediate signal to generate a plurality of second intermediate signals.

Illustrative clause 33. The receiver of illustrative clause 32, wherein each of the one or more signal amplifiers is a variable gain amplifier.

Illustrative clause 34. The receiver of illustrative clause 32, wherein the signal conditioning block further includes a combiner configured to receive the plurality of second intermediate signals from the plurality of signal amplifiers and combine the plurality of second intermediate signals to generate the one or more baseband signals.

Illustrative clause 35. The receiver of illustrative clause 34, wherein the signal conditioning block further comprises one or more drivers, each of the one or more drivers being configured to receive a particular baseband signal of the one or more baseband signals from the combiner and drive the particular baseband signal.

Illustrative clause 36. The receiver of illustrative clause 35, wherein each of the one or more drivers is a driver with termination configured to receive the particular baseband signal of the one or more baseband signals from the combiner, drive the particular baseband signal, and match a characteristic impedance of the particular first transmission medium to which the second electrical conductor of a particular signal output port of the one or more signal output ports is configured to be electrically coupled, the particular signal output port being configured to receive the particular baseband signal.

Illustrative clause 37. The receiver of illustrative clause 25, further comprising a matching network configured to receive the one or more antenna output signals from the one or more antennas and match a characteristic impedance of the one or more hollow waveguides from which the one or more antennas are configured to receive the one or more radiated signals.

Illustrative clause 38. The receiver of illustrative clause 25, wherein the demodulation block includes one or more frequency mixers, each of the one or more frequency mixers being configured to receive a particular antenna output signal of the one or more antenna output signals from the one or more antennas and the second clock signal from the clock conditioning block and modulate the particular antenna output signal onto the second clock signal to generate the one or more intermediate signals.

Illustrative clause 39. The receiver of illustrative clause 25, wherein the signal conditioning block includes one or more signal amplifiers, each of the one or more signal amplifiers being configured to receive a particular intermediate signal of the one or more intermediate signals and amplify the particular intermediate signal.

Illustrative clause 40. The receiver of illustrative clause 39, wherein each of the one or more signal amplifiers is a trans-impedance amplifier.

Illustrative clause 41. The receiver of illustrative clause 39, wherein the signal conditioning block further includes one or more buffers, each of the one or more buffers being configured to receive a particular intermediate signal of the one or more intermediate signals from a particular signal amplifier of the one or more signal amplifiers and adjust one or more signal characteristics of the particular intermediate signal to generate the one or more baseband signals.

Illustrative clause 42. The receiver of illustrative clause 25, further comprising a clock input configured to receive the first clock signal, the clock conditioning block being configured to receive the first clock signal from the clock input.

Illustrative clause 43. The receiver of illustrative clause 42, wherein the clock input includes a clock input port including a third electrical conductor electrically coupled to a common ground and a fourth electrical conductor configured to be electrically coupled to a second transmission medium, the clock input being configured to receive the first clock signal from the second transmission medium as a single-ended signal referenced against the common ground.

Illustrative clause 44. The receiver of illustrative clause 43, wherein the clock conditioning block includes a second electrical termination circuit configured to receive the first clock signal from the clock input port and match a characteristic impedance of the second transmission medium from which the fourth electrical conductor of the clock input port is configured to receive the first clock signal.

Illustrative clause 45. The receiver of illustrative clause 44, wherein the clock conditioning block further includes a buffer configured to receive the first clock signal from the second electrical termination circuit and adjust one or more signal characteristics of the first clock signal.

Illustrative clause 46. The receiver of illustrative clause 45, wherein the clock conditioning block further includes a frequency divider configured to receive the first clock signal from the buffer and divide the first clock frequency of the first clock signal by a first predetermined integer value.

Illustrative clause 47. The receiver of illustrative clause 46, wherein the clock conditioning block further includes one or more frequency multipliers, each of the one or more frequency multipliers being configured to receive the first clock signal from the frequency divider and multiply the first clock frequency of the first clock signal by a second predetermined integer value to generate the second clock signal.

Illustrative clause 48. The receiver of illustrative clause 47, wherein at least one of the one or more frequency multipliers is a multi-stage frequency multiplier configured to receive the first clock signal from the frequency divider and multiply the first clock frequency of the first clock signal by the second predetermined integer value at least two times to generate a third clock signal.

Illustrative clause 49. The receiver of illustrative clause 48, wherein the one or more intermediate signals are one or more first intermediate signals and the demodulation block includes a first frequency mixer and one or more second frequency mixers, the first frequency mixer being configured to receive a particular antenna output signal of the one or more antenna output signals from the one or more antennas and the third clock signal from the clock conditioning block and modulate the particular antenna output signal onto the third clock signal to generate the one or more first intermediate signals, each of the one or more second frequency mixers being configured to receive a particular first intermediate signal of the one or more first intermediate signals from the first frequency mixer and the second clock signal from the clock conditioning block and modulate the particular first intermediate signal onto the second clock signal to generate one or more second intermediate signals.

Illustrative clause 50. The receiver of illustrative clause 46, wherein the clock conditioning block further includes a multi-stage frequency multiplier configured to receive the first clock signal from the frequency divider and multiply the first clock frequency of the first clock signal by a second predetermined integer value at least two times to generate the second clock signal.

Illustrative clause 51. The receiver of illustrative clause 50, wherein the clock conditioning block further includes a clock amplifier configured to receive the second clock signal from the multi-stage frequency multiplier and amplify the second clock signal to generate a third clock signal.

Illustrative clause 52. The receiver of illustrative clause 51, wherein the one or more intermediate signals are one or more first intermediate signals and the demodulation block includes a first frequency mixer and one or more second frequency mixers, the first frequency mixer being configured to receive a particular antenna output signal of the one or more antenna output signals from the one or more antennas and the third clock signal from the clock conditioning block and modulate the particular antenna output signal onto the third clock signal to generate the one or more first intermediate signals, each of the one or more second frequency mixers being configured to receive a particular first intermediate signal of the one or more first intermediate signals from the first frequency mixer and the second clock signal from the clock conditioning block and modulate the particular first intermediate signal onto the second clock signal to generate one or more second intermediate signals.

Illustrative clause 53. The receiver of illustrative clause 25, wherein each of the one or more baseband signals, the one or more intermediate signals, the first clock signal, the second clock signal, and the one or more antenna output signals are differential signals having an in-phase (I) component and a quadrature (Q) component.

Illustrative clause 54. A transceiver, comprising: a transmitter, comprising: a client-side input configured to receive one or more outbound baseband signals having outbound client data encoded therein; an outbound signal conditioning block configured to receive the one or more outbound baseband signals from the client-side input and adjust one or more signal characteristics of the one or more outbound baseband signals to generate one or more outbound intermediate signals based on the one or more outbound baseband signals; a clock conditioning block configured to receive a first clock signal and adjust one or more signal characteristics of the first clock signal to generate a second clock signal based on the first clock signal, the first clock signal having a first clock frequency, the second clock signal having a second clock frequency that is a harmonic frequency corresponding to the first clock frequency; a modulation block configured to receive the one or more outbound intermediate signals from the outbound signal conditioning block and the second clock signal from the clock conditioning block and modulate the one or more outbound intermediate signals onto the second clock signal to generate one or more antenna feed signals; and one or more outbound antennas configured to receive the one or more antenna feed signals from the modulation block, generate one or more outbound radiated signals based on the one or more antenna feed signals, and couple the one or more outbound radiated signals into one or more first hollow waveguides, each of the one or more outbound radiated signals being radiated electromagnetic waves configured for coherent detection and having an outbound transmission frequency in a range between 300 Gigahertz (GHz) and 10 Terahertz (THz); and a receiver, comprising: one or more inbound antennas configured to detect one or more inbound radiated signals received from one of the one or more first hollow waveguides and one or more second hollow waveguides and generate one or more antenna output signals based on the one or more inbound radiated signals, each of the one or more radiated signals being radiated electromagnetic waves configured for coherent detection and having inbound client data encoded therein and an inbound transmission frequency in the range between 300 GHz and 10 THz; a demodulation block configured to receive the one or more antenna output signals from the one or more inbound antennas and the second clock signal from the clock conditioning block and modulate the one or more antenna output signals onto the second clock signal to generate one or more inbound intermediate signals; an inbound signal conditioning block configured to receive the one or more inbound intermediate signals from the demodulation block and adjust one or more signal characteristics of the one or more inbound intermediate signals to generate one or more inbound baseband signals based on the one or more inbound intermediate signals; and a client-side output configured to receive the one or more inbound baseband signals from the signal conditioning block and transmit the one or more inbound baseband signals.

Illustrative clause 55. The transceiver of illustrative clause 54, wherein the client-side input is configured to receive the one or more outbound baseband signals having the outbound client data encoded therein and the one or more inbound antennas are configured to detect the one or more inbound radiated signals received from one of the one or more first hollow waveguides and the one or more second hollow waveguides having the inbound client data encoded therein using a modulation protocol conforming to a specification of one of intensity modulation (IM)/direct detection (DD) (IM/DD), return-to-zero (RZ) code, non-return-to-zero (NRZ) code, pulse-amplitude modulation (PAM), IM-PAM, quadrature-amplitude modulation (QAM), and single-sideband (SSB) modulation.

Illustrative clause 56. The transceiver of illustrative clause 54, further comprising a clock source configured to generate the first clock signal, the clock conditioning block being configured to receive the first clock signal from the clock source.

Illustrative clause 57. The transceiver of illustrative clause 54, wherein the client-side input includes one or more signal input ports, each of the one or more signal input ports including a first outbound electrical conductor electrically coupled to a common ground and a second outbound electrical conductor configured to be electrically coupled to a particular first outbound transmission medium of one or more first outbound transmission mediums, the client-side input being configured to receive the one or more outbound baseband signals from the one or more first outbound transmission mediums as one or more single-ended signals referenced against the common ground.

Illustrative clause 58. The transceiver of illustrative clause 57, wherein the outbound signal conditioning block includes one or more first outbound electrical termination circuits, each of the one or more first outbound electrical termination circuits being configured to receive a particular outbound baseband signal of the one or more outbound baseband signals from a particular signal input port of the one or more signal input ports and match a characteristic impedance of the particular first outbound transmission medium to which the second outbound electrical conductor of the particular signal input port is configured to be electrically coupled.

Illustrative clause 59. The transceiver of illustrative clause 58, wherein the outbound signal conditioning block further includes one or more re-timer circuits, each of the one or more re-timer circuits being configured to receive a particular outbound baseband signal of the one or more outbound baseband signals from a particular first outbound electrical termination circuit of the one or more first outbound electrical termination circuits and re-time the particular outbound baseband signal.

Illustrative clause 60. The transceiver of illustrative clause 59, wherein each of the one or more re-timer circuits includes a re-timer portion and a bypass portion, the re-timer portion of each of the one or more re-timer circuits being configured to receive a particular outbound baseband signal of the one or more outbound baseband signals from a particular first outbound electrical termination circuit of the one or more first outbound electrical termination circuits and selectively re-time the particular outbound baseband signal, the bypass portion of each of the one or more re-timer circuits being configured to receive a particular outbound baseband signal of the one or more outbound baseband signals from a particular first outbound electrical termination circuit of the one or more first outbound electrical termination circuits and selectively bypass the re-timer portion.

Illustrative clause 61. The transceiver of illustrative clause 59, wherein the outbound signal conditioning block further includes one or more pulse-shaping circuits, each of the one or more pulse-shaping circuits being configured to receive a particular outbound baseband signal of the one or more outbound baseband signals from a particular re-timer circuit of the one or more re-timer circuits and adjust one or more signal characteristics of the one or more outbound baseband signals to generate the one or more outbound intermediate signals based on the one or more outbound baseband signals.

Illustrative clause 62. The transceiver of illustrative clause 61, wherein the outbound signal conditioning block further includes one or more outbound splitters, each of the one or more outbound splitters being configured to receive a particular outbound intermediate signal of the one or more outbound intermediate signals from a particular pulse-shaping circuit of the one or more pulse-shaping circuits and split the particular outbound intermediate signal into a plurality of outbound intermediate signals.

Illustrative clause 63. The transceiver of illustrative clause 62, wherein the plurality of outbound intermediate signals are a plurality of first outbound intermediate signals and the modulation block includes a plurality of outbound frequency mixers and an outbound combiner, each of the plurality of outbound frequency mixers being configured to receive a particular outbound intermediate signal of the plurality of outbound intermediate signals from the outbound signal conditioning block and the second clock signal from the clock conditioning block and modulate the particular outbound intermediate signal onto the second clock signal to generate a plurality of second outbound intermediate signals, the outbound combiner being configured to receive the plurality of second outbound intermediate signals from the one or more outbound frequency mixers and combine the plurality of second outbound intermediate signals to generate the one or more antenna feed signals.

Illustrative clause 64. The transceiver of illustrative clause 54, further comprising a clock input configured to receive the first clock signal, the clock conditioning block being configured to receive the first clock signal from the clock input.

Illustrative clause 65. The transceiver of illustrative clause 64, wherein the clock input includes a clock input port including a first clock electrical conductor electrically coupled to a common ground and a second clock electrical conductor configured to be electrically coupled to a second transmission medium, the clock input being configured to receive the first clock signal from the second transmission medium as a single-ended signal referenced against the common ground.

Illustrative clause 66. The transceiver of illustrative clause 65, wherein the clock conditioning block includes a second clock electrical termination circuit configured to receive the first clock signal from the clock input port and match a characteristic impedance of the second transmission medium from which the second clock electrical conductor of the clock input port is configured to receive the first clock signal.

Illustrative clause 67. The transceiver of illustrative clause 66, wherein the clock conditioning block further includes a clock buffer configured to receive the first clock signal from the second clock electrical termination circuit and adjust one or more signal characteristics of the first clock signal.

Illustrative clause 68. The transceiver of illustrative clause 67, wherein the clock conditioning block further includes a frequency divider configured to receive the first clock signal from the clock buffer and divide the first clock frequency of the first clock signal by a first predetermined integer value.

Illustrative clause 69. The transceiver of illustrative clause 68, wherein the clock conditioning block further includes one or more frequency multipliers, each of the one or more frequency multipliers being configured to receive the first clock signal from the frequency divider and multiply the first clock frequency of the first clock signal by a second predetermined integer value to generate the second clock signal.

Illustrative clause 70. The transceiver of illustrative clause 54, wherein the one or more outbound intermediate signals are one or more first outbound intermediate signals and the modulation block includes one or more outbound frequency mixers and an outbound combiner, each of the one or more outbound frequency mixers being configured to receive a particular first outbound intermediate signal of the one or more first outbound intermediate signals from the outbound signal conditioning block and a particular second clock signal of the one or more second clock signals from the clock conditioning block and modulate the particular first outbound intermediate signal onto the particular second clock signal to generate one or more second outbound intermediate signals, the outbound combiner being configured to receive the one or more second outbound intermediate signals from the one or mor outbound e frequency mixers and combine the one or more second outbound intermediate signals to generate the one or more antenna feed signals.

Illustrative clause 71. The transceiver of illustrative clause 69, wherein at least one of the one or more frequency multipliers is a multi-stage frequency multiplier configured to receive the first clock signal from the frequency divider and multiply the first clock frequency of the first clock signal by the second predetermined integer value at least two times to generate a third clock signal having a third clock frequency.

Illustrative clause 72. The transceiver of illustrative clause 71, wherein the one or more outbound intermediate signals are one or more first outbound intermediate signals and the modulation block includes one or more first outbound frequency mixers, an outbound combiner, and a second outbound frequency mixer, each of the one or more first outbound frequency mixers being configured to receive a particular first outbound intermediate signal of the one or more first outbound intermediate signals from the outbound signal conditioning block and the second clock signal from the clock conditioning block and modulate the particular first outbound intermediate signal onto the second clock signal to generate one or more second outbound intermediate signals, the outbound combiner being configured to receive the one or more second outbound intermediate signals from the one or more first outbound frequency mixers and combine the one or more second outbound intermediate signals to generate one or more third outbound intermediate signals, the second outbound frequency mixer being configured to receive the one or more third outbound intermediate signals from the outbound combiner and the third clock signal from the clock conditioning block and modulate the one or more third outbound intermediate signals onto the third clock signal to generate the one or more antenna feed signals.

Illustrative clause 73. The transceiver of illustrative clause 68, wherein the clock conditioning block further includes a multi-stage frequency multiplier configured to receive the first clock signal from the frequency divider and multiply the first clock frequency of the first clock signal by a second predetermined integer value at least two times to generate the second clock signal.

Illustrative clause 74. The transceiver of illustrative clause 73, wherein the clock conditioning block further includes a clock amplifier configured to receive the second clock signal from the multi-stage frequency multiplier and amplify the second clock signal to generate a third clock signal having a third clock frequency.

Illustrative clause 75. The transceiver of illustrative clause 74, wherein the one or more outbound intermediate signals are one or more first outbound intermediate signals and the modulation block includes one or more first outbound frequency mixers, an outbound combiner, and one or more second outbound frequency mixers, each of the one or more first outbound frequency mixers being configured to receive a particular first outbound intermediate signal of the one or more first outbound intermediate signals from the outbound signal conditioning block and the second clock signal from the clock conditioning block and modulate the particular first outbound intermediate signal onto the second clock signal to generate one or more second outbound intermediate signals, the outbound combiner being configured to receive the one or more second outbound intermediate signals from the one or more first outbound frequency mixers and combine the one or more second outbound intermediate signals to generate one or more third outbound intermediate signals, each of the one or more second outbound frequency mixers being configured to receive a particular third outbound intermediate signal of the one or more third outbound intermediate signals from the outbound combiner and the third clock signal from the clock conditioning block and modulate the particular third outbound intermediate signal onto the third clock signal to generate the one or more antenna feed signals.

Illustrative clause 76. The transceiver of illustrative clause 54, further comprising an outbound matching network configured to receive the one or more antenna feed signals from the modulation block and match a characteristic impedance of the one or more first hollow waveguides into which the one or more outbound antennas are configured to couple the one or more outbound radiated signals.

Illustrative clause 77. The transceiver of illustrative clause 54, wherein each of the one or more outbound baseband signals, the one or more inbound baseband signals, the one or more outbound intermediate signals, the one or more inbound intermediate signals, the first clock signal, the second clock signal, the one or more antenna feed signals, and the one or more antenna output signals are differential signals having an in-phase (I) component and a quadrature (Q) component.

Illustrative clause 78. The transceiver of illustrative clause 54, wherein the client-side output includes one or more signal output ports, each of the one or more signal output ports including a first inbound electrical conductor electrically coupled to a common ground and a second inbound electrical conductor configured to be electrically coupled to a particular first inbound transmission medium of one or more first inbound transmission mediums, the client-side output being configured to transmit the one or more inbound baseband signals into the one or more first inbound transmission mediums as one or more single-ended signals referenced against the common ground.

Illustrative clause 79. The transceiver of illustrative clause 78, wherein the demodulation block includes an inbound splitter and a plurality of inbound frequency mixers, the inbound splitter being configured to receive the one or more antenna output signals from the one or more inbound antennas and split the one or more antenna output signals into a plurality of antenna output signals, each of the plurality of inbound frequency mixers being configured to receive a particular antenna output signal of the plurality of antenna output signals from the inbound splitter and the second clock signal from the clock conditioning block and modulate the particular antenna output signal onto the second clock signal to generate a plurality of inbound intermediate signals.

Illustrative clause 80. The transceiver of illustrative clause 79, wherein the inbound signal conditioning block includes a plurality of equalizers, each of the plurality of equalizers being configured to receive a particular inbound intermediate signal of the plurality of inbound intermediate signals from the demodulation block and equalize the particular inbound intermediate signal.

Illustrative clause 81. The transceiver of illustrative clause 80, wherein each of the plurality of equalizers is a continuous time linear equalizer.

Illustrative clause 82. The transceiver of illustrative clause 81, wherein the plurality of inbound intermediate signals are a plurality of first inbound intermediate signals and the inbound signal conditioning block further includes a plurality of inbound signal amplifiers, each of the plurality of inbound signal amplifiers being configured to receive a particular first inbound intermediate signal of the plurality of first inbound intermediate signals from a particular equalizer of the plurality of equalizers and amplify the particular first inbound intermediate signal to generate a plurality of second inbound intermediate signals.

Illustrative clause 83. The transceiver of illustrative clause 82, wherein each of the one or more inbound signal amplifiers is a variable gain amplifier.

Illustrative clause 84. The transceiver of illustrative clause 82, wherein the inbound signal conditioning block further includes an inbound combiner configured to receive the plurality of second inbound intermediate signals from the plurality of inbound signal amplifiers and combine the plurality of second inbound intermediate signals to generate the one or more inbound baseband signals.

Illustrative clause 85. The transceiver of illustrative clause 84, wherein the inbound signal conditioning block further comprises one or more drivers, each of the one or more drivers being configured to receive a particular inbound baseband signal of the one or more inbound baseband signals from the inbound combiner and drive the particular inbound baseband signal.

Illustrative clause 86. The transceiver of illustrative clause 85, wherein each of the one or more drivers is a driver with termination configured to receive the particular inbound baseband signal of the one or more inbound baseband signals from the inbound combiner, drive the particular inbound baseband signal, and match a characteristic impedance of the particular first inbound transmission medium to which the second inbound electrical conductor of a particular signal output port of the one or more signal output ports is configured to be electrically coupled, the particular signal output port being configured to receive the particular inbound baseband signal.

Illustrative clause 87. The transceiver of illustrative clause 54, further comprising an inbound matching network configured to receive the one or more antenna output signals from the one or more inbound antennas and match a characteristic impedance of the one of the one or more first hollow waveguides and the one or more second hollow waveguides from which the one or more inbound antennas are configured to receive the one or more inbound radiated signals.

Illustrative clause 88. The transceiver of illustrative clause 54, wherein the demodulation block includes one or more inbound frequency mixers, each of the one or more inbound frequency mixers being configured to receive a particular antenna output signal of the one or more antenna output signals from the one or more inbound antennas and the second clock signal from the clock conditioning block and modulate the particular antenna output signal onto the second clock signal to generate the one or more inbound intermediate signals.

Illustrative clause 89. The transceiver of illustrative clause 54, wherein the inbound signal conditioning block includes one or more inbound signal amplifiers, each of the one or more inbound signal amplifiers being configured to receive a particular inbound intermediate signal of the one or more inbound intermediate signals and amplify the particular inbound intermediate signal.

Illustrative clause 90. The transceiver of illustrative clause 89, wherein each of the one or more inbound signal amplifiers is a trans-impedance amplifier.

Illustrative clause 91. The transceiver of illustrative clause 89, wherein the inbound signal conditioning block further includes one or more inbound buffers, each of the one or more inbound buffers being configured to receive a particular inbound intermediate signal of the one or more inbound intermediate signals from a particular inbound signal amplifier of the one or more inbound signal amplifiers and adjust one or more signal characteristics of the particular inbound intermediate signal to generate the one or more inbound baseband signals.

Illustrative clause 92. The transceiver of illustrative clause 71, wherein the one or more inbound intermediate signals are one or more first inbound intermediate signals and the demodulation block includes a first inbound frequency mixer and one or more second inbound frequency mixers, the first inbound frequency mixer being configured to receive a particular antenna output signal of the one or more antenna output signals from the one or more inbound antennas and the third clock signal from the clock conditioning block and modulate the particular antenna output signal onto the third clock signal to generate the one or more first inbound intermediate signals, each of the one or more second inbound frequency mixers being configured to receive a particular first inbound intermediate signal of the one or more first inbound intermediate signals from the first inbound frequency mixer and the second clock signal from the clock conditioning block and modulate the particular first inbound intermediate signal onto the second clock signal to generate one or more second inbound intermediate signals.

Illustrative clause 93. The transceiver of illustrative clause 74, wherein the one or more inbound intermediate signals are one or more first inbound intermediate signals and the demodulation block includes a first inbound frequency mixer and one or more second inbound frequency mixers, the first inbound frequency mixer being configured to receive a particular antenna output signal of the one or more antenna output signals from the one or more inbound antennas and the third clock signal from the clock conditioning block and modulate the particular antenna output signal onto the third clock signal to generate the one or more first inbound intermediate signals, each of the one or more second inbound frequency mixers being configured to receive a particular first inbound intermediate signal of the one or more first inbound intermediate signals from the first inbound frequency mixer and the second clock signal from the clock conditioning block and modulate the particular first inbound intermediate signal onto the second clock signal to generate one or more second inbound intermediate signals.

Illustrative clause 94. A method, comprising: providing one or more baseband signals to a transmitter in a transport network, at least one of the one or more baseband signal having client data encoded therein, the transport network comprising one or more hollow waveguides, the transmitter coupled to the one or more hollow waveguides, and a receiver coupled to the one or more hollow waveguides; generating, by the transmitter, one or more radiated signals based on the one or more baseband signals, at least one of the one or more radiated signals being a radiated electromagnetic wave having a transmission frequency in a range between 300 Gigahertz (GHz) and 10 Terahertz (THz); coupling, by the transmitter, the one or more radiated signals into the one or more hollow waveguides; receiving, by the receiver, the one or more radiated signals from the one or more hollow waveguides; measuring, by the receiver, one or more signal quality parameters of the one or more radiated signals, wherein the one or more signal quality parameters include one or more of signal distortion, bit error rate (BER), spurious free dynamic range (SFDR), signal-to-noise ratio (SNR), signal dynamic range, and jitter; generating, by the receiver, one or more actuation controls based on the one or more signal quality parameters, each of the one or more actuation controls being configured to adjust a particular one of one or more transmitter operating parameters of the transmitter, wherein the one or more transmitter operating parameters include one or more of gain, bandwidth, equalization, linearity, and jitter; sending, by the receiver, an actuation control signal, the actuation control signal having the one or more actuation controls encoded therein; receiving, by the transmitter, the actuation control signal; and adjusting, by the transmitter, at least one of the one or more transmitter operating parameters of the transmitter based on the one or more actuation controls.

Illustrative clause 95. The method of illustrative clause 94, wherein the step of generating the one or more radiated signals based on the one or more baseband signals includes mixing, by the transmitter, each of the one or more baseband signals with a particular local oscillator signal of one or more local oscillator signals to generate the one or more radiated signals, each particular local oscillator signal of the one or more local oscillator signals having a particular local oscillator frequency of a plurality of local oscillator frequencies, wherein at least one of the plurality of local oscillator frequencies is the transmission frequency.

Illustrative clause 96. The method of illustrative clause 94, wherein the step of adjusting at least one of the one or more transmitter operating parameters of the transmitter based on the one or more actuation controls is further defined as adjusting, by a processor of the transmitter, at least one of the one or more transmitter operating parameters of the transmitter based on the one or more actuation controls.

### CONCLUSION

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred embodiment. Further, the phrase “based on” is intended to mean “based, at least in part, on” unless explicitly stated otherwise.

What is claimed is:

1. A transmitter, comprising:
a client-side input configured to receive one or more baseband signals having client data encoded therein;
a signal conditioning block configured to receive the one or more baseband signals from the client-side input and adjust one or more signal characteristics of the one or more baseband signals to generate one or more intermediate signals based on the one or more baseband signals;
a clock conditioning block configured to receive a first clock signal and adjust one or more signal characteristics of the first clock signal to generate a second clock signal based on the first clock signal, the first clock signal having a first clock frequency, the second clock signal having a second clock frequency that is a harmonic frequency corresponding to the first clock frequency;
a modulation block configured to receive the one or more intermediate signals from the signal conditioning block and the second clock signal from the clock conditioning block and modulate the one or more intermediate signals onto the second clock signal to generate one or more antenna feed signals; and
one or more antennas configured to receive the one or more antenna feed signals from the modulation block, generate one or more radiated signals based on the one or more antenna feed signals, and couple the one or more radiated signals into one or more hollow waveguides, each of the one or more radiated signals being radiated electromagnetic waves configured for coherent detection and having a transmission frequency in a range between 300 Gigahertz (GHz) and 10 Terahertz (THz).

2. The transmitter of claim 1, wherein the client-side input is configured to receive the one or more baseband signals having the client data encoded therein using a modulation protocol conforming to a specification of one of intensity modulation (IM)/direct detection (DD) (IM/DD), return-to-zero (RZ) code, non-return-to-zero (NRZ) code, pulse-amplitude modulation (PAM), IM-PAM, quadrature-amplitude modulation (QAM), and single-sideband (SSB) modulation.

3. The transmitter of claim 1, further comprising a clock source configured to generate the first clock signal, the clock conditioning block being configured to receive the first clock signal from the clock source.

4. The transmitter of claim 1, wherein the client-side input includes one or more signal input ports, each of the one or more signal input ports including a first electrical conductor electrically coupled to a common ground and a second electrical conductor configured to be electrically coupled to a particular first transmission medium of one or more first transmission mediums, the client-side input being configured to receive the one or more baseband signals from the one or more first transmission mediums as one or more single-ended signals referenced against the common ground.

5. The transmitter of claim 4, wherein the signal conditioning block includes one or more first electrical termination circuits, each of the one or more first electrical termination circuits being configured to receive a particular baseband signal of the one or more baseband signals from a particular signal input port of the one or more signal input ports and match a characteristic impedance of the particular first transmission medium to which the second electrical conductor of the particular signal input port is configured to be electrically coupled.

6. The transmitter of claim 5, wherein the signal conditioning block further includes one or more re-timer circuits, each of the one or more re-timer circuits being configured to receive a particular baseband signal of the one or more baseband signals from a particular first electrical termination circuit of the one or more first electrical termination circuits and re-time the particular baseband signal.

7. The transmitter of claim 6, wherein each of the one or more re-timer circuits includes a re-timer portion and a bypass portion, the re-timer portion of each of the one or more re-timer circuits being configured to receive a particular baseband signal of the one or more baseband signals from a particular first electrical termination circuit of the one or more first electrical termination circuits and selectively re-time the particular baseband signal, the bypass portion of each of the one or more re-timer circuits being configured to receive a particular baseband signal of the one or more baseband signals from a particular first electrical termination circuit of the one or more first electrical termination circuits and selectively bypass the re-timer portion.

8. The transmitter of claim 6, wherein the signal conditioning block further includes one or more pulse-shaping circuits, each of the one or more pulse-shaping circuits being configured to receive a particular baseband signal of the one or more baseband signals from a particular re-timer circuit of the one or more re-timer circuits and adjust one or more signal characteristics of the one or more baseband signals to generate the one or more intermediate signals based on the one or more baseband signals.

9. The transmitter of claim 8, wherein the signal conditioning block further includes one or more splitters, each of the one or more splitters being configured to receive a particular intermediate signal of the one or more intermediate signals from a particular pulse-shaping circuit of the one or more pulse-shaping circuits and split the particular intermediate signal into a plurality of intermediate signals.

10. The transmitter of claim 9, wherein the plurality of intermediate signals are a plurality of first intermediate signals and the modulation block includes a plurality of frequency mixers and a combiner, each of the plurality of frequency mixers being configured to receive a particular intermediate signal of the plurality of intermediate signals from the signal conditioning block and the second clock signal from the clock conditioning block and modulate the particular intermediate signal onto the second clock signal to generate a plurality of second intermediate signals, the combiner being configured to receive the plurality of second intermediate signals from the one or more frequency mixers and combine the plurality of second intermediate signals to generate the one or more antenna feed signals.

11. The transmitter of claim 1, further comprising a clock input configured to receive the first clock signal, the clock conditioning block being configured to receive the first clock signal from the clock input.

12. The transmitter of claim 11, wherein the clock input includes a clock input port including a third electrical conductor electrically coupled to a common ground and a fourth electrical conductor configured to be electrically coupled to a second transmission medium, the clock input being configured to receive the first clock signal from the second transmission medium as a single-ended signal referenced against the common ground.

13. The transmitter of claim 12, wherein the clock conditioning block includes a second electrical termination circuit configured to receive the first clock signal from the clock input port and match a characteristic impedance of the second transmission medium from which the fourth electrical conductor of the clock input port is configured to receive the first clock signal.

14. The transmitter of claim 13, wherein the clock conditioning block further includes a buffer configured to receive the first clock signal from the second electrical termination circuit and adjust one or more signal characteristics of the first clock signal.

15. The transmitter of claim 14, wherein the clock conditioning block further includes a frequency divider configured to receive the first clock signal from the buffer and divide the first clock frequency of the first clock signal by a first predetermined integer value.

16. The transmitter of claim 15, wherein the clock conditioning block further includes one or more frequency multipliers, each of the one or more frequency multipliers being configured to receive the first clock signal from the frequency divider and multiply the first clock frequency of the first clock signal by a second predetermined integer value to generate the second clock signal.

17. The transmitter of claim 1, wherein the one or more intermediate signals are one or more first intermediate signals and the modulation block includes one or more frequency mixers and a combiner, each of the one or more frequency mixers being configured to receive a particular first intermediate signal of the one or more first intermediate signals from the signal conditioning block and a particular second clock signal of the one or more second clock signals from the clock conditioning block and modulate the particular first intermediate signal onto the particular second clock signal to generate one or more second intermediate signals, the combiner being configured to receive the one or more second intermediate signals from the one or more frequency mixers and combine the one or more second intermediate signals to generate the one or more antenna feed signals.

18. The transmitter of claim 16, wherein at least one of the one or more frequency multipliers is a multi-stage frequency multiplier configured to receive the first clock signal from the frequency divider and multiply the first clock frequency of the first clock signal by the second predetermined integer value at least two times to generate a third clock signal having a third clock frequency.

19. The transmitter of claim 18, wherein the one or more intermediate signals are one or more first intermediate signals and the modulation block includes one or more first frequency mixers, a combiner, and a second frequency mixer, each of the one or more first frequency mixers being configured to receive a particular first intermediate signal of the one or more first intermediate signals from the signal conditioning block and the second clock signal from the clock conditioning block and modulate the particular first intermediate signal onto the second clock signal to generate one or more second intermediate signals, the combiner being configured to receive the one or more second intermediate signals from the one or more first frequency mixers and combine the one or more second intermediate signals to generate one or more third intermediate signals, the second frequency mixer being configured to receive the one or more third intermediate signals from the combiner and the third clock signal from the clock conditioning block and modulate the one or more third intermediate signals onto the third clock signal to generate the one or more antenna feed signals.

20. The transmitter of claim 15, wherein the clock conditioning block further includes a multi-stage frequency multiplier configured to receive the first clock signal from the frequency divider and multiply the first clock frequency of the first clock signal by a second predetermined integer value at least two times to generate the second clock signal.

21. The transmitter of claim 20, wherein the clock conditioning block further includes a clock amplifier configured to receive the second clock signal from the multi-stage frequency multiplier and amplify the second clock signal to generate a third clock signal having a third clock frequency.

22. The transmitter of claim 21, wherein the one or more intermediate signals are one or more first intermediate signals and the modulation block includes one or more first frequency mixers, a combiner, and one or more second frequency mixers, each of the one or more first frequency mixers being configured to receive a particular first intermediate signal of the one or more first intermediate signals from the signal conditioning block and the second clock signal from the clock conditioning block and modulate the particular first intermediate signal onto the second clock signal to generate one or more second intermediate signals, the combiner being configured to receive the one or more second intermediate signals from the one or more first frequency mixers and combine the one or more second intermediate signals to generate one or more third intermediate signals, each of the one or more second frequency mixers being configured to receive a particular third intermediate signal of the one or more third intermediate signals from the combiner and the third clock signal from the clock conditioning block and modulate the particular third intermediate signal onto the third clock signal to generate the one or more antenna feed signals.

23. The transmitter of claim 1, further comprising a matching network configured to receive the one or more antenna feed signals from the modulation block and match a characteristic impedance of the one or more hollow waveguides into which the one or more antennas are configured to couple the one or more radiated signals.

24. The transmitter of claim 1, wherein each of the one or more baseband signals, the one or more intermediate signals, the first clock signal, the second clock signal, and the one or more antenna feed signals are differential signals having an in-phase (I) component and a quadrature (Q) component.

25. A receiver, comprising:
one or more antennas configured to detect one or more radiated signals received from one or more hollow waveguides and generate one or more antenna output signals based on the one or more radiated signals, each of the one or more radiated signals being radiated electromagnetic waves configured for coherent detection and having client data encoded therein and a transmission frequency in a range between 300 Gigahertz (GHz) and 10 Terahertz (THz);
a clock conditioning block configured to receive a first clock signal and adjust one or more signal characteristics of the first clock signal to generate a second clock signal based on the first clock signal, the first clock signal having a first clock frequency, the second clock signal having a second clock frequency that is a harmonic frequency corresponding to the first clock frequency;
a demodulation block configured to receive the one or more antenna output signals from the one or more antennas and the second clock signal from the clock conditioning block and modulate the one or more antenna output signals onto the second clock signal to generate one or more intermediate signals;
a signal conditioning block configured to receive the one or more intermediate signals from the demodulation block and adjust one or more signal characteristics of the one or more intermediate signals to generate one or more baseband signals based on the one or more intermediate signals; and
a client-side output configured to receive the one or more baseband signals from the signal conditioning block and transmit the one or more baseband signals.

26. The receiver of claim 25, wherein the one or more antennas are configured to detect the one or more radiated signals received from one or more hollow waveguides having the client data encoded therein using a modulation protocol conforming to a specification of one of intensity modulation (IM)/direct detection (DD) (IM/DD), return-to-zero (RZ) code, non-return-to-zero (NRZ) code, pulse-amplitude modulation (PAM), IM-PAM, quadrature-amplitude modulation (QAM), and single-sideband (SSB) modulation.

27. The receiver of claim 25, further comprising a clock source configured to generate the first clock signal, the clock conditioning block being configured to receive the first clock signal from the clock source.

28. The receiver of claim 25, wherein the client-side output includes one or more signal output ports, each of the one or more signal output ports including a first electrical conductor electrically coupled to a common ground and a second electrical conductor configured to be electrically coupled to a particular first transmission medium of one or more first transmission mediums, the client-side output being configured to transmit the one or more baseband signals into the one or more first transmission mediums as one or more single-ended signals referenced against the common ground.

29. The receiver of claim 28, wherein the demodulation block includes a splitter and a plurality of frequency mixers, the splitter being configured to receive the one or more antenna output signals from the one or more antennas and split the one or more antenna output signals into a plurality of antenna output signals, each of the plurality of frequency mixers being configured to receive a particular antenna output signal of the plurality of antenna output signals from the splitter and the second clock signal from the clock conditioning block and modulate the particular antenna output signal onto the second clock signal to generate a plurality of intermediate signals.

30. The receiver of claim 29, wherein the signal conditioning block includes a plurality of equalizers, each of the plurality of equalizers being configured to receive a particular intermediate signal of the plurality of intermediate signals from the demodulation block and equalize the particular intermediate signal.

31. The receiver of claim 30, wherein each of the plurality of equalizers is a continuous time linear equalizer.

32. The receiver of claim 31, wherein the plurality of intermediate signals are a plurality of first intermediate signals and the signal conditioning block further includes a plurality of signal amplifiers, each of the plurality of signal amplifiers being configured to receive a particular first intermediate signal of the plurality of first intermediate signals from a particular equalizer of the plurality of equalizers and amplify the particular first intermediate signal to generate a plurality of second intermediate signals.

33. The receiver of claim 32, wherein each of the one or more signal amplifiers is a variable gain amplifier.

34. The receiver of claim 32, wherein the signal conditioning block further includes a combiner configured to receive the plurality of second intermediate signals from the plurality of signal amplifiers and combine the plurality of second intermediate signals to generate the one or more baseband signals.

35. The receiver of claim 34, wherein the signal conditioning block further comprises one or more drivers, each of the one or more drivers being configured to receive a particular baseband signal of the one or more baseband signals from the combiner and drive the particular baseband signal.

36. The receiver of claim 35, wherein each of the one or more drivers is a driver with termination configured to receive the particular baseband signal of the one or more baseband signals from the combiner, drive the particular baseband signal, and match a characteristic impedance of the particular first transmission medium to which the second electrical conductor of a particular signal output port of the one or more signal output ports is configured to be electrically coupled, the particular signal output port being configured to receive the particular baseband signal.

37. The receiver of claim 25, further comprising a matching network configured to receive the one or more antenna output signals from the one or more antennas and match a characteristic impedance of the one or more hollow waveguides from which the one or more antennas are configured to receive the one or more radiated signals.

38. The receiver of claim 25, wherein the demodulation block includes one or more frequency mixers, each of the one or more frequency mixers being configured to receive a particular antenna output signal of the one or more antenna output signals from the one or more antennas and the second clock signal from the clock conditioning block and modulate the particular antenna output signal onto the second clock signal to generate the one or more intermediate signals.

39. The receiver of claim 25, wherein the signal conditioning block includes one or more signal amplifiers, each of the one or more signal amplifiers being configured to receive a particular intermediate signal of the one or more intermediate signals and amplify the particular intermediate signal.

40. The receiver of claim 39, wherein each of the one or more signal amplifiers is a trans-impedance amplifier.

41. The receiver of claim 39, wherein the signal conditioning block further includes one or more buffers, each of the one or more buffers being configured to receive a particular intermediate signal of the one or more intermediate signals from a particular signal amplifier of the one or more signal amplifiers and adjust one or more signal characteristics of the particular intermediate signal to generate the one or more baseband signals.

42. The receiver of claim 25, further comprising a clock input configured to receive the first clock signal, the clock conditioning block being configured to receive the first clock signal from the clock input.

43. The receiver of claim 42, wherein the clock input includes a clock input port including a third electrical conductor electrically coupled to a common ground and a fourth electrical conductor configured to be electrically coupled to a second transmission medium, the clock input being configured to receive the first clock signal from the second transmission medium as a single-ended signal referenced against the common ground.

44. The receiver of claim 43, wherein the clock conditioning block includes a second electrical termination circuit configured to receive the first clock signal from the clock input port and match a characteristic impedance of the second transmission medium from which the fourth electrical conductor of the clock input port is configured to receive the first clock signal.

45. The receiver of claim 44, wherein the clock conditioning block further includes a buffer configured to receive the first clock signal from the second electrical termination circuit and adjust one or more signal characteristics of the first clock signal.

46. The receiver of claim 45, wherein the clock conditioning block further includes a frequency divider configured to receive the first clock signal from the buffer and divide the first clock frequency of the first clock signal by a first predetermined integer value.

47. The receiver of claim 46, wherein the clock conditioning block further includes one or more frequency multipliers, each of the one or more frequency multipliers being configured to receive the first clock signal from the frequency divider and multiply the first clock frequency of the first clock signal by a second predetermined integer value to generate the second clock signal.

48. The receiver of claim 47, wherein at least one of the one or more frequency multipliers is a multi-stage frequency multiplier configured to receive the first clock signal from the frequency divider and multiply the first clock frequency of the first clock signal by the second predetermined integer value at least two times to generate a third clock signal.

49. The receiver of claim 48, wherein the one or more intermediate signals are one or more first intermediate signals and the demodulation block includes a first frequency mixer and one or more second frequency mixers, the first frequency mixer being configured to receive a particular antenna output signal of the one or more antenna output signals from the one or more antennas and the third clock signal from the clock conditioning block and modulate the particular antenna output signal onto the third clock signal to generate the one or more first intermediate signals, each of the one or more second frequency mixers being configured to receive a particular first intermediate signal of the one or more first intermediate signals from the first frequency mixer and the second clock signal from the clock conditioning block and modulate the particular first intermediate signal onto the second clock signal to generate one or more second intermediate signals.

50. The receiver of claim 46, wherein the clock conditioning block further includes a multi-stage frequency multiplier configured to receive the first clock signal from the frequency divider and multiply the first clock frequency of the first clock signal by a second predetermined integer value at least two times to generate the second clock signal.

51. The receiver of claim 50, wherein the clock conditioning block further includes a clock amplifier configured to receive the second clock signal from the multi-stage frequency multiplier and amplify the second clock signal to generate a third clock signal.

52. The receiver of claim 51, wherein the one or more intermediate signals are one or more first intermediate signals and the demodulation block includes a first frequency mixer and one or more second frequency mixers, the first frequency mixer being configured to receive a particular antenna output signal of the one or more antenna output signals from the one or more antennas and the third clock signal from the clock conditioning block and modulate the particular antenna output signal onto the third clock signal to generate the one or more first intermediate signals, each of the one or more second frequency mixers being configured to receive a particular first intermediate signal of the one or more first intermediate signals from the first frequency mixer and the second clock signal from the clock conditioning block and modulate the particular first intermediate signal onto the second clock signal to generate one or more second intermediate signals.

53. The receiver of claim 25, wherein each of the one or more baseband signals, the one or more intermediate signals, the first clock signal, the second clock signal, and the one or more antenna output signals are differential signals having an in-phase (I) component and a quadrature (Q) component.

54. A transceiver, comprising:
a transmitter, comprising:
a client-side input configured to receive one or more outbound baseband signals having outbound client data encoded therein;
an outbound signal conditioning block configured to receive the one or more outbound baseband signals from the client-side input and adjust one or more signal characteristics of the one or more outbound baseband signals to generate one or more outbound intermediate signals based on the one or more outbound baseband signals;
a clock conditioning block configured to receive a first clock signal and adjust one or more signal characteristics of the first clock signal to generate a second clock signal based on the first clock signal, the first clock signal having a first clock frequency, the second clock signal having a second clock frequency that is a harmonic frequency corresponding to the first clock frequency;
a modulation block configured to receive the one or more outbound intermediate signals from the outbound signal conditioning block and the second clock signal from the clock conditioning block and modulate the one or more outbound intermediate signals onto the second clock signal to generate one or more antenna feed signals; and
one or more outbound antennas configured to receive the one or more antenna feed signals from the modulation block, generate one or more outbound radiated signals based on the one or more antenna feed signals, and couple the one or more outbound radiated signals into one or more first hollow waveguides, each of the one or more outbound radiated signals being radiated electromagnetic waves configured for coherent detection and having an outbound transmission frequency in a range between 300 Gigahertz (GHz) and 10 Terahertz (THz); and
a receiver, comprising:
one or more inbound antennas configured to detect one or more inbound radiated signals received from one of the one or more first hollow waveguides and one or more second hollow waveguides and generate one or more antenna output signals based on the one or more inbound radiated signals, each of the one or more radiated signals being radiated electromagnetic waves configured for coherent detection and having inbound client data encoded therein and an inbound transmission frequency in the range between 300 GHz and 10 THz;
a demodulation block configured to receive the one or more antenna output signals from the one or more inbound antennas and the second clock signal from the clock conditioning block and modulate the one or more antenna output signals onto the second clock signal to generate one or more inbound intermediate signals;
an inbound signal conditioning block configured to receive the one or more inbound intermediate signals from the demodulation block and adjust one or more signal characteristics of the one or more inbound intermediate signals to generate one or more inbound baseband signals based on the one or more inbound intermediate signals; and
a client-side output configured to receive the one or more inbound baseband signals from the signal conditioning block and transmit the one or more inbound baseband signals.

55. The transceiver of claim 54, wherein the client-side input is configured to receive the one or more outbound baseband signals having the outbound client data encoded therein and the one or more inbound antennas are configured to detect the one or more inbound radiated signals received from one of the one or more first hollow waveguides and the one or more second hollow waveguides having the inbound client data encoded therein using a modulation protocol conforming to a specification of one of intensity modulation (IM)/direct detection (DD) (IM/DD), return-to-zero (RZ) code, non-return-to-zero (NRZ) code, pulse-amplitude modulation (PAM), IM-PAM, quadrature-amplitude modulation (QAM), and single-sideband (SSB) modulation.

56. The transceiver of claim 54, further comprising a clock source configured to generate the first clock signal, the clock conditioning block being configured to receive the first clock signal from the clock source.

57. The transceiver of claim 54, wherein the client-side input includes one or more signal input ports, each of the one or more signal input ports including a first outbound electrical conductor electrically coupled to a common ground and a second outbound electrical conductor configured to be electrically coupled to a particular first outbound transmission medium of one or more first outbound transmission mediums, the client-side input being configured to receive the one or more outbound baseband signals from the one or more first outbound transmission mediums as one or more single-ended signals referenced against the common ground.

58. The transceiver of claim 57, wherein the outbound signal conditioning block includes one or more first outbound electrical termination circuits, each of the one or more first outbound electrical termination circuits being configured to receive a particular outbound baseband signal of the one or more outbound baseband signals from a particular signal input port of the one or more signal input ports and match a characteristic impedance of the particular first outbound transmission medium to which the second outbound electrical conductor of the particular signal input port is configured to be electrically coupled.

59. The transceiver of claim 58, wherein the outbound signal conditioning block further includes one or more re-timer circuits, each of the one or more re-timer circuits being configured to receive a particular outbound baseband signal of the one or more outbound baseband signals from a particular first outbound electrical termination circuit of the one or more first outbound electrical termination circuits and re-time the particular outbound baseband signal.

60. The transceiver of claim 59, wherein each of the one or more re-timer circuits includes a re-timer portion and a bypass portion, the re-timer portion of each of the one or more re-timer circuits being configured to receive a particular outbound baseband signal of the one or more outbound baseband signals from a particular first outbound electrical termination circuit of the one or more first outbound electrical termination circuits and selectively re-time the particular outbound baseband signal, the bypass portion of each of the one or more re-timer circuits being configured to receive a particular outbound baseband signal of the one or more outbound baseband signals from a particular first outbound electrical termination circuit of the one or more first outbound electrical termination circuits and selectively bypass the re-timer portion.

61. The transceiver of claim 59, wherein the outbound signal conditioning block further includes one or more pulse-shaping circuits, each of the one or more pulse-shaping circuits being configured to receive a particular outbound baseband signal of the one or more outbound baseband signals from a particular re-timer circuit of the one or more re-timer circuits and adjust one or more signal characteristics of the one or more outbound baseband signals to generate the one or more outbound intermediate signals based on the one or more outbound baseband signals.

62. The transceiver of claim 61, wherein the outbound signal conditioning block further includes one or more outbound splitters, each of the one or more outbound splitters being configured to receive a particular outbound intermediate signal of the one or more outbound intermediate signals from a particular pulse-shaping circuit of the one or more pulse-shaping circuits and split the particular outbound intermediate signal into a plurality of outbound intermediate signals.

63. The transceiver of claim 62, wherein the plurality of outbound intermediate signals are a plurality of first outbound intermediate signals and the modulation block includes a plurality of outbound frequency mixers and an outbound combiner, each of the plurality of outbound frequency mixers being configured to receive a particular outbound intermediate signal of the plurality of outbound intermediate signals from the outbound signal conditioning block and the second clock signal from the clock conditioning block and modulate the particular outbound intermediate signal onto the second clock signal to generate a plurality of second outbound intermediate signals, the outbound combiner being configured to receive the plurality of second outbound intermediate signals from the one or more outbound frequency mixers and combine the plurality of second outbound intermediate signals to generate the one or more antenna feed signals.

64. The transceiver of claim 54, further comprising a clock input configured to receive the first clock signal, the clock conditioning block being configured to receive the first clock signal from the clock input.

65. The transceiver of claim 64, wherein the clock input includes a clock input port including a first clock electrical conductor electrically coupled to a common ground and a second clock electrical conductor configured to be electrically coupled to a second transmission medium, the clock input being configured to receive the first clock signal from the second transmission medium as a single-ended signal referenced against the common ground.

66. The transceiver of claim 65, wherein the clock conditioning block includes a second clock electrical termination circuit configured to receive the first clock signal from the clock input port and match a characteristic impedance of the second transmission medium from which the second clock electrical conductor of the clock input port is configured to receive the first clock signal.

67. The transceiver of claim 66, wherein the clock conditioning block further includes a clock buffer configured to receive the first clock signal from the second clock electrical termination circuit and adjust one or more signal characteristics of the first clock signal.

68. The transceiver of claim 67, wherein the clock conditioning block further includes a frequency divider configured to receive the first clock signal from the clock buffer and divide the first clock frequency of the first clock signal by a first predetermined integer value.

69. The transceiver of claim 68, wherein the clock conditioning block further includes one or more frequency multipliers, each of the one or more frequency multipliers being configured to receive the first clock signal from the frequency divider and multiply the first clock frequency of the first clock signal by a second predetermined integer value to generate the second clock signal.

70. The transceiver of claim 54, wherein the one or more outbound intermediate signals are one or more first outbound intermediate signals and the modulation block includes one or more outbound frequency mixers and an outbound combiner, each of the one or more outbound frequency mixers being configured to receive a particular first outbound intermediate signal of the one or more first outbound intermediate signals from the outbound signal conditioning block and a particular second clock signal of the one or more second clock signals from the clock conditioning block and modulate the particular first outbound intermediate signal onto the particular second clock signal to generate one or more second outbound intermediate signals, the outbound combiner being configured to receive the one or more second outbound intermediate signals from the one or mor outbound e frequency mixers and combine the one or more second outbound intermediate signals to generate the one or more antenna feed signals.

71. The transceiver of claim 69, wherein at least one of the one or more frequency multipliers is a multi-stage frequency multiplier configured to receive the first clock signal from the frequency divider and multiply the first clock frequency of the first clock signal by the second predetermined integer value at least two times to generate a third clock signal having a third clock frequency.

72. The transceiver of claim 71, wherein the one or more outbound intermediate signals are one or more first outbound intermediate signals and the modulation block includes one or more first outbound frequency mixers, an outbound combiner, and a second outbound frequency mixer, each of the one or more first outbound frequency mixers being configured to receive a particular first outbound intermediate signal of the one or more first outbound intermediate signals from the outbound signal conditioning block and the second clock signal from the clock conditioning block and modulate the particular first outbound intermediate signal onto the second clock signal to generate one or more second outbound intermediate signals, the outbound combiner being configured to receive the one or more second outbound intermediate signals from the one or more first outbound frequency mixers and combine the one or more second outbound intermediate signals to generate one or more third outbound intermediate signals, the second outbound frequency mixer being configured to receive the one or more third outbound intermediate signals from the outbound combiner and the third clock signal from the clock conditioning block and modulate the one or more third outbound intermediate signals onto the third clock signal to generate the one or more antenna feed signals.

73. The transceiver of claim 68, wherein the clock conditioning block further includes a multi-stage frequency multiplier configured to receive the first clock signal from the frequency divider and multiply the first clock frequency of the first clock signal by a second predetermined integer value at least two times to generate the second clock signal.

74. The transceiver of claim 73, wherein the clock conditioning block further includes a clock amplifier configured to receive the second clock signal from the multi-stage frequency multiplier and amplify the second clock signal to generate a third clock signal having a third clock frequency.

75. The transceiver of claim 74, wherein the one or more outbound intermediate signals are one or more first outbound intermediate signals and the modulation block includes one or more first outbound frequency mixers, an outbound combiner, and one or more second outbound frequency mixers, each of the one or more first outbound frequency mixers being configured to receive a particular first outbound intermediate signal of the one or more first outbound intermediate signals from the outbound signal conditioning block and the second clock signal from the clock conditioning block and modulate the particular first outbound intermediate signal onto the second clock signal to generate one or more second outbound intermediate signals, the outbound combiner being configured to receive the one or more second outbound intermediate signals from the one or more first outbound frequency mixers and combine the one or more second outbound intermediate signals to generate one or more third outbound intermediate signals, each of the one or more second outbound frequency mixers being configured to receive a particular third outbound intermediate signal of the one or more third outbound intermediate signals from the outbound combiner and the third clock signal from the clock conditioning block and modulate the particular third outbound intermediate signal onto the third clock signal to generate the one or more antenna feed signals.

76. The transceiver of claim 54, further comprising an outbound matching network configured to receive the one or more antenna feed signals from the modulation block and match a characteristic impedance of the one or more first hollow waveguides into which the one or more outbound antennas are configured to couple the one or more outbound radiated signals.

77. The transceiver of claim 54, wherein each of the one or more outbound baseband signals, the one or more inbound baseband signals, the one or more outbound intermediate signals, the one or more inbound intermediate signals, the first clock signal, the second clock signal, the one or more antenna feed signals, and the one or more antenna output signals are differential signals having an in-phase (I) component and a quadrature (Q) component.

78. The transceiver of claim 54, wherein the client-side output includes one or more signal output ports, each of the one or more signal output ports including a first inbound electrical conductor electrically coupled to a common ground and a second inbound electrical conductor configured to be electrically coupled to a particular first inbound transmission medium of one or more first inbound transmission mediums, the client-side output being configured to transmit the one or more inbound baseband signals into the one or more first inbound transmission mediums as one or more single-ended signals referenced against the common ground.

79. The transceiver of claim 78, wherein the demodulation block includes an inbound splitter and a plurality of inbound frequency mixers, the inbound splitter being configured to receive the one or more antenna output signals from the one or more inbound antennas and split the one or more antenna output signals into a plurality of antenna output signals, each of the plurality of inbound frequency mixers being configured to receive a particular antenna output signal of the plurality of antenna output signals from the inbound splitter and the second clock signal from the clock conditioning block and modulate the particular antenna output signal onto the second clock signal to generate a plurality of inbound intermediate signals.

80. The transceiver of claim 79, wherein the inbound signal conditioning block includes a plurality of equalizers, each of the plurality of equalizers being configured to receive a particular inbound intermediate signal of the plurality of inbound intermediate signals from the demodulation block and equalize the particular inbound intermediate signal.

81. The transceiver of claim 80, wherein each of the plurality of equalizers is a continuous time linear equalizer.

82. The transceiver of claim 81, wherein the plurality of inbound intermediate signals are a plurality of first inbound intermediate signals and the inbound signal conditioning block further includes a plurality of inbound signal amplifiers, each of the plurality of inbound signal amplifiers being configured to receive a particular first inbound intermediate signal of the plurality of first inbound intermediate signals from a particular equalizer of the plurality of equalizers and amplify the particular first inbound intermediate signal to generate a plurality of second inbound intermediate signals.

83. The transceiver of claim 82, wherein each of the one or more inbound signal amplifiers is a variable gain amplifier.

84. The transceiver of claim 82, wherein the inbound signal conditioning block further includes an inbound combiner configured to receive the plurality of second inbound intermediate signals from the plurality of inbound signal amplifiers and combine the plurality of second inbound intermediate signals to generate the one or more inbound baseband signals.

85. The transceiver of claim 84, wherein the inbound signal conditioning block further comprises one or more drivers, each of the one or more drivers being configured to receive a particular inbound baseband signal of the one or more inbound baseband signals from the inbound combiner and drive the particular inbound baseband signal.

86. The transceiver of claim 85, wherein each of the one or more drivers is a driver with termination configured to receive the particular inbound baseband signal of the one or more inbound baseband signals from the inbound combiner, drive the particular inbound baseband signal, and match a characteristic impedance of the particular first inbound transmission medium to which the second inbound electrical conductor of a particular signal output port of the one or more signal output ports is configured to be electrically coupled, the particular signal output port being configured to receive the particular inbound baseband signal.

87. The transceiver of claim 54, further comprising an inbound matching network configured to receive the one or more antenna output signals from the one or more inbound antennas and match a characteristic impedance of the one of the one or more first hollow waveguides and the one or more second hollow waveguides from which the one or more inbound antennas are configured to receive the one or more inbound radiated signals.

88. The transceiver of claim 54, wherein the demodulation block includes one or more inbound frequency mixers, each of the one or more inbound frequency mixers being configured to receive a particular antenna output signal of the one or more antenna output signals from the one or more inbound antennas and the second clock signal from the clock conditioning block and modulate the particular antenna output signal onto the second clock signal to generate the one or more inbound intermediate signals.

89. The transceiver of claim 54, wherein the inbound signal conditioning block includes one or more inbound signal amplifiers, each of the one or more inbound signal amplifiers being configured to receive a particular inbound intermediate signal of the one or more inbound intermediate signals and amplify the particular inbound intermediate signal.

90. The transceiver of claim 89, wherein each of the one or more inbound signal amplifiers is a trans-impedance amplifier.

91. The transceiver of claim 89, wherein the inbound signal conditioning block further includes one or more inbound buffers, each of the one or more inbound buffers being configured to receive a particular inbound intermediate signal of the one or more inbound intermediate signals from a particular inbound signal amplifier of the one or more inbound signal amplifiers and adjust one or more signal characteristics of the particular inbound intermediate signal to generate the one or more inbound baseband signals.

92. The transceiver of claim 71, wherein the one or more inbound intermediate signals are one or more first inbound intermediate signals and the demodulation block includes a first inbound frequency mixer and one or more second inbound frequency mixers, the first inbound frequency mixer being configured to receive a particular antenna output signal of the one or more antenna output signals from the one or more inbound antennas and the third clock signal from the clock conditioning block and modulate the particular antenna output signal onto the third clock signal to generate the one or more first inbound intermediate signals, each of the one or more second inbound frequency mixers being configured to receive a particular first inbound intermediate signal of the one or more first inbound intermediate signals from the first inbound frequency mixer and the second clock signal from the clock conditioning block and modulate the particular first inbound intermediate signal onto the second clock signal to generate one or more second inbound intermediate signals.

93. The transceiver of claim 74, wherein the one or more inbound intermediate signals are one or more first inbound intermediate signals and the demodulation block includes a first inbound frequency mixer and one or more second inbound frequency mixers, the first inbound frequency mixer being configured to receive a particular antenna output signal of the one or more antenna output signals from the one or more inbound antennas and the third clock signal from the clock conditioning block and modulate the particular antenna output signal onto the third clock signal to generate the one or more first inbound intermediate signals, each of the one or more second inbound frequency mixers being configured to receive a particular first inbound intermediate signal of the one or more first inbound intermediate signals from the first inbound frequency mixer and the second clock signal from the clock conditioning block and modulate the particular first inbound intermediate signal onto the second clock signal to generate one or more second inbound intermediate signals.

94. A method, comprising:
providing one or more baseband signals to a transmitter in a transport network, at least one of the one or more baseband signal having client data encoded therein, the transport network comprising one or more hollow waveguides, the transmitter coupled to the one or more hollow waveguides, and a receiver coupled to the one or more hollow waveguides;
generating, by the transmitter, one or more radiated signals based on the one or more baseband signals, at least one of the one or more radiated signals being a radiated electromagnetic wave having a transmission frequency in a range between 300 Gigahertz (GHz) and 10 Terahertz (THz);
coupling, by the transmitter, the one or more radiated signals into the one or more hollow waveguides;
receiving, by the receiver, the one or more radiated signals from the one or more hollow waveguides;
measuring, by the receiver, one or more signal quality parameters of the one or more radiated signals, wherein the one or more signal quality parameters include one or more of signal distortion, bit error rate (BER), spurious free dynamic range (SFDR), signal-to-noise ratio (SNR), signal dynamic range, and jitter;
generating, by the receiver, one or more actuation controls based on the one or more signal quality parameters, each of the one or more actuation controls being configured to adjust a particular one of one or more transmitter operating parameters of the transmitter, wherein the one or more transmitter operating parameters include one or more of gain, bandwidth, equalization, linearity, and jitter;
sending, by the receiver, an actuation control signal, the actuation control signal having the one or more actuation controls encoded therein;
receiving, by the transmitter, the actuation control signal; and
adjusting, by the transmitter, at least one of the one or more transmitter operating parameters of the transmitter based on the one or more actuation controls.

95. The method of claim 94, wherein the step of generating the one or more radiated signals based on the one or more baseband signals includes mixing, by the transmitter, each of the one or more baseband signals with a particular local oscillator signal of one or more local oscillator signals to generate the one or more radiated signals, each particular local oscillator signal of the one or more local oscillator signals having a particular local oscillator frequency of a plurality of local oscillator frequencies, wherein at least one of the plurality of local oscillator frequencies is the transmission frequency.

96. The method of claim 94, wherein the step of adjusting at least one of the one or more transmitter operating parameters of the transmitter based on the one or more actuation controls is further defined as adjusting, by a processor of the transmitter, at least one of the one or more transmitter operating parameters of the transmitter based on the one or more actuation controls.
